(19) United States
(12) Patent Application Publication
(10) Pub. No.: US 2013/0120676 A1
(43) Pub. Date: May 16, 2013

(54) STEREO IMAGE PRINT AND METHOD OF PRODUCING THE SAME

(71) Applicant: FUJIFILM CORPORATION, Tokyo (JP)

(72) Inventors: Nobutaka IWAHASHI, Minami-ashigara-shi (JP); Shinichi MORISHIMA, Minami-ashigara-shi (JP)

(73) Assignee: FUJIFILM CORPORATION, Tokyo (JP)

(21) Appl. No.: 13/717,120

(22) Filed: Dec. 17, 2012

Related U.S. Application Data
(63) Continuation of application No. PCT/JP2011/063929, filed on Jun. 17, 2011.

(30) Foreign Application Priority Data
Jun. 18, 2010 (JP) 2010-139317

(51) Int. Cl. G02B 27/22; C09D 11/00

(52) U.S. Cl. CPC G02B 27/225; C09D 11/328
USPC 349/15; 347/20; 359/465

(57) ABSTRACT

Provided is a stereo image print observable without polarized glasses, having a transparent support; first and second laminate disposed on a surface, respectively, of the transparent support, each laminate having an image layer satisfying condition (1) and a protective layer having at least one layer satisfying condition (2), the image layer and the protective layer being disposed in this order from the transparent support side: (1) each image layer has a dichroic image including pixels for a left eye and pixels for a right eye arranged in a predetermined array, each pixel having at least one kind of horizontally aligned dichroic dye, and absorption axes of the dichroic images in the first and the second laminates are orthogonal to each other, (2) the protective layer has an in-plane retardation value (Re) 10 mm or less for visible light.

The present application is a continuation of PCT/JP2011/063929 filed on Jun. 17, 2011 and claims priority under 35 U.S.C. §119 of Japanese Patent Application No. 139317/2010, filed on Jun. 18, 2010.

### TECHNICAL FIELD

The present invention relates to a stereo image print stereoscopically displaying an image and a method of producing the image print.

### BACKGROUND ART

Conventional methods of stereoscopically displaying image prints of planar images for viewers have been proposed (e.g., PCT Japanese Translation Patent Publication Nos. Hei 11-555701 and 2001-505323 and Journal of Imaging Science and Technology, “Full-color 3-D Prints and Technology”, vol. 42, No. 4, July/August 1998, J. J. Scarpetti, P. M. Dubois, R. M. Friedhoff, and V. K. Walworth) in which the methods use dichroic dyes. In each method, polarized images for the left eye and the right eye are separately formed using an ink containing a dichroic dye on a sheet of which molecules are aligned by, for example, stretching treatment. Another method of producing a stereo image print disclosed in Japanese Patent Laid-Open No. Hei 5-210182 involves arranging pixels for the left eye and the right eye in a predetermined array, disposing a polarizing filter over the pixels for the left eye and the right eye, and further stacking a ¼ wavelength plate on the polarizing film, where the angle between the polarizing axis of the polarizing film and the delay axis of the ¼ wavelength plate is ±45 degrees for the right eye and the left eye, respectively.

In these methods, the viewer needs to wear polarized glasses.

### SUMMARY OF INVENTION

It is an object of the present invention to provide a stereo image print that can be observed without polarized glasses and a method of producing the stereo image print.

The method for solving the above-mentioned problem is as follows:

<1> 1. A stereo image print comprising:

a transparent support;

a first laminate and a second laminate disposed on a front surface and a back surface, respectively, of the transparent support, each laminate comprising an image layer satisfying the following condition (1) and a protective layer comprising at least one layer satisfying the following condition (2), the image layer and the protective layer being disposed in this order from the transparent support side:

(1) each image layer has a dichroic image including pixels for a left eye and pixels for a right eye arranged in a predetermined array, each pixel comprises at least one kind of horizontally aligned dichroic dye, and the dichroic images in the first and second laminates having absorption axes being orthogonal to each other.

(2) the protective layer comprising at least one layer included in the first laminate has an in-plane retardation value (Re) of 10 nm or less for visible light; and

comprising a linearly polarizing layer having patterned first and second domains on the surface of the first laminate, the first and second domains having polarization axes being orthogonal to each other, the stereo image print being viewed from exterior of the patterned linearly polarizing layer,

wherein the stereo image print is configured such that only the dichroic image for the left eye enters an designed viewing position for the left eye and that only the dichroic image for the right eye enters an designed viewing position for the right eye.

<2> The stereo image print according to <1>, wherein the pixels for a right eye and the pixels for a left eye in the dichroic images each included in the first and second laminates are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate.

<3> The stereo image print according to <1> or <2>, wherein the transparent support shows an in-plane retardation value (Re) of 10 nm or less for visible light.

<4> The stereo image print according to any one of <1> to <3>, wherein the at least one kind of dichroic dye has liquid crystallinity; and

which comprises a first alignment film disposed between the image layer of the first laminate and the transparent support and a second alignment film disposed between the image layer of the second laminate and the transparent support; and the first and second alignment films have alignment axes orthogonal to each other.

<5> The stereo image print according to <4>, wherein the first and second alignment films are rubbing alignment films formed from a composition primarily composed of a polymer compound by rubbing the surfaces of the films such that the rubbing directions of the films are orthogonal to each other.

<6> The stereo image print according to <4>, wherein the first and second alignment films are photoalignment films aligned by light irradiation in directions orthogonal to each other.

<7> The stereo image print according to any one of <4> to <6>, wherein the at least one kind of liquid crystalline dichroic dye is hydrophobic; and the first and second alignment films each comprise a hydrophilic polymer as a main component.

<8> The stereo image print according to any one of <1> to <7>, wherein the first laminate and/or the second laminate comprises an oxygen-shielding layer formed from a composition primarily composed of polyvinyl alcohol as one layer of the protective layer comprising one or more layers.

<9> The stereo image print according to any one of <1> to <8>, wherein the first laminate and/or the second laminate comprises a layer containing a UV absorber as one layer of the protective layer comprising one or more layers.

<10> The stereo image print according to any one of <1> to <9>, wherein the at least one kind of dichroic dye is a liquid crystalline dichroic dye represented by Formula (I), Formula (II), Formula (III), Formula (IV), or Formula (VI);

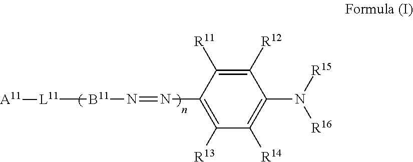

(in the formula, R¹¹ to R¹⁴ each independently represent a hydrogen atom or a substituent; R¹⁵ R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1to 5, provided that when n represents an integer of 2 or more, a plurality of B¹¹'s may be the same as or different from each other);

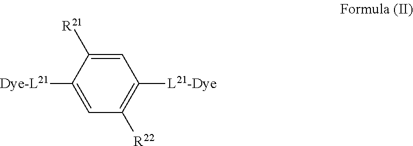

(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydrogen group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (—O—C(═O)—), and imino group (—N═CH—), and a vinylene group (—C═C—); and each Dye represents an azo dye residue represented by Formula (IIa):

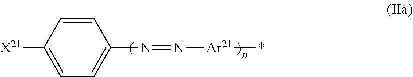

in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹ 's may be the same as or different from each other);

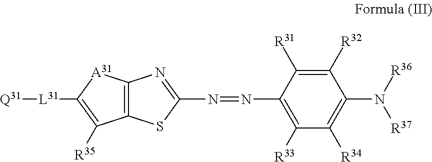

(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom);

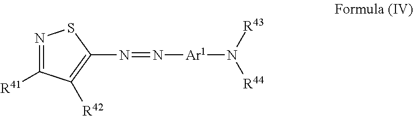

(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to forma a heterocyclic ring); and

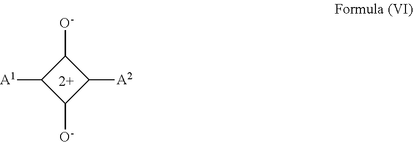

(in the formula, A¹ and A² each independently represent a substituted or unsubstituted hydrocarbon ring or heterocyclic group).

<11> The stereo image print according to any of <1> to <10>, wherein the patterned linearly polarizing layer is a coating-type linearly polarizing layer formed by coating.

<12 > The stereo image print according to <11>, wherein the coating-type linearly polarizing layer contains at least one kind of dichroic dye represented by Formula (I), Formula (II), Formula (III), Formula (IV), or Formula (VI) according to <9>. 13. The stereo image print according to <1>, further comprising a non-depolarizing reflecting layer on the surface opposite to the viewer side.

<13> the stereo image print according to any one of <1> to <12 >, further comprising a non-depolarizing reflecting layer on the surface opposite to the viewer side.

<14 > A method of producing a stereo image print according to any one of <1> to <13>, the method comprising:

applying a dichroic dye composition comprising an organic solvent and at least one kind of dichroic dye dissolved in the organic solvent, simultaneously or separately, onto the front surface and the back surface of a transparent support so as to form the respective images by arranging pixels for the left eye and pixels for the right eye in a predetermined array; and

horizontally aligning spontaneously or passively the at least one kind of dichroic dye by evaporating the organic solvent in the composition.

<15 > The method according to <14 >, wherein the liquid crystalline dichroic dye composition is applied by ink jetting.

The present invention can provide a stereo image print a viewer can observe without wearing polarized glasses and a method of producing the stereo image print.

### BRIEF DESCRIPTION OF DRAWINGS

FIG. 1 is a schematic cross-sectional view of an example stereo image print of the present invention.

FIG. 2 is a view schematically illustrating an operation when a viewer views a stereo image print of the present invention.

FIG. 3 is a schematic view illustrating the directions of rubbing treatment in an example rubbing alignment film that can be used in the present invention.

FIG. 4 is a schematic view illustrating the directions of light irradiation in an example photoalignment film that can be used in the present invention.

FIG. 5 includes a schematic planar view (c) of an example patterned linearly polarizing layer that can be used in the present invention and schematic planar views (a) and (b) of an example mask that can be used for producing the patterned linearly polarizing layer.

FIG. 6 is a schematic cross-sectional view of an example stereo image print of the present invention.

FIG. 7 is a schematic cross-sectional view of an example stereo image print of the present invention.

FIG. 8 is a schematic cross-sectional view of an example printing sheet that can be used for producing a stereo image print of the present invention.

### DESCRIPTION OF EMBODIMENTS

The invention is described in detail hereinunder. In this description, the numerical range expressed by the wording “a number to another number” means the range that falls between the former number indicating the lowermost limit of the range and the latter number indicating the uppermost limit thereof. First described are the terns used in this description.

Note that throughout the specification, Re(λ) denotes the front retardation value (unit: nm) at a wavelength λ nm; Rth(λ) denotes the retardation value (unit: nm) in the thickness direction at a wavelength λ nm; and the value in the case of not stating wavelength is one at wavelength of 550 nm. The in-plane retardation (Re(λ)) is measured with KOBRA 21ADH or WR (manufactured by Oji Keisoku KiKi Co. Ltd.) using incident light having a wavelength λ nm entering in the film normal direction; and the thickness direction retardation (Rth(λ)) is calculated based on the value (Re(λ) and a plurality of values obtained by measurement with light from oblique directions.

In this description, “visible light” means from 380 nm to 780 nm. unless otherwise specifically defined in point of the wavelength in measurement in this description, the wavelength in measurement is 550 nm.

In this description, the angle (for example, “90°”, etc.) and the relational expressions thereto (for example, “perpendicular”, “parallel”, “crossing at 45°”, etc.) should be so interpreted as to include the error range generally acceptable in the technical field to which the invention belongs. For example, this means within a range of a strict angle ± less than 10°, and the error from the string angle is preferably at most 5°, more preferably at most 3°.

Throughout the specification, the term “patterning” refers to production of two or more regions having different directions characterized by optical anisotropy (i.e., directions including slow axis and polarization axis) from each other on a film (layer) object or possession of two or more such regions.

Throughout the specification, the terms “crosstalk” and “ghost image” refer to the right and left images that are recognized as a double image and are recognized as an image other than the objective image due to incomplete separation thereof.

### 1. Stereo Image Print

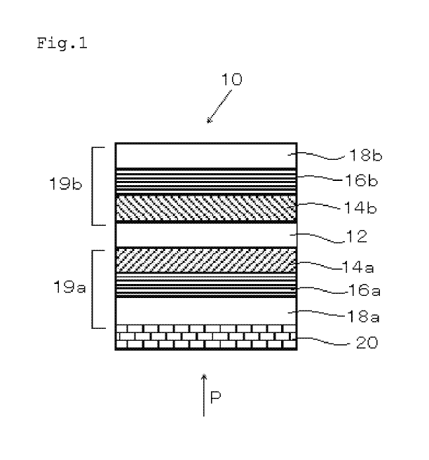

FIG. 1 is a cross-sectional view of a stereo image print of an embodiment of the present invention.

The stereo image pint 10 of FIG. 1 is viewed from the directions of the arrow P. The stereo image print 10 includes a first laminate 19a including an image layer 16a and a protective layer 18a laminated on the viewer-side surface of a transparent support 12 and a second laminate 19b including an image layer 16b and a protective layer 18b laminated on the other surface of the transparent support 12. the image layers 16a and 16b each have a dichroic image including pixels for the right eye and pixels for the left eye arranged in a predetermined array, each pixel being composed of at least one substantially horizontally aligned dichroic dye. The absorption axes of the dichroic images in the first laminate 19a and the second laminate 19b are orthogonal to each other. A patterned linearly polarizing layer 20 is disposed on the viewer-side surface of the first laminate 19a.

Am image-receiving layer 14a is disposed between the transparent support 12 and the image layer 16a, and an image-receiving layer 14b is disposed between the transparent support 12 and the image layer 16b. The image-receiving layers 14a and 14b each maintain a dichroic dye on the surface thereof or allow the dichroic dye to permeate therein and each have a function of allowing the dichroic dye to be spontaneoulsy or passively horizontally aligned. For example, in the case of using a spontaneously aligning liquid crystalline dichroic dye, the image-receiving layers 14a and 14b are preferably alignment. films that are disposed such that their alignment axes are orthogonal to each other. In the case of a dichroic dye being a compound that does not spontaneously align but passively aligns in the presence of another molecule, the image-receiving layers 14a and 14b are preferably molecularly aligned sheets stretched in directions orthogonal to each other. In such a case, the dichroic dye is required to permeate the image-receiving layers 14a and 14b, and this restricts the combination of raw materials. In contrast, in the case of using a liquid crystalline dichroic dye, the dichroic dye is not required to permeate the image-receiving layers 14a and 14b, for example even if the liquid crystalline dichroic dye is hydrophobic whereas the image-receiving layers 14a and 14b are primarily composed of hydrophilic materials; hence, a dichroic image can be formed. In the case of using a liquid crystalline dichroic dye, a dichroic image can be formed with a high dichroic ratio, compared with the case of allowing a non-liquid crystalline dichroic dye to permeate a molecularly aligned sheet and passively align along the molecular alignment. As a result, crosstalk and ghost images can be reduced.

FIG. 1 illustrates the image layers 16a and 16b, each having a two-layer structure. For example, in the case of a dichroic dye that permeates the image-receiving layer to be horizontally aligned therein as described above, the image layer 16a and the image-receiving layer 14a can be regarded as an unseparated single layer, and similarly, the image layer 16b and the image-receiving layer 14b can be regarded as a single layer.

The image layers 16a and 16b each have a dichroic image combined based on, for example, image data photographed with a digital camera, more specifically, digital data such as an image photographed with a digital camera equipped with taking lenses of two systems for right and left. The dichroic image is composed of pixels for the left eye and the right eye arranged in a predetermined pattern. The predetermined pattern is, for example, a stripe pattern. an example is a dichroic image, wherein the pixels for the right eye and the pixels for the left eye are alternately arranged in each of the image layers 16a and 16b and the pixels for the right eye and the pixels for the left eye are stacked and arranged so that the image layer 16a and the image layer 16b correspond to each other. The dichroic images are preferably formed by ink-jet recording.

The first and the second laminates 19a and 19b, respectively, include protective layers 18a and 18b for protecting the image layers 16a and 16b. The protective layers 18a and 18b are made of, for example, a polymer film. the protective layer 18a included in the first laminate 19a, i.e., the protective layer 18a disposed on the viewing-surface side of the transparent support 12 shows an in-plane retardation value (Re) of 10 nm or less for visible light. A value Re of exceeding 10 nm changes the absorption axis of the dichroic image, causing crosstalk and ghost images. Accordingly, the protective layer 18a preferably has low phase difference. Specifically, the in-plane retardation Re(550) at a wavelength of 550 nm is preferably 0 to 10 nm and more preferably 5 nm or less. The value Rth of the protective layer 18a also affects the absorption axis of a dichroic image to cause crosstalk and ghost. Accordingly, the absolute value of Rth(550) of the protective layer 18a is preferably 20 nm or less and more preferably 5 nm or less.

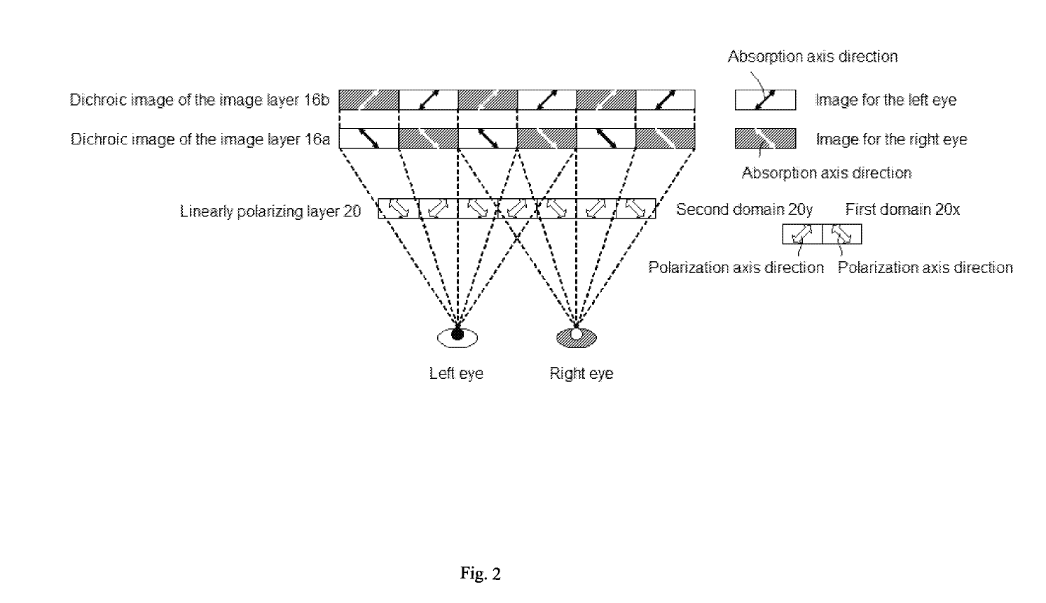

The linearly polarizing layer 20 is patterned into first domains 20x and second domains 20y where the polarization axes of the first and the second domains 20x and 20y are orthogonal to each other. The stereo image print 10 is viewed from the exterior of the patterned linearly polarizing layer 20, that is, from the direction of the arrow P. FIG. 2 is a view schematically illustrating pixels viewed by the left eye and pixels viewed by the right eye when a viewer views the stereo image print 10 without wearing polarized glasses.

The pattern of the linearly polarizing layer 20 is arranged such that, for the dichroic image in the first laminate 12a, the positions of first domains 20x having polarization axes coincident with the absorption axes of the pixels for the left eye correspond to the positions of the pixels for the left eye when viewed from the designed left eye position; and the positions of second domains 20y having polarization axes coincident with the absorption axes of the pixels for the right eye correspond to the positions of the pixels for the right eye when viewed from the designed right eye position; and such that, for the dichroic image in the second laminate 12b, the positions of second domains 20y having polarization axes coincident with the absorption axes of the pixels for the left eye when viewed from the designed left eye positions; and the positions of first domains 20x having polarization axes coincident with the absorption axes of the pixels for the right eye correspond to the positions of the pixels for the right eye when viewed from the designed right eye position.

A viewer views the stereo image print through the linearly polarizing layer 20. The linearly polarizing layer 20 is arranged such that, when the image layer 16a is viewed with the left eye, the pixels for the left eye are viewed through the first domains 20x having polarization axes in the direction coincident with the absorption axis direction of the pixels for the left eye while the pixels for the right eye are viewed through the second domains 20y having polarization axes in the directions orthogonal to the absorption axis direction of the pixels for the right eye; and when the image layer 16b is viewed with the left eye, the pixels for the left eye are viewed through the second domains 20y having polarization axes in the direction coincident with the absorption axis directions of the pixels for the left eye while the pixels for the right eye are viewed through the first domains 20x having polarization axes in the direction orthogonal to the absorption axis directions of the pixels for the right eye. As a result, the left eye can view only the pixels for the left eye of the image layers 16a and 16b. Similarly, the linearly polarizing layer 20 is arranged such that, when the image layer 16a is viewed with the right eye, the pixels for the right eye are viewed through the first domains 20x having polarization axes in the directions coincident with the absorption axis direction of the pixels for the right eye while the pixels for the left eye are viewed through the second domains 20y having polarization axes in the direction orthogonal to the absorption axis direction of the pixels for the left eye; and when the image layer 16b is viewed with the right eye, the pixels for the right eye are viewed through the second domains 20y having polarization axes in the direction coincident with the absorption axis direction of the pixels for the right eye while the pixels for the left eye are viewed through the first domains 20x having polarization axes in the direction orthogonal to the absorption axis direction of the pixels for the left eye. As a result, the right eye can view only the pixels for the right eye of the image layers 16a and 16b.

The distances from a viewer to the image layers 16a and 16b, the distances from the linearly polarizing layer 20 to the image layers 16a and 16b, the midpoint distances between the pixels for the left eye and the pixels for the right eye, the average distance between the right eye and the left eye, and the patterning intervals of the linearly polarizing layer satisfy predetermined geometrical relationships. Accordingly, the stereo image print 10 can be designed depending on relational expressions. The details are described in “Theory of Parallax Barriers”, July, 1952, Journal of the SMPTE, vol. 59, SAM H. KAPLAN. The conventional technology described in this specification does not use a patterned linearly polarizing layer, but uses a parallax barrier. In this point, the conventional technology differs from the present invention. The present invention is superior to the conventional technology using the parallax barrier in that a resolution can be ensured.

The optical characteristics of the transparent support 12 affect the absorption axis of the dichroic image in the second laminate 19b; hence, the transparent support 12 preferably has low phase difference. Specifically, the in-plane retardation Re(550) at a wavelength of 550 nm is preferably 0 to 10 nm and more preferably 5 nm or less. The absolute value of Rth(550) is preferably 20 nm or less and more preferably 5 nm or less.

Various materials that can be used for the stereo image print of the present invention will now be described.

### Transparent Support

The support of the stereo image print is transparent. Specifically, the support preferably has a light transmittance of 70% or more, more preferably 80% or more, and most preferably 90% or more. In order not to affect the polarized nature of the dichroic image in the second laminate on the back side, the support preferably has low phase difference or has isotropy, as described above. Specific examples and preferred embodiments of the polymer suitable for a low phase difference film or optically isotrophic film are described in paragraph [0013 ]of Japanese Patent Laid-Open No. 2002-22942, which can be incorporated herein. The films formed of the polymers, which are commonly known as easy to develop birefringence, such as polycarbonates or polysulfones, may be also used after being modified by the process described in WO00/26705 thereby to reduce the development of birefringence.

The transparent support may be a cellulose acylate film. The cellulose acylate film is preferably a low phase difference film primarily composed of cellulose acetate having a degree of acetylation of 55.0 to 62.5%, in particular, 57.0 to 62.9%. The preferred scope of acetylation rates and the preferred chemical structures of cellulose acetates are same as those described at [0021] column in JPA No. 2002-196146. It is disclosed in Journal of Technical Disclosure (Hatsumei Kyoukai Koukai Gihou) No. 2001-1745, published by Japan Institute of Invention and Innovation, cellulose acylate films produced by using chlorine-free solvents, and the cellulose acetate films can be employed in the present invention.

The cellulose acylate film, produced by a solvent-casting method using a cellulose acylate solution (dope), is preferably used. The dope may further comprise the agent for increasing retardation, and such a dope is preferred. Multilayered films can be produced by using the cellulose acylate solution (dope). The production of the films can be carried out according to the descriptions at columns from [0038] to [0040] in JPA No. 2002-139621. The support may be a film produced by melt film formation.

Plasticizes may be added to the cellulose acetate films in order to improve the mechanical properties of the films and the drying speed. Examples of the plasticizer and the preferred scope of the plasticizers are same as those described at [0043] column in JPA No. 2002-139621.

Anti-degradation agents such as antioxidants, decomposers of peroxides, inhibitors or radicals, in-activators of metals, trapping agents of acids of amines, and UV ray protective agents, may be added to the cellulose acetate film, the anti-degradation agents are described at [0044] column in JPA No. 2002-139621. The preferred example of the anti-degradation agent is butylated hydroxy toluene. UV ray protective agents are described in JPA No. Hei 7-11056 (1995-11056).

In order to improve the adhesiveness of the transparent support to the image layer (in FIG. 1, image-receiving layer), the transparent support may be a surface-treated cellulose acylate film. The surface treatment of a cellulose acylate film and the surface energy of a solid described in paragraphs [0051] to [0052] of Japanese Patent Laid-Open No. 2002-196146 can be applied to the present invention.

In order to improve the adhesiveness of the transparent support to the first and the second alignment films, easy adhesion layers may be formed on the front and the back surfaces of the transparent support.

Other examples of the transparent support include films of cycloolefin polymers, acrylic polymers, polycarbonate polymers, polyester polymers, polystyrene polymers, polyolefin polymers, vinyl chloride polymers, amide polymers, imide polymers, sulfone polymers, polyether sulfone polymers, polyether ether ketone polymers, polyphenylene sulfide polymers, vinylidene chloride polymers, vinyl alcohol polymers, vinyl butyral polymers. acrylate polymers, polyoxymethylene polymers, epoxy polymers, and polymers blends thereof. The polymer film of the present invention may be a hardened layer composed of an ultraviolet hardening resin such as acrylic, urethane, acrylic urethane, epoxy, or silicone resin or of a heat hardening resin.

As the material for forming the transparent support, also preferred is use of thermoplastic norborene resins. As the thermoplastic norbornene resins, there are mentioned Nippon Zeon's Zeonex and Zeonoa; JSR's Arton, etc.

The thickness of the support is not particularly limited and is usually in the range of 5 to 500 μm, preferably 20 to 250 μm, and more preferably 30 to 180 μm. In optical use, a particularly preferred thickness is in the range of 30 to 110 μm.

### Image Layer

The stereo image print of the present invention has image layers each having a dichroic image on the front and the back surfaces of the transparent support. The image layer may be, for example, a layer of an alignment film having a dichroic image formed thereon or a layer of a molecularly aligned film having a dichroic image formed therein with a permeating dichroic dye. In the former layer, the dichroic dye is preferably a liquid crystalline dichroic dye from the viewpoint of reducing crosstalk and ghost images. An embodiment of image-receiving layers composed of alignment films will be described in detail.

Throughout the specification, the term “alignment film” refers to a film capable of regulating the alignment of liquid crystal molecules. Each alignment film has an alignment axis that regulates the alignment of liquid crystal molecules, and the liquid crystal molecules are aligned according to the alignment axis. In an example, liquid crystal molecules are aligned such that the long axes are parallel to the alignment axis. In another example, liquid crystal molecules are aligned such that the long axes are orthogonal to the alignment axis. In the stereo image print of this embodiment, permeation of the liquid crystalline dichroic dye into the alignment film is not essential. The liquid crystalline dichroic dye having aligning ability aligns along the alignment axis by the regulating force of the alignment film. Accordingly, the materials for the alignment film are not required to be determined depending on the combination with the liquid crystalline dichroic dye used for image formation. In this embodiment, for example, even if the main component of the alignment film is a hydrophilic polymer, and image can be formed with a hydrophobic liquid crystalline dichroic dye.

In this embodiment, the alignment film may have any alignment-regulating ability and may be made of any material that allows the dichroic dye molecules to form a desired alignment state. A typical example of the alignment film is a rubbing alignment film that is an organic compound (preferably a polymer) film having a rubbing-treated surface. The alignment film can also be formed by other means, for example, oblique evaporation of an inorganic compound, formation of a layer having microgrooves, or accumulation of an organic compound (e.g., ω-tricosanoic acid, dioctadecyl methyl ammonium chloride, or methyl stearate) by a Langmuir-Blodgett technique (LB film). Furthermore, an alignment film in which alignment-regulating force is generated by application of an electric field, application of a magnetic field, or light irradiation is also known. In particular, in this embodiment, a rubbing alignment film formed by rubbing treatment is preferred from the viewpoint of easiness in control of the pretilt angle of the alignment film. From the viewpoint of uniformity of alignment, a photoalignment film that is formed by light irradiation is preferred.

### Rubbing Alignment Film

The rubbed alignment layer generally comprises a polymer as the main ingredient thereof. Regarding the polymer material for the alignment layer, a large number of substances are described in literature, and a large number of commercial products are available. The polymer material for use in the invention is preferably polyvinyl alcohol or polyimide, and their derivatives. Especially preferred are modified or unmodified polyvinyl alcohols. Polyvinyl alcohols having a different degree of saponification are known. In the invention, preferred is use of those having a degree of saponification of from 85 to 99 or so. Commercial products are usable here, and for example, “PVA103”, “PVA203” (by Kuraray) and others are PVAs having the above-mentioned degree of saponification. Regarding the rubbed alignment layer, referred to are the modified polyvinyl alcohols described in WO01/88574A1, from page 43, line 24 to page 49, line 8, and Japanese Patent 3907735, paragraphs [0071] to [0095]. Preferably, the thickness of the rubbed alignment layer is from 0.01 to 10 micro meters, more preferably from 0.01 to 1 micro meters.

The rubbing treatment may be attained generally by rubbing the surface of a film formed mainly of a polymer, a few times with paper or cloth in a predetermined direction. A general method of rubbing treatment is described, for example, in “Liquid Crystal Handbook” (published by Maruzen, Oct. 30, 2000).

Regarding the method of changing the rubbing density, employable is the method described in “Liquid Crystal Handbook” (published by Maruzen). The rubbing density (L) is quantified by the following (A):

L=N1(l+2πrn/60v) (A)

wherein N means the rubbing frequency, l means the contact length of the rubbing roller, r means the radius of the roller, n is the rotation number of the roller (rpm), and v means the stage moving speed (per second).

For increasing the rubbing density, the rubbing frequency is increased, the contact length of the rubbing roller is prolonged, the radius of the roller is increased, the rotation number of the roller is increased, the stage moving speed is lowered; but on the contrary, for decreasing the rubbing density, the above are reversed.

The relationship between the rubbing density and the pretilt angle of the alignment layer is that, when the rubbing density is higher, then the pretilt angle is smaller, but when the rubbing density is lower, then the pretilt angle is larger.

For sticking an alignment layer to a long polarizing film of which the absorption axis is in the lengthwise direction thereof, preferably, an alignment layer is formed on a long support of polymer film. and then continuosly rubbed in the direction at 45° relative to the lengthwise directions. thereby forming the intended rubbed alignment layer. In this embodiment, on the occasion of forming a dichroic image with the liquid crystalline dichroic dye, it is preferable to perform rubbing treatment at a high rubbing density so as to provide a small pretilt angle and uniform horizontal alignment. That is, the rubbing density L calculated by the expression above is preferably 10 to 1000 mm and more preferably 50 to 500 mm.

### Photoalignment Film

Photo-alignment materials for photo-alignment films that can be used in the present invention may be those described in various documents. Preferred examples of the material for the alignment film of the present invention include are compounds described in JP-A-s. 2006-285197, 2007-76839, 2007-138138, 2007-94071, 2007-121721, 2007-140465, 2007-156439, 2207-133184, and 2009-109831 and Japanese Patent Nos. 3883648 and 4151746; aromatic ester compounds described in JP-A-2002-229039; maleimide and/or alkenyl-substituted nadimide compounds having photo-alignment units described in JP-A-s. 2002-265541 and 2002-317013; photo-crosslinkable silane derivatives described in Japanese Patent Nos. 4205195 and 4205198; and photo-crosslinkable polyimides, polyamides, and esters described in National Publication of International Patent Application Nos. 2003-520878 and 2004-529220 and Japanese Patent 4162850. Particularly preferred are azo compounds and photo-crosslinkable polyimides, polyamides, and esters.

The photoalignment film composed of the above-mentioned material is irradiated with linearly polarized light or unpolarized light to develop an alignment-regulating force. The photoalignment film has an alignment axis along the light irradiation direction.

In the specification, the term “linearly polarized light irraditation” is a process for generating a photoreaction in the photoalignment material. The wavelength of the irradiation light varies depending on the photoalignment material, and any wavelength that can cause the photoreaction can be employed. The peak wavelength of the irradiation light is preferably 200 to 700 nm, and ultraviolet light having a peak wavelength of 400 nm or less is more preferred.

The light source for the light irradiation may be one that is usually used. Examples of the light source include lamps such as a tungsten lamp, a halogen lamp, a xenon lamp, a xenon flash lamp, a mercury lamp, a mercury-xenon lamp, and a carbon arc lamp; various lasers (e.g., a semiconductor laser, a helium-neon laser, an argon ion laser, a helium-cadmium laser, and a YAG laser); light-emitting diodes; and cathode-ray tubes.

The linearly polarized light can be generated by a method using a polarizing plate (e.g., an iodine polarizing plate, dichroic dye polarizing plate, or wire grid polarizing plate), a method using a prism element (e.g., a Glan-Thompson prism) or a reflection of polarizer utilizing Brewstar's angle, or a method using light emitted from a polarized laser light source. Alternately, light having only a necessary wavelength may be selectively employed for irradiation using, for example, a filter or wavelength converter.

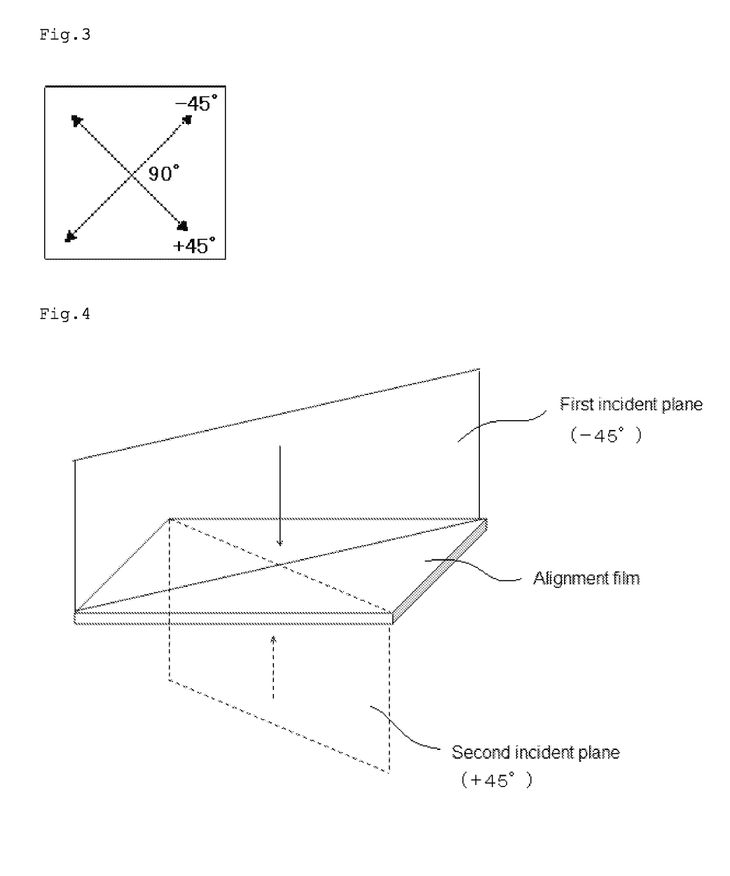

In the case of using linearly polarized light for irradiation, the alignment film is irradiated with the light from the upper surface or back surface side in a direction perpendicular or oblique to the alignment film surface. Though the incident angle of the light varies depending on the photoalignment material, for example, it is 0° to 90° (perpendicular), preferably 40° to 90°. For example, when alignment films tor forming dichroic images satisfying a relationship shown in FIG. 2 are formed from a photoalignment film irradiated with linearly polarized light, as shown in FIG. 4, one alignment film is irradiated with light from a direction parallel to a first incident plane that is perpendicular to the alignment film surface and is in a direction of −45° in the alignment film plane; and the other alignment film is irradiated with light from a direction parallel to a second incident plane that is perpendicular to the alignment film surface and is in a direction of +45° in the alignment film plane. The alignment film is, however, not limited to this example.

In the case of using unpolarized light for irradiation, the alignment film is irradiated with unpolarized light from an oblique direction. The incident angle is 10° to 80°, preferably 20° to 60°, and most preferably 30° to 50°.

The irradiation time is preferably 1 to 60 minutes, more preferably 1 to 10 minutes.

In the above-described example, the image layer includes the alignment film, but the present invention is not limited thereto. As described above, in the case of using a non-liquid crystalline dichroic dye, the image-receiving layer may be a stretched molecularly aligned film. For example, use of films respectively stretched in directions of −45° and +45° allows formation of dichroic images having absorption axes orthogonal to each other.

### Dichroic Dye

The dichroic dye that is used in formation of an image in the present invention will now be described in detail.

In the present invention, a dichroic dye composition containing at least one kind of azo dichroic dye having nematic liquid crystallinity is preferably used for forming an image. In the present invention, the term “dichroic dye” refers to a dye showing different absorbances depending on the direction. The “dichroism” or “dichroic ratio” is calculated as a ration of the absorbance in the absorption axis direction to the absorbance in the polarization axis direction of the polarized light in a dichroic dye layer composed of a dichroic dye composition.

The dichroic dye composition in the present invention preferably contains at least one kind of azo dye represented by the following formula (I), (II), (III), or (IV). The dichroic dyes represented by Formulae (I) to (IV) preferably have nematic liquid crystallinity.

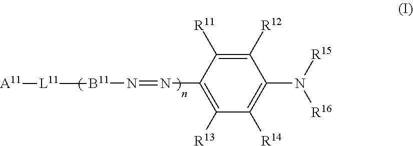

In the formula, R¹¹ to R¹⁴ respectively represent a hydrogen atom or a substituent; R¹⁵ and R¹⁶ respectively represent a hydrogen atom or an optionally-substituted alkyl; L¹¹ represents —N═N—, —CH═N—, —N═CH—, —C(═O)O— or —OC(═O)—; A¹¹ represents an optionally-substituted phenyl, and optionally-substituted naphthyl, or an optionally-substituted aromatic heterocyclic group; B¹¹ represents an optionally-substituted divalent aromatic hydrocarbon group or an optionally-substituted divalent aromatic heterocyclic group; n is an integer from 1 to 5, B¹¹ may be same or different when n is equal to or more than 2.

Examples of the substituent represented by R¹¹-R¹⁴ respectively include alkyls (preferably C₁₋₂₀, more preferably C₁₋₁₂ and even more preferably C₁₋₈ alkyls such as methyl, ethyl, isopropyl, tert-butyl, n-octyl, n-decyl, n-hexadecyl, cyclopropyl, cyclopentyl and cyclohexyl), alkenyls (preferably C₂₋₂₀, more preferably C₂₋₁₂ and even more preferably C₂₋₈ alkenyls such as vinyl, allyl, 2-butenyl and 3-pentenyl), alkynyls (preferably C₂₋₂₀, more preferably C₂₋₁₂ and even more preferably C₂₋₈ alkynyls such as propargyl and 3-pentynyl), aryls (preferably C₆₋₃₀, more preferably C₆₋₂₀, more preferably C₆₋₁₂ aryls such as phenyl, 2,6-diethyl phenyl, 3,5-ditrifluoromethyl phenyl, napthyl and biphenyl), substituted or non-substituted aminos (preferably C₀₋₂₀, more preferably C₀₋₁₀ and even more preferably C₀₋₆ aminos such as non-substituted amino, ethylamino, dimethylamino, diethylamino and anilino), alkoxys (preferably C₁₋₂₀, more preferably C₁₋₁₀ and even more preferably C₁₋₆ alkoxys such as methoxy, othoxy and butoxy), oxycarbonyls (preferably C₂₋₂₀, more preferably C₂₋₁₅ and even more preferably C₂₋₁₀ oxycarbonyls such as methoxcarbonyl, ethoxycarbonayl and phenoxycarbonyl), acyloxys preferably C₂₋₂₀, more preferably C₂₋₁₀ and even more preferably C₂₋₆ acyloxys such as acetoxy and benzoyloxy), acylaminos (preferably C₂₋₂₀, more preferably C₂₋₁₀ and even more preferably C₂₋₆ acylaminos such as acetylamino and benzoylamino), alkoxycarbonylaminos preferably C₂₋₂₀, more preferably C₂₋₁₀ and even more preferably C₂₋₆ alkoxycarbonylaminos such as methoxycarbonylamino), aryloxycarbonylaminos (preferably C₇₋₂₀, more preferably C₇₋₁₆ and even more preferably C₇₋₁₂ aryloxycarbonylaminos such as phenyloxycarbonylamino), sulfonylaminos (preferably C₁₋₂₀, more preferably C₁₋₁₀ and even more preferably C₁₋₆ sulfonylaminos such as methane sulfonylamino and benzene sulfonylamino), sulfamoyls (preferably C₀₋₂₀, more preferably C₀₋₁₀ and even more preferably C₀₋₆ sulfamoyls such as non-substituted sulfamoyl, methyl sulfamoyl, dimethyl sulfamoyl and phenyl sulfamoyl), carbamoyls (preferably C₁₋₂₀, more preferably C₁₋₁₀ and even more preferably C₁₋₆ carbomoyls such as non-substituted carbamoyl, methyl carbamoyl, diethyl carbamoyl and phenylcarbamoyl), alkythios (preferably C₁₋₂₀, more preferably C₁₋₁₀ and even more preferably C₁₋₆ alkylthios such as methylthio and ethylthio), arylthios (preferably C₆₋₂₀, more preferably C₆₋₁₆ and even more preferably C₆₋₁₂ arylthios such that phenylthio), sulfonyls (preferably C₁₋₂₀, more preferably C₁₋₁₀ and even more preferably C₁₋₆ sulfonyls such as mesyl and tosyl), sulfinyls (preferably C₁₋₂₀, more preferably C₁₋₁₀ and even more preferably C₁₋₆ sulfinyls such as methane sulfinyl and benzene sulfinyl), ureidos (preferably C₁₋₂₀, more preferably C₁₋₁₀ and even more preferably C₁₋₆ ureidos such as non-substituted ureido, methyl ureido and phenyl ureido), amide phosphate group (preferably C₁₋₂₀, more preferably C₁₋₁₀ and even more preferably C₁₋₆ amide phosphate group such as diethyl amide phosphate and phenyl amide phosphate), hydroxy, mercapto, halogen atoms (for example, fluorine atom, chlorine atom, bromine atom and iodine atom), cyano, nitro, hydroxamic group, imino (—C═N— or —N═CH—), azo group, heterocyclic group (preferably C₁₋₃₀ and more preferably C₁₋₂ heterocyclic group having at least one hetero atom selected from nitrogen atom, oxygen atom, sulfur atom and so on including imidazolyl, pyridyl, quinolyl, furyl, piperidyl, morpholino, benzoxazolyl, benzoimidazolyl and benzothiazolyl), and silyl group (preferably C₃₋₄₀, more preferably C₃₋₃₀ and even more preferably C₃₋₂₄ silyl group such as trimethyl silyl and triphenyl and silyl.

These substituents may have one or more substituents. Two or more substituents may be same or different. And they may combine to form a ring.

Preferable examples of R¹¹ to R¹⁴ include a hydrogen atom, alkyl, alkoxy and a halogen atom, more preferably a hydrogen atom, alkyl and alkoxy, and even more preferably a hydrogen atom and methyl.

The optionally-substituted alkyl represented by R¹⁵ or R¹⁶ is preferably a C₁₋₂₀, more preferably C₁₋₁₂ and even more preferably C₁₋₈ alkyl such as methyl, ethyl and n-octyl. Examples of the substituent of the alkyl represented by R^{15 l or R}¹⁶ include those exemplified above as a substituent of any of R^{11 to R}¹⁴. When R¹⁵ or R¹⁶ represents an alkyl, it may combine with R¹² or R¹⁴ to form a ring. Preferably, R¹⁵ and R¹⁶ represent a hydrogen atom or alkyl respectively; and more preferably, R¹⁵ and R¹⁶ represent a hydrogen atom, methyl or ethyl respectively.

In the formula, A¹¹ represents an optionally-substituted phenyl, an optionally-substituted naphthyl or an optionally-substituted aromatic heterocyclic group.

The substituent of the phenyl or the naphthyl may be any substituent having at least one group capable of enhancing the solubility or the nematic liquid crystallinity of the azo compound, any substituent having at least one electron-releasing or electron-attracting group capable of controlling the hue of the azo dye, or any substituent having at least one polymerizable group capable of fixing the alignment of the azo compound. And specific examples thereof include those exemplified above as a substituent of any of R¹¹ to R¹⁴. Preferable examples of the substituent include optionally-substituted alkyls, optionally-substituted alkenyls, optionally-substituted alkynyls, optionally-substituted aryls, optionally-substituted alkoxys, optionally-substituted oxycarbonyls, optionally-substituted acyloxys, optionally-substituted acylaminos, optionally-substituted aminos, optionally-substituted alkoxycarbonylaminos, optionally-substituted sulfonylaminos, optionally-substituted sulfamoyls, optionally-substituted carbamoyls, optionally-substituted alkylthios, optionally-substituted sulfonyls, optionally-substituted ureidos, nitro, hydroxy, cyano, imino, azo and halogen atoms; more preferable examples of the substituent include optionally-substituted alkyls, optionally-substituted alkenyls, optionally-substituted aryls, optionally-substituted alkoxys, optionally-substituted oxycarbonyls, optionally-substituted acyloxys, nitro, imino and azo. Among these substituents, regarding each of those having a carbon atom(s), the preferable range of the number of carbon atoms therein is same as that of the substituent represented by each of R¹¹ to R¹⁴.

The phenyl or the naphthyl may have 1 to 5 substituents selected from the above described examples; and preferably, the phenyl or the napthyl may have one substituent selected from the above described examples. Regarding the phenyl, preferably, it has one substituent selected from the above described examples at a para-position with respect to L¹¹.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolylm thiophenyl, thiazolyl, benzothiazolyl, thiadiazolyl, quinolonyl, naphthalimidoyl, and thienothiazoly.

Preferably, the aromatic heterocyclic group is pyridyl, quinolyl, thiazolyl, benzothiazolyl, thiadiazolyl, or thienothiazoly; and more preferably, the aromatic heterocyclic group is pyridyl, benzothiazolyl, or thienothiazoly.

Preferably, A¹¹ represents optionally-substituted phenyl, pyridyl, benzothiazolyl, or thienothiazoly.

In the formula, B¹¹ represents an optionally-substituted divalent aromatic hydrocarbon group or an optionally-substituted divalent aromatic heterocyclic group. In the formula, n is an integer from 1 to 5, and B¹¹ may be same or different when n is equal to or more than 2.

Preferable examples of the aromatic hydrocarbon group include phenyl and napthyl. Preferable examples of the substituent of the aromatic hydrocarbon group include optionally-substituted alkyls, optionally-substituted alkoxys, hydroxy, nitro, halogen atoms, optionally-substituted aminos, optionally-substituted acylaminos and cyano. Among these, optionally-substituted alkyls, optionally-substituted alkoxys and halogen atoms are more preferable; and methyl and halogen atoms are even more preferable.

The aromatic heterocyclic group may be preferably derived from a monocyclic or bicyclic hetero-ring. The atom, embedded in the aromatic heterocyclic group, other than a carbon atom may be a nitrogen, sulfur or oxygen atom. Two or more hetero atoms embedded in the aromatic heterocyclic group may be same or different from each other. Examples of the aromatic heterocyclic group include pyridyl, quinolyl, isoquinolyl, benzothiadiazole, phthalimide, and thienothiazole. Among these, thienothiazole is more preferable.

Examples of the substituent of the aromatic heterocyclic group include alkyls such as methyl and ethyl; alkoxys such as methoxy and ethoxy; aminos such as non-substituted amino and methyl amino; acetylaminos, acylaminos, nitro, hydroxy, cyano and halogen atoms. Among these substituents, regarding each of those having a carbon atom(s), the preferable range of the number of carbon atoms therein is same as that of the substituent represented by each of R¹¹ to R¹⁴.

Preferable examples of the azo dye include those represented by any one of formulas (Ia) to (Ib).

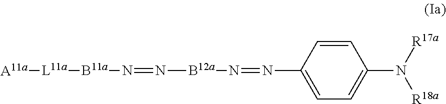

In the formula, R^{17a} and R^{18a} respectively represent a hydrogen atom, methyl or ethyl; L^{11a} represents —N═N—, —N═CH—, —O(C═O)— or —CH═CH—; A^{11a} represents a group (Ia-II) or (Ia-III); and B^{11a} and B^{12a} respectively represent a group (Ia-IV), (Ia-V) or (Ia-VI).

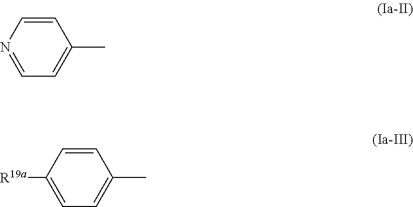

In the formula, R^{19a} represent an optionally-substituted alkyl, an optionally-substituted aryl, an optionally-substituted alkoxy, an optionally-substituted oxycarbonyl, or an optionally-substituted acyloxy.

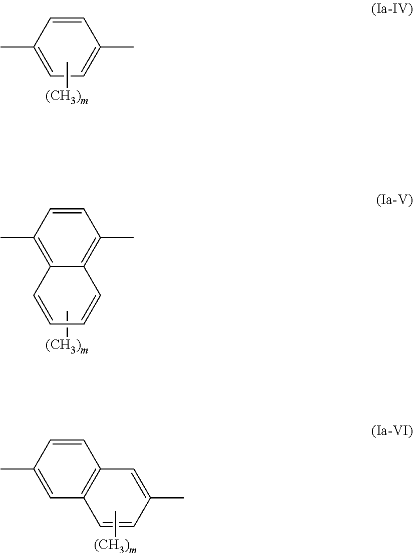

In the formulas, m represents an integer of from 0 to 2.

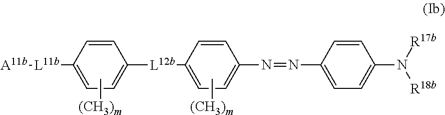

In the formula, R^{17a} and R^{18b} respectively represent a hydrogen atom, methyl or ethyl; L^{11b} represents —N═N— or —(C═O))—; L^{2b} represents —N═CH—, —(C═O)O— or —O(C═O)—; A^{1b} represents a group (Ib-II) or (Ib-III); and m represents an integer of from 0 to 2.

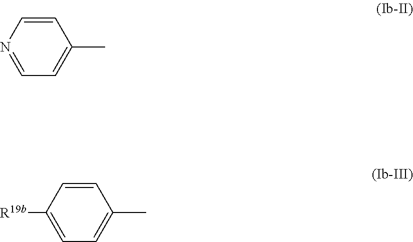

In the formula, R^{19a} represents an optionally-substituted alkyl, an optionally-substituted aryl, an optionally-substituted alkoxy, an optionally-substituted oxycarbonyl, or an optionally-substituted acyloxy.

Examples of the substituent of each of the groups in formulas (Ia) and (Ib) include those exemplified above as a substituent of any of R¹¹ to R¹⁴. Among these substituents, regarding each of those (such as alkyls) having a carbon atom(s), the preferable range of the number of carbon atoms therein is same as that of the substituent represented by each of R^{11 to R}¹⁴.

The compound represented by formula (I), (IA), and (Ib) may have one or more polymerizable groups as a substituent. Using the compound having one or more polymerizable group may contribute to improvement in hardenability. Examples of the polymerizable group include an unsaturated polymerizable group, epoxy group and aziridinyl group; an unsaturated polymerizable group is preferable; and an ethylene unsaturated polymerizable group is more preferable. Examples of the ethylene unsaturated polymerizable group include an acryloyl group and a methacryloyl group.

Preferably, the polymerizable group(s) exists at the molecular end, that is, preferably, the polymerizable group(s) exists as a substituent of R¹⁵ and/or R¹⁶ or as a substituent of A¹¹ in formula (I).

Examples of the compound represented by formula (I) include, but are not limited to, those described below.

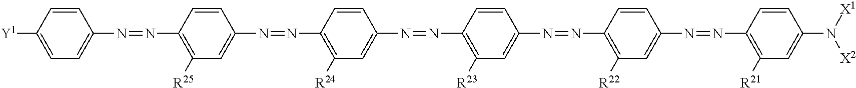

| No. | X¹ | X² | R²¹ | R²² | R²³ | R²⁴ | R²⁵ | Y¹ |
|---|---|---|---|---|---|---|---|---|
| A-1 | —C₂H₅ | —C₂H₅ | —H | —CH₃ | —H | —H | —H | —C₄H₉ |
| A-2 | —C₂H₅ | —C₂H₅ | —H | —CH₃ | —CH₃ | —CH₃ | —H | —C₄H₉ |
| A-3 | —CH₃ | —CH₃ | —H | —CH₃ | —H | —H | —H | —C₄H₉ |

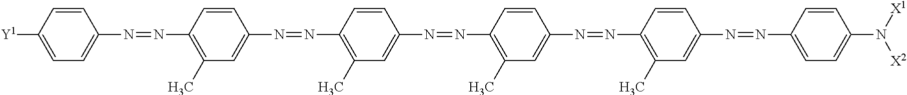

| No. | X¹ | X² | Y¹ |
|---|---|---|---|
| A-4 | —C₂H₅ | —C₂H₅ | 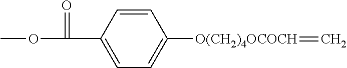 |
| A-5 | —C₂H₅ | —C₂H₅ | 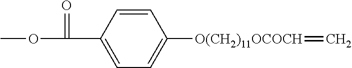 |

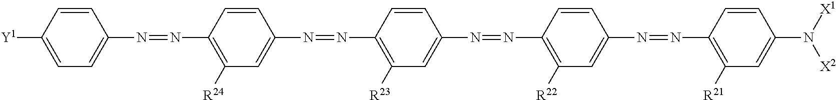

| No. | X¹ | X² | R²¹ | R²² | R²³ | R²⁴ | Y¹ |
|---|---|---|---|---|---|---|---|
| A-9 | —C [symbol] H [symbol] | —C [symbol] H [symbol] | —H | —CH₃ | —H | —H | —C [symbol] H [symbol] |
| A-10 | —C [symbol] H [symbol] | —C [symbol] H [symbol] | —CH₃ | —CH₃ | —H | —H | —C [symbol] H [symbol] |
| A-11 | —C [symbol] H [symbol] | —C [symbol] H [symbol] | —H | —CH₃ | —CH₃ | —CH₃ | —C [symbol] H [symbol] |
| A-15 | —C [symbol] H [symbol] | —C [symbol] H [symbol] | —H | —CH₃ | —CH₃ | —CH₃ | 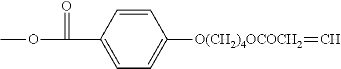 |

[symbol]

indicates data missing or illegible when filed

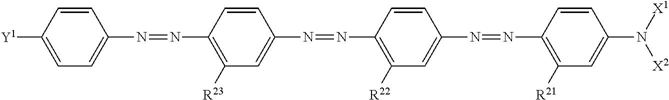

| No. | X¹ | X² | R²¹ | R²² | R²³ | Y¹ |
|---|---|---|---|---|---|---|
| A-16 | —C₂H₅ | —C₂H₅ | —H | —CH₃ | —H | —C₄H₉ |
| A-17 | —C₂H₅ | —C₂H₅ | —H | —CH₃ | —CH₃ | —C₄H₉ |
| A-18 | —C₂H₅ | —C₂H₅ | —H | —CH₃ | —H | 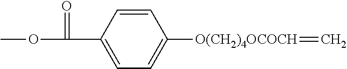 |
| A-19 | —C₂H₅ | —C₂H₅ | —H | —CH₃ | —H | 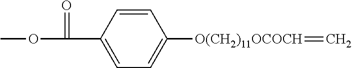 |
| A-24 | —C₂H₅ | —C₂H₅ | —OCH₃ | —CH₃ | —H | —C₄H₉ |
| A-25 | —C₂H₅ | —C₂H₅ | —H | —CH₃ | —CH₃ | 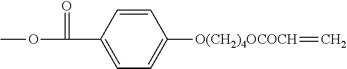 |

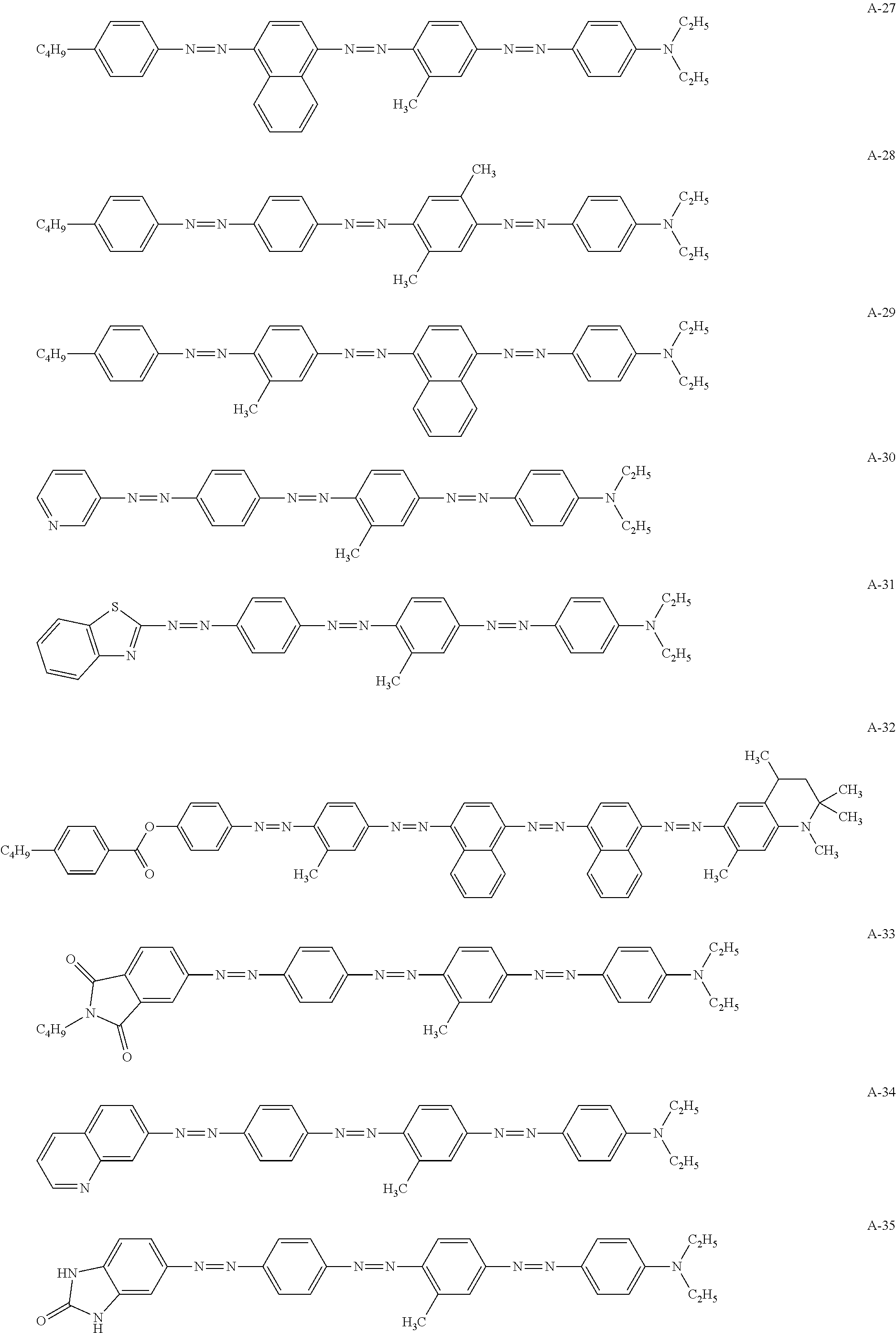

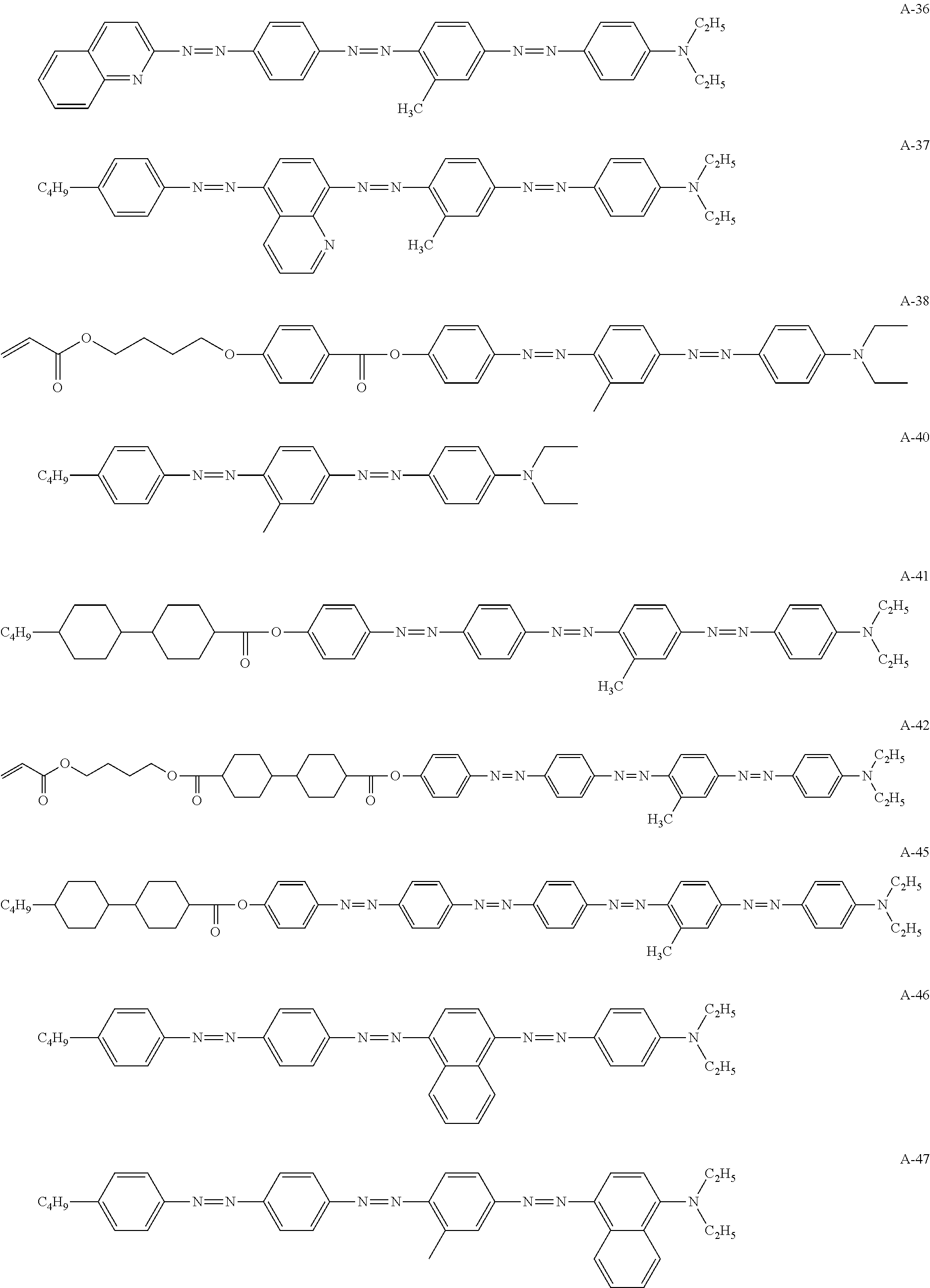

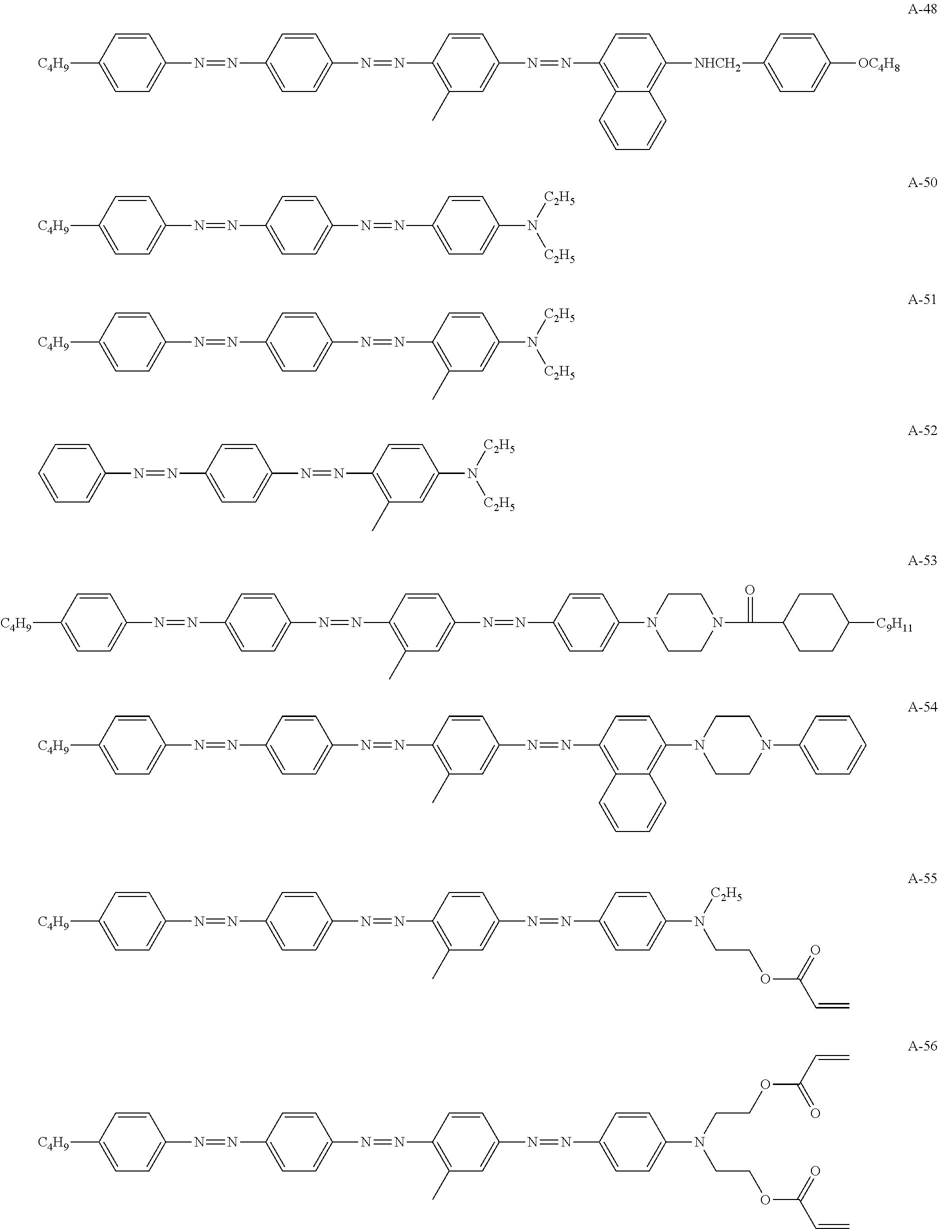

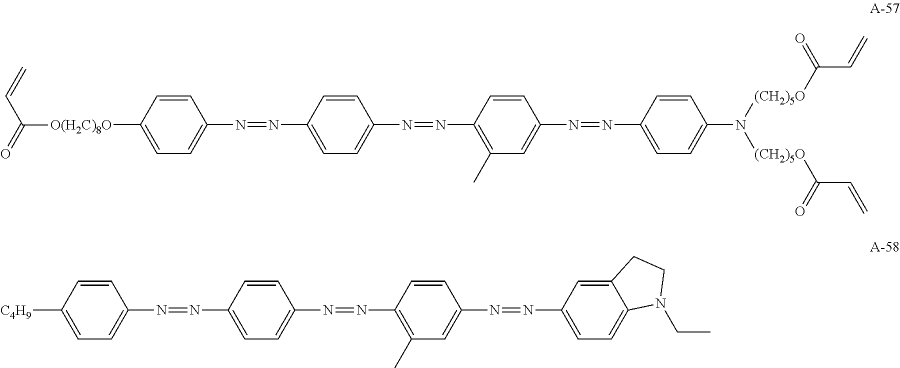

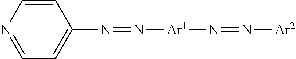

| compound | Ar¹ | Ar² |
|---|---|---|
| B-1 | 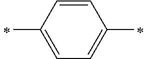 | 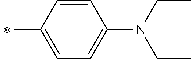 |
| B-2 | 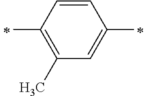 | 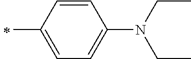 |
| B-3 | 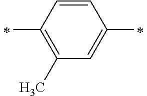 | 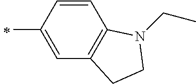 |

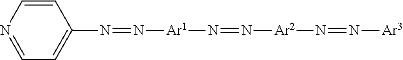

| compound | Ar¹ | Ar² | Ar³ |
|---|---|---|---|
| B-4 | 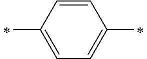 | 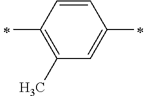 | 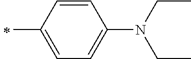 |
| B-5 | 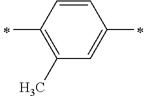 | 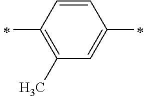 | 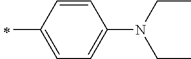 |
| B-6 | 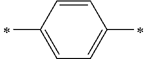 | 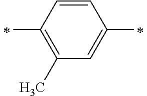 | 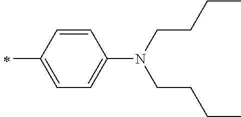 |
| B-7 | 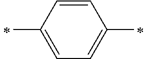 | 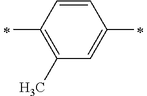 | 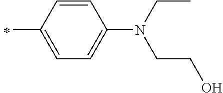 |
| B-8 | 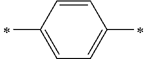 | 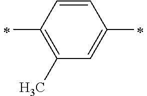 | 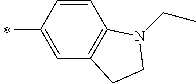 |
| B-9 | 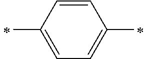 | 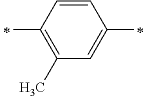 | 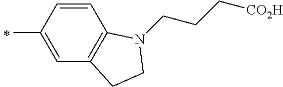 |

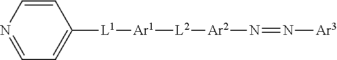

| compound | L¹ | Ar¹ | L² | Ar² | Ar³ |
|---|---|---|---|---|---|
| B-10 | *—N═N—* | 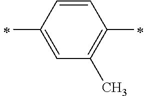 | 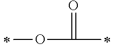 | 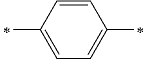 | 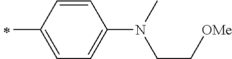 |
| B-11 | *—N═N—* | 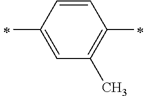 | 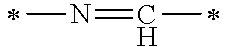 | 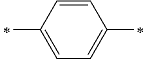 | 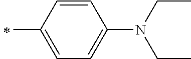 |
| B-12 | 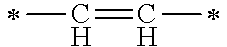 | 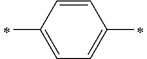 | 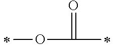 | 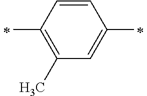 | 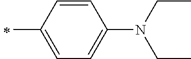 |

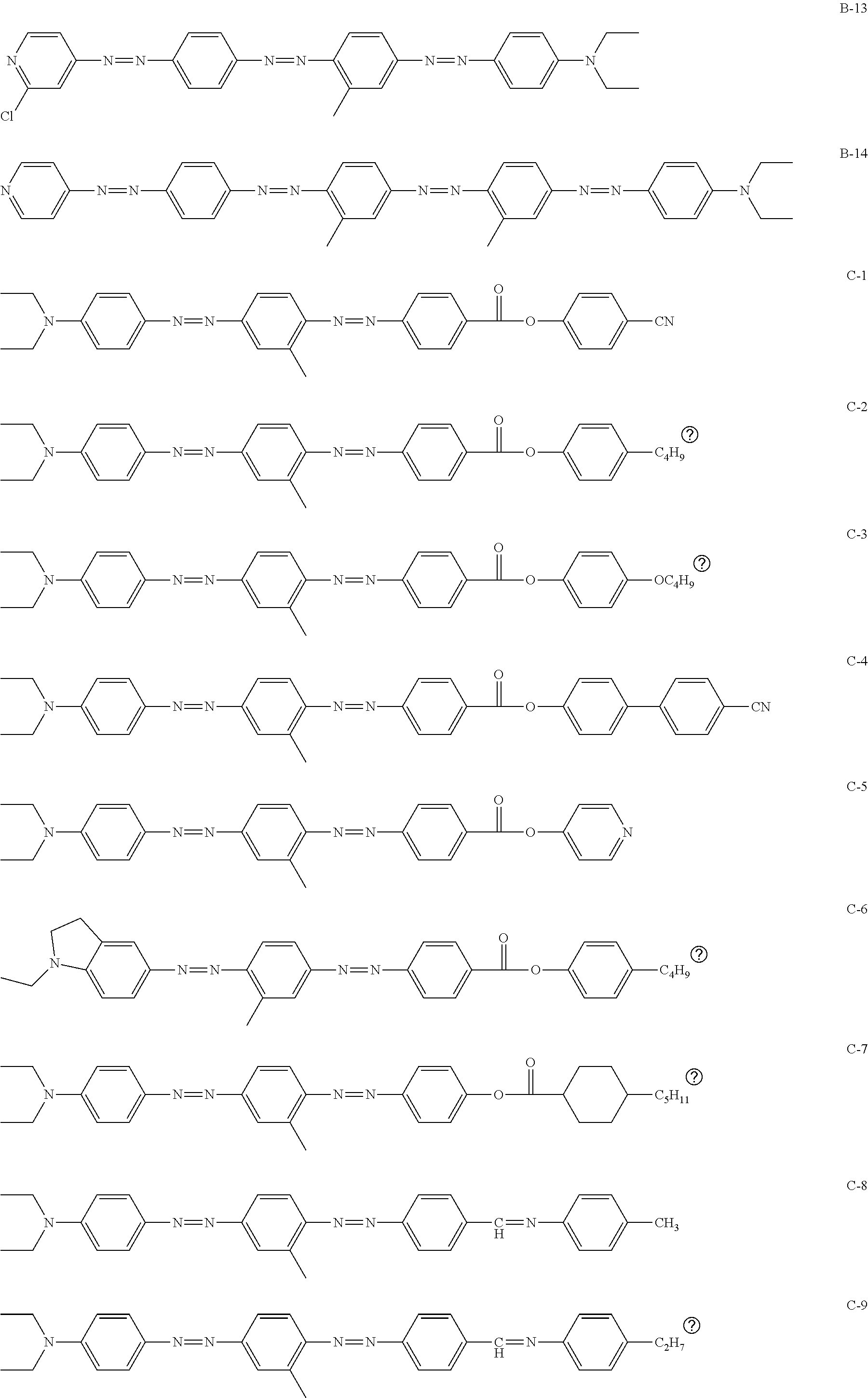

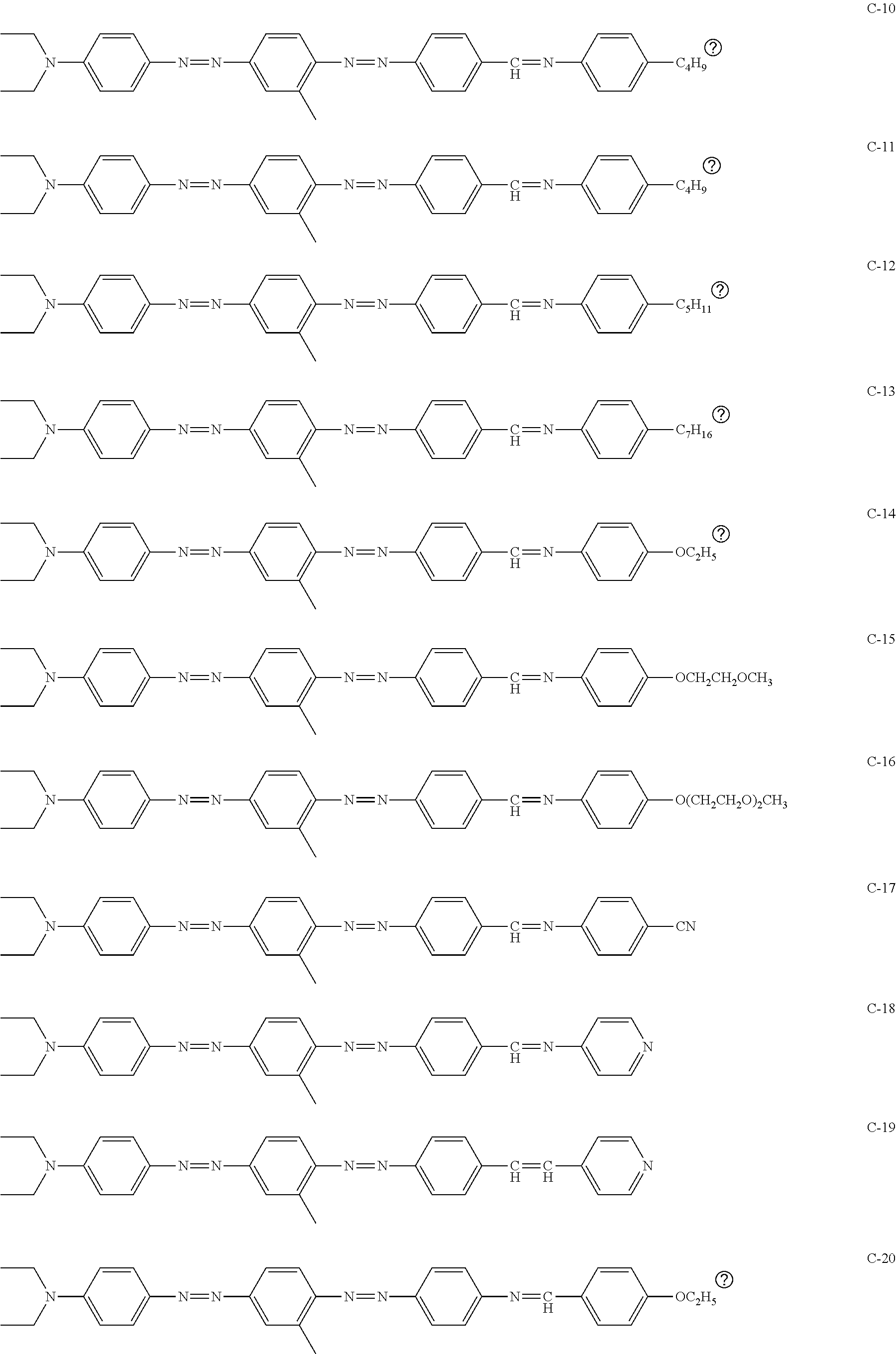

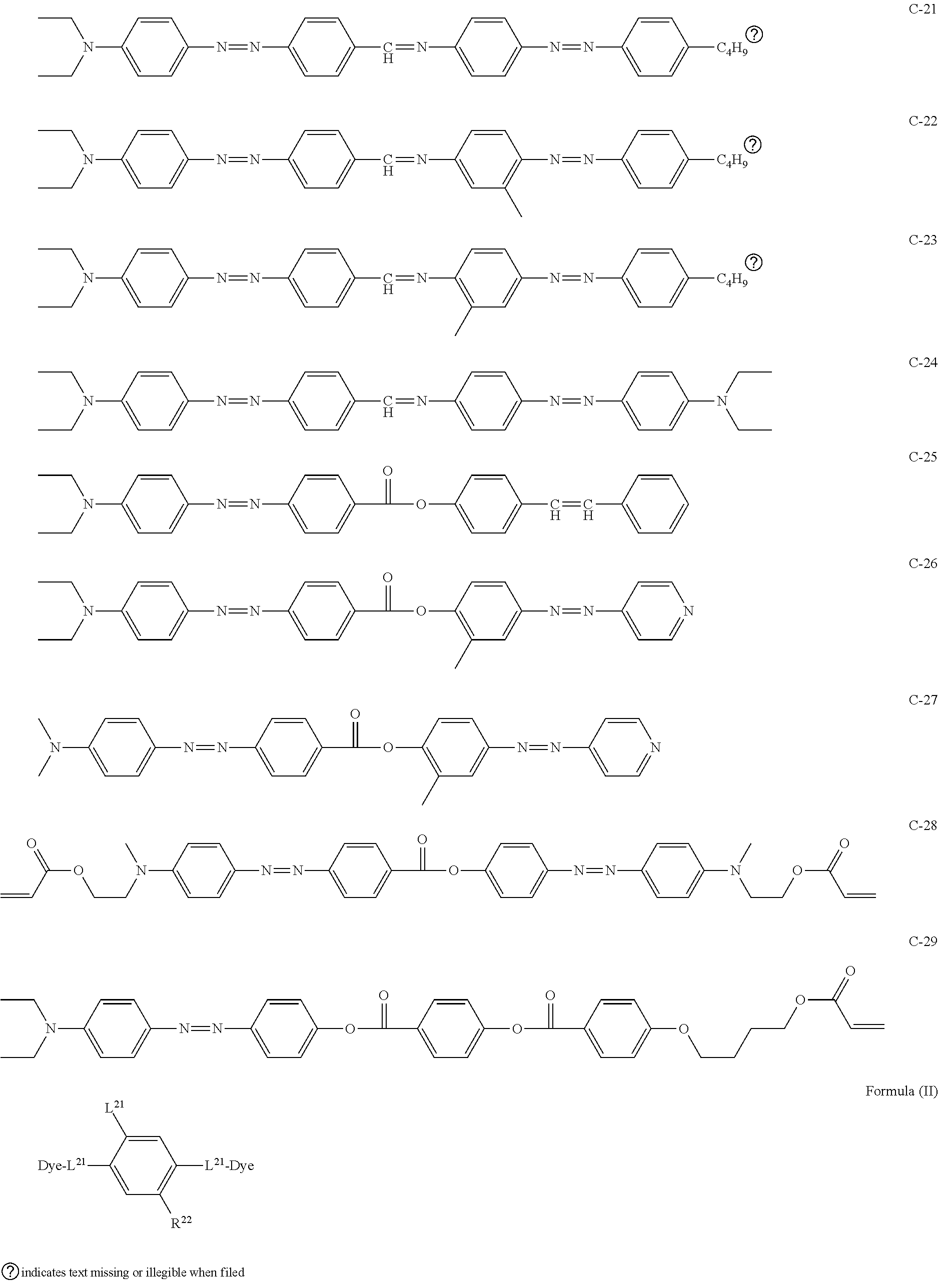

In the formula, R²¹ and R²² each represent a hydrogen atom, an alkyl group, an alkoxy group or a substituent represented by -L²²-Y, provided that at least one of them represents a group other than a hydrogen atom. L²² represents an alkylene group, and one CH₂ group or non-adjacent two or more CH₂ groups present in the alkylene group may each be substituted with —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbons). Y represents a hydrogen atom, a hydroxy group, an alkoxy group, a carboxyl group, a halogen atom or a polymerizable group.

Particularly, it is preferable that one of R²¹ and R²² is a hydrogen atom or an approximately C₁ C₄ short chain substituent and the other of R²¹ and R²² is an approximately C₅ to C₃₀ long chain substituent, since solubility is further improved in this case. In general, it is well known that the molecular shape and anisotropy of polarizability and the like significantly affect realization of liquid crystallinity, and details thereof are described in the Liquid Crystal Handbook (2000, Maruzen) and the like. A typical skeleton of a rod-shaped liquid crystal molecule is composed of a rigid mesogen and flexible end chains along the molecular long axis direction, and in general, lateral substituents along the molecular short axis direction corresponding to R²¹ and R²² in the formula (II) are small substituents not disrupting rotation of the molecule, or substituents are not present. As examples characterized in lateral substituents, examples of stabilization of a smectic phase by introducing a hydrophilic (for example, ionic) lateral substituent are known, however, there are scarcely known examples realizing a stable nematic phase. Particularly, examples in which solubility is improved without lowering the degree of orientation order, by introducing a long chain substituent into a specific substitution position of a rod-shaped liquid crystalline molecule realizing a nematic phase are not known at all.

The alkyl group each represented by R²¹ and R²² includes C₁ to C₃₀ alkyl groups. As examples of the above-described short chain alkyl group, C₁ to C₉ groups are preferable and C₁ to C₄ groups are more preferable. On the other hand, as the above-described long chain alkyl group, C₅ to C₃₀ groups are preferable, C₁₀ to C₃₀ groups are more preferable and C_{10 to C}₂₀ groups are further preferable.

The alkoxy group each represented by R²¹ and R²² includes C₁ C₃₀ alkoxy groups. As examples of the above-described short chain alkoxy group, C₁ to C₈ groups are preferable and C₁ to C₃ groups are more preferable. On the other hand, as the above-described long chain alkoxy group, C₅ to C₃₀ groups are preferable, C₁₀ to C₂₀ groups are more preferable and C₁₀ to C₂₀ groups are further preferable.

As the alkylene group represented by L²² in the substituent represented by -L²²-Y each represented by R²¹ and R²², C₅ to C₃₀ groups are preferable, C₁₀ to C₃₀ groups are more preferable and C₁₀ to C₂₀ groups are further preferable. One CH₂ group or non-adjacent two or more CH₂ groups present in the above-described alkylene group may each be substituted with at least one selected from the group of divalent groups consisting of —O—, —COO—, —OCO—, —OCOO—, —NRCOO—, —OCONR—, —CO—, —S—, —SO₂—, —NR—, —NRSO₂—, and —SO₂NR— (R represents a hydrogen atom or an alkyl group having 1 to 4 carbons). Of course, one CH₂ group or non-adjacent two or more CH₂ groups may also be substituted with two or more groups selected from the group of the above-described divalent groups. CH₂ situated at the end of L²² and linking to Y may be substituted with any of the above-described divalent groups. Further, CH₂ situated at the end of L²² and linking to a phenyl group may be substituted with any of the above-described divalent groups.

Particularly, it is preferable that L²² is an alkyleneoxy group or contains an alkyleneoxy group, and it is further preferable that L²² is a polyethyleneoxy group represented by —(OCH₂CH₂)ₚ— (here, p represents a number of 3 or more, preferably 3 to 10, more preferably 3 to 6) or contains a polyethyleneoxy group, from the standpoint of improvement in solubility.

Examples of -L²²- include, but are not limited to, the following examples. In the following formulae, q is a number of 1 or more, preferably 1 to 10, more preferably 2 to 6. r is 5 to 30, preferably 10 to 30, more preferably 10 to 20.

—(OCH₂CH₂)ₚ—

—(OCH₂CH₂)ₚ—O—(CH₂)_{q}—

—(OCH₂CH₂)ₚ—OC(═O)—(CH₂)_{q}—

—(OCH₂CH₂)ₚ—OC(═O)NH—(CH₂)_{q}—

—O(CH₂)ᵣ—

—(CH₂)ᵣ—

Y in the substituent represented by -L²²-Y each represented by R²¹ and R²² represents a hydrogen atom, a hydroxy group, an alkoxy group (preferably a C₁to C₁₀ alkoxy group, more preferably a C₁ to C₅ alkoxy group), a carboxyl group, a halogen atom or a polymerizable group.

By combining L²² with Y, the end of -L²²-Y can be, for example, a substituent reinforcing the intermolecular interaction such as a carboxyl group, an amino group, an ammonium group and the like, and can be a leaving group such as a sulfonyloxy group, a halogen atom and the like.

The end of -L²²-Y may be a substituent forming a covalent bond to another molecule, such as a crosslinkable group, a polymerizable group and the like, and may also be a polymerizable group such as, for example, —O—C(═O)CH═CH₂, —O— C(═O)C(CH₃)═CH₂ and the like.

When used as a material for a curing film, Y is preferably a polymerizable group (however, here, even if the compound of the above-described formula (II) has no polymerizable group, when a compound to be used together is polymerizable, the alignment of the compound of the formula (II) can be fixed by promoting the polymerization reaction of the other compound). The polymerization reaction is preferably an addition polymaerization (including ring-opening polymerization) or a condensation polymerization. That is, it is preferable that the polymerizable group is a functional group capable of performing an addition polymerization reaction or a condensation polymerization reaction. Examples of the polymerizable group represented by the above-described formula include an acrylate group represented by the following formula (M-1) and a methacrylate group represented by the following formula (M-2).

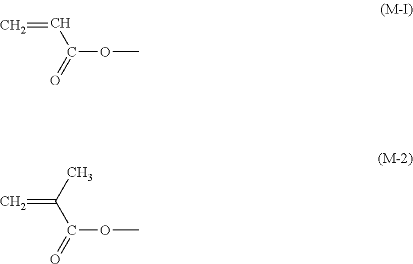

Also, ring-opening polymerizable groups are preferable, and for example, cyclic ether groups are preferable, an epoxy group or an oxetanyl group is more preferable and an epoxy group is particularly preferable.

L²¹s in the above-described formula (II) each represent a linking group selected from the group consisting of an azo group (—N═N—), a carbonyloxy group (—C(═O)O—), an oxycarbonyl group (—O—C(═O)—, an imino group (—N═CH—) and a vinylene group (—C═C—). Among them, a vinylene group is preferable.

Dyes in the above-described formula (II) each represent an azo dye residue represented by the following formula (IIa).

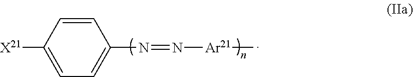

In the formula (IIa), * represents a linkage part to L²¹; X²¹ represents a hydroxy group, a substituted or un-substituted alkyl group, a substituted or un-substituted alkoxy group, an un-substituted amino group or a mono or dialkylamino group; Ar²¹s each represent an aromatic hydrocarbon ring optionally having a substituent or aromatic hetero ring optionally having a substituent; n represents an integer of 1 to 3, and when n is 2 or more, a plurality of Ar²¹s may be mutually the same or different.

The alkyl group represented by X²¹ is preferably a C₁ to C₁₂ alkyl group and more preferably a C₁ to C₆ alkyl group. Specifically, a methyl group, an ethyl group, a propyl group, a butyl group and the like are mentioned. The alkyl group may have a substituent, and examples of the substituent include a hydroxy group, a carboxyl group and a polymerizable group. Preferable examples of the polymerizable group are the same as the preferable examples of the polymerizable group represented by Y described above.

The alkoxy group represented by X²¹ is preferably a C₁ to C₂₀ alkoxy group, more preferably a C₁ to C₁₀ alkoxy group and further preferably a C₁ to C₆ alkoxy group. Specifically, a methoxy group, an ethoxy group, a propyloxy group, a butoxy group, a pentaoxy group, a hexaoxy group, a heptaoxy group, an octaoxy group and the like are mentioned. The alkoxy group may have a substituent, and examples of the substituent include a hydroxy group, a carboxyl group and a polymerizable group. Preferable examples of the polymerizable group are the same as the preferable examples of the polymerizable group represented by Y described above.

The substituted or un-substituted amino group represented by X²¹ is preferably a C₀ to C₂₀ amino group, more preferable a C₀ to C₁₀ amino group and further preferably a C₀ to C₆ amino group. Specifically, an un-substituted amino group, a methylamino group, a dimethylamino group, a diethylamino group, a methyl hexylamino group, an anilino group and the like are mentioned.

Among them, X²¹ is preferably an alkoxy group.

In the above-described formula (II), Ar²¹ represents an aromatic hydrocarbon ring group optionally having a substituent or aromatic heterocyclic group optionally having a substituent. Examples of the aromatic hydrocarbon ring group and the aromatic heterocyclic group include a 1,4-phenylene group, a 1,4-naphthalene group, a pyridine ring group, a pyrimidine ring group, a pyrazine ring group, a quinoline ring group, a thiophene ring group, a thiaxole ring group, a thiadiazole ring group, a thienothiazole ring group and the like. Among them, a 1,4-phenylene group, a 1,4-naphthylene group and a thienothlazole ring group are preferable and a 1,4-phenylene group is most preferable.

The substituent that Ar²¹ optionally has includes preferably an alkyl group having 1 to 10 carbons, a hydroxy group, an alkoxy group having 1 to 10 carbons, a cyano group and the like, more preferably an alkyl group having 1 to 2 carbons and an alkoxy group having 1 to 2 carbons.

n is preferably 1 or 2 and more preferably 1.

Examples of the compound represented by the above-described formula (II) include compounds represented by the following formula (IIb). The meaning of each symbol in the formula is the same as those in the formula (II), and also the preferable range thereof is the same as for the formula (II).

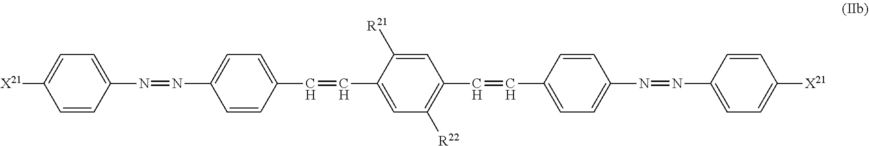

In the formula, it is preferable that X²¹s are mutually the same or different and represent a C₁₋₁₂ alkoxy group; it is preferably that R²¹ and R²² are mutually different, and it is preferable that one of R²¹ and R²² is a hydrogen atom or a C₁ to C₄ short chain substituent (an alkyl group, an alkoxy group or a substituent represented by -L²²-Y) and the other of R²¹ and R²² is a C₅ to C₃₀ long chain substituent (an alkyl group, an alkoxy group or a substituent represented by -L²²-Y). Alternatively, it is also preferable that R²¹ and R²² each represent a substituent represented by -L²²-Y and L²² is an alkyleneoxy group or contains an alkyleneoxy group.

Specific examples of the compound represented by the above-described formula (II) include, but are not limited to, the following compound examples.

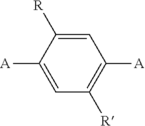

| | A | R |
|---|---|---|
| A2-1 | 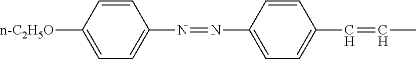 | MeO |
| A2-2 | 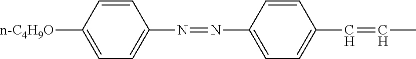 | MeO |
| A2-3 | 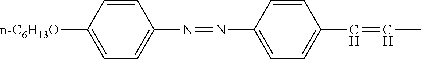 | MeO |
| A2-4 | 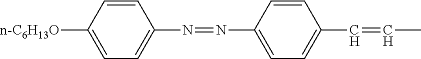 | MeO |
| A2-5 | 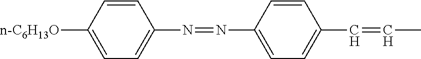 | MeO |
| A2-6 | 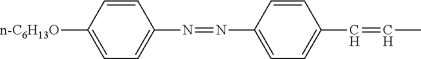 | MeO |
| A2-7 | 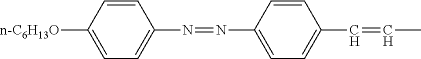 | MeO |
| A2-8 | 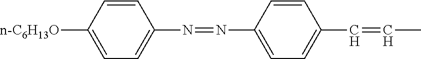 | MeO |
| A2-9 | 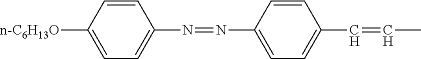 | MeO |
| A2-10 | 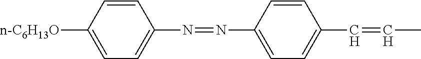 | —(OCH₂CH₂)₃—OMe |
| A2-11 | 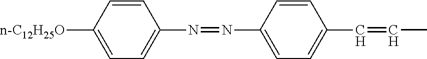 | MeO |
| A2-12 | 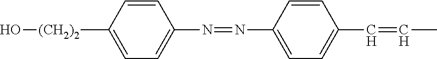 | MeO |
| A2-13 | 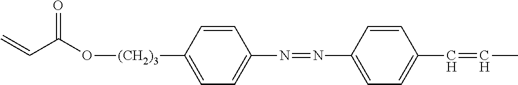 | MeO |
| A2-14 | 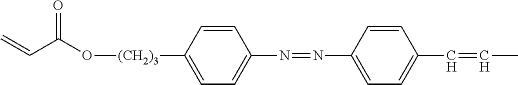 | MeO |

| | R′ |
|---|---|
| A2-1 | —(OCH₂CH₂)₃—OMe |
| A2-2 | —(OCH₂CH₂)₃—OMe |
| A2-3 | —(OCH₂CH₂)₃—OMe |
| A2-4 | —(OCH₂CH₂)₃—OH |
| A2-5 | —(OCH₂CH₂) [symbol] —OH |
| A2-6 | 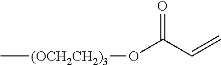 |
| A2-7 | 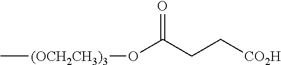 |
| A2-8 | 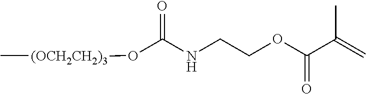 |
| A2-9 | —OC₁₉H₃₇-n |
| A2-10 | —(OCH₂CH₂)₃—OMe |
| A2-11 | —(OCH₂CH₂)₃—OMe |
| A2-12 | —(OCH₂CH₂)₃—OH |
| A2-13 | 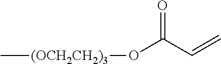 |
| A2-14 | —(OCH₂CH₂)₃—OMe |

[symbol]

indicates data missing or illegible when filed

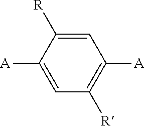

| | A | R | R′ |
|---|---|---|---|
| A2-15 | 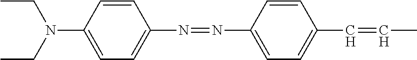 | MeO | —(OCH₂CH₂)₃—OH |
| A2-16 | 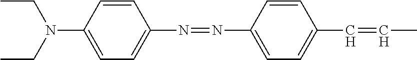 | MeO | —OC₁₈H₃₇-n |
| A2-17 | 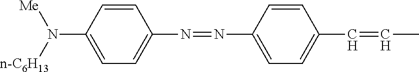 | MeO | —(OCH₂CH₂)₃—OH |
| A2-18 | 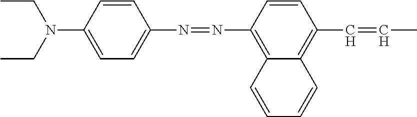 | MeO | —(OCH₂CH₂)₃—OH |
| A2-19 | 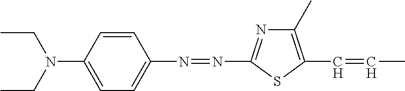 | MeO | —(OCH₂CH₂)₃—OH |
| A2-20 | 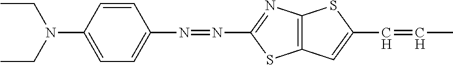 | MeO | —(OCH₂CH₂)₃—OH |
| A2-21 | 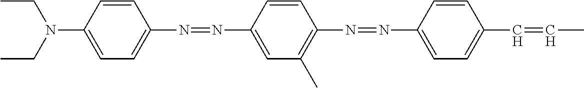 | MeO | —(OCH₂CH₂)₃—OH |
| A2-22 | 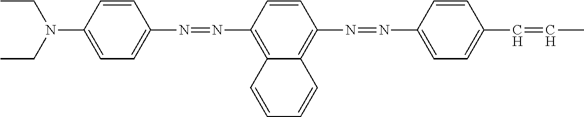 | MeO | —(OCH₂CH₂)₃—OH |
| A2-23 | 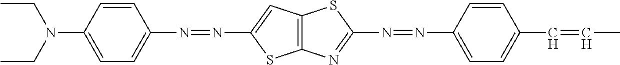 | MeO | —(OCH₂CH₂)₃—OH |

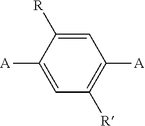

| | A | R | R′ |
|---|---|---|---|
| A2-24 | 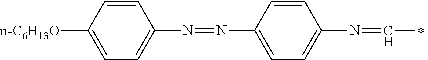 | MeO | *—(OCH₂CH₂)₂—OH |
| A2-25 | 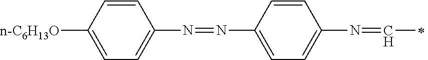 | MeO | *—OC₁₂H₂₅-n |
| A2-26 | 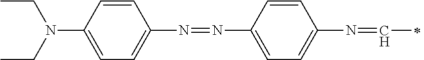 | MeO | *—(OCH₂CH₂)₃—OH |
| A2-27 | 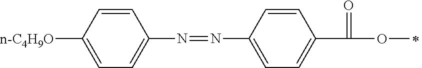 | MeO | *—(OCH₂CH₂)₃—OH |
| A2-28 | 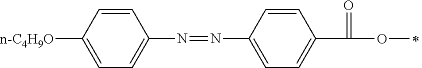 | H | *—OC₁₈H₃₇-n |
| A2-29 | 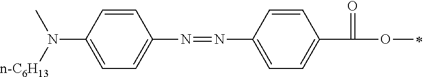 | MeO | *—(OCH₂CH₂)₃—OMe |
| A2-30 | 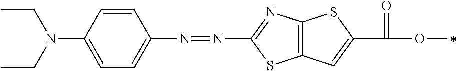 | MeO | *—(OCH₂CH₂)₃—OH |
| A2-31 | 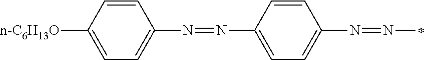 | MeO | *—(OCH₂CH₂)₃—OH |
| A2-32 | 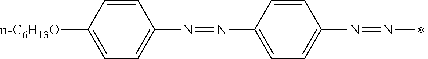 | MeO | *—(OCH₂CH₂CH₂)₃—OH |
| A2-33 | 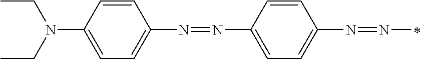 | MeO | *—(OCH₂CH₂)₃—OMe |
| A2-34 | 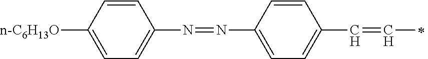 | MeO | MeO |

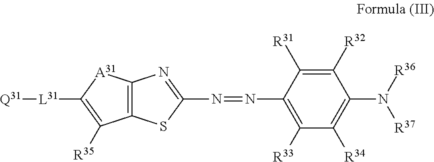

In the formula, R³¹ to R³⁵ each represent independently a hydrogen atom or a substituent; R³⁶ and R³⁷ each represent independently a hydrogen atom or an alkyl group optionally having a substituent; Q³¹ represents an aromatic hydrocarbon group optionally having a substituent, an aromatic heterocyclic group optionally having a substituent or a cyclohexane ring group optionally having a substituent; L³¹ represents a divalent linking group; A³¹ represents an oxygen atom or a sulfur atom.

Examples of the substituent represented by R³¹ to R³⁵ are the same as the examples of the substituent each represented by R¹¹ to R¹⁴ in the above-described formula (I). The examples thereof include preferably a hydrogen atom, an alkyl group, an alkoxy group and a halogen atom, particularly preferably a hydrogen atom, an alkyl group and an alkoxy group and most preferably a hydrogen atom or methyl group.

The alkyl group optionally having a substituent represented by R³⁶ and R³⁷ in the above-described formula (III) is an alkyl group preferably having 1 to 20 carbons, more preferably having 1 to 12 carbons and particularly preferably having 1 to 8 carbons, and examples thereof include a methyl group, an ethyl group, an n-octyl group and the like. The substituent on the alkyl group represented by R³⁶ and R³⁷ is the same as the substituent represented by R³¹ to R³⁵ described above. When R³⁶ and R³⁷ represent an alkyl group, they may be mutually linked to form a cyclic structure. When R³⁶ or R³⁷ represents an alkyl group, each of them may be linked to R³² or R³⁴ to form a cyclic structure.

The group represented by R³⁶ and R³⁷ particularly preferably a hydrogen atom or an alkyl group and further preferably a hydrogen atom, a methyl group or an ethyl group.

In the above-described formula (II), Q³¹ represents an aromatic hydrocarbon group optionally having a substituent (preferably having 1 to 20 carbons and more preferably having 1 to 10 carbons, and examples thereof include a phenyl group, a naphthyl group and the like), an aromatic heterocyclic group optionally having a substituent or a cyclohexane ring group optionally having a substituent.

The substituent optionally carried on the group represented by Q³¹ is preferably a group introduced to enhance solubility or nematic liquid crystallinity of an azo compound, a group having an electron donative property or an electron withdrawing property introduced to adjust the color tone as a dye or a group having a polymerizable group introduced to fix alignment, and specifically, is the same as the substituent represented by R³¹ to R³⁵ described above. Preferable are an alkyl group optionally having a substituent, an alkenyl group optionally having a substituent, an alkynyl group optionally having a substituent, an aryl group optionally having a substituent, an alkoxy group optionally having a substituent, an oxycarbonyl group optionally having a substituent, an acyloxy group optionally having a substituent, an acylamino group optionally having a substituent, an amino group optionally having a substituent, an alkoxycarbonylamino group optionally having a substituent, a sulfonylamino group optionally having a substituent, a sulfamoyl group optionally having a substituent, a carbamoyl group optionally having a substituent, an alkylthio group optionally having a substituent, a sulfonyl group optionally having a substituent, a ureide group optionally having a substituent, a nitro group, a hydroxy group, a cyano group, an imino group, an azo group and a halogen atom, and particularly preferable are an alkyl group optionally having a substituent, an alkenyl group optionally have a substituent, an aryl group optionally having a substituent, an alkoxy group optionally having a substituent, an oxycarbonyl group optionally having a substituent, an acyloxy group optionally having a substituent, a nitro group, an imino group and an azo group. the preferably range of the number of carbon atoms of the above-mentioned substituents having a carbon is the same as the preferably range of the number of carbon atoms for the substituents represented by R³¹ to R³⁵.

The aromatic hydrocarbon group, the aromatic heterocyclic group or the cyclohexane ring group may have 1 to 5 of these substituents, and preferably, has one substituent. When Q³¹ is a phenyl group, it is preferable that one substituent is carried at a para-position with respect to L³¹, and when Q³¹ is a cyclohexane ring group, it is preferable that one substituent is carried in trans configuration at a 4-position with respect to L³¹.

As the aromatic heterocyclic group represented by Q³¹, groups derived from monocyclic or bicyclic hetero rings are preferable. The atoms other than carbon, constituting the aromatic heterocyclic group, include a nitrogen atom, s sulfur atom and an oxygen atom. When the aromatic heterocyclic group has two or more ring constituent atoms other than carbon, these may be the same or different. The aromatic heterocyclic group includes, specifically, a pyridyl group, a quinolyl group, a thiophenyl group, a thiazolyl group, a benzothiazolyl group, a thiadiazolyl group, a quinolonyl group, a naphthalimidyl group, a thienothiazolyl group and the like.

The aromatic heterocyclic group is preferably a pyridyl group, a quinolyl group, a thiazolyl group, a benzothiazolyl group, a thiadiazolyl group or a thienothiazolyl group, particularly preferably a pyridyl group, a benzothiazolyl group, a thiadiazolyl group or a thienothiazolyl group, most preferably a pyridyl group, a benzothiazolyl group or a thienothiazolyl group.

The group represented by Q³¹ is particularly preferably a phenyl group optionally having a substituent, a naphthyl group optionally having a substituent, a pyridyl group optionally having a substituent, a benzothiazolyl group optionally having a substituent, a thienothiazolyl group optionally having a substituent or a cyclohexane ring group optionally having a substituent, more preferably a phenyl group, a pyridyl group, a benzothiazolyl group or a cyclohexane ring group.

The linking group represented by L³¹ in the above-described formula (III) includes a single bond, alkylene a groups (preferably having 1 to 20 carbons, more preferably having 1 to 10 carbons and particularly preferably having 1 to 6 carbons, and examples thereof include a methylene group, an ethylene group, a propylene group, a butylene group, a pentylene group, a cyclohexane-1,4-diyl group and the like), alkenylene groups (preferably having 2 to 20 carbons, more preferably having 2 to 10 carbons and particularly preferably having 2 to 6 carbons, and examples thereof include an ethenylane group and the like), alkynlene groups (preferably having 2 to 20 carbons, more preferably having 2 to 10 carbons and particularly preferably having 2 to 6 carbons, and examples thereof include an ethynylene group and the like), alkyleneoxy groups (preferably having 1 to 20 carbons, more preferably having 1 to 10 carbons and particularly preferably having 1 to 6 carbons, and examples thereof include a methyleneoxy group and the like), an amide group, an ether group, an acyloxy group (—C(═O)O—), an oxycarbonyl group (—OC(═O)—), an imino group (—CH═N— or —N═CH—), a sulfoamide group, a sulfonate group, a ureide group, a sulfonyl group, a sulfinyl group, a thioether group, a carbonyl group, an —NR— group (here, R represents a hydrogen atom, an alkyl group or an aryl group), an azo group, an azoxy group, or divalent linking groups having 0 to 60 carbons constituted by combining two or more of them.

The group represented by L⁻is particularly preferably a single bond, an amide group, an acyloxy group, an oxycarbonyl group, an imino group, an azo group or an azoxy group, more further preferably an azo group, an acyloxy group, an oxycarbonyl group or an imino group.

In the above-described formula (III), A⁻represents an oxygen atom, or a sulfur atom, preferably a sulfur atom.

The compound represented by the above-described formula (III) may have a polymerizable group as a substituent. It is preferable to have a polymerizable group since a film curing property is improved. Examples of the polymerizable group include unsaturated polymerizable groups, an epoxy group and an aziridinyl group, and unsaturated polymerizable groups are preferable and an ethylenically unsaturated polymerizable group is particularly preferable. Examples of the ethylenically unsaturated polymerizable group include an acryloyl group and a methacryloyl group.

It is preferable that the polymerizable group is situated at the molecular end, that is, it is preferable that, in the formula (III), the polymerizable group is present as a substituent of R³⁶ and/or R³⁷ and as a substituent of Q¹.

Among compounds represented by the above-described formula (III), particularly preferable are compounds represented by the following formula (IIIa).

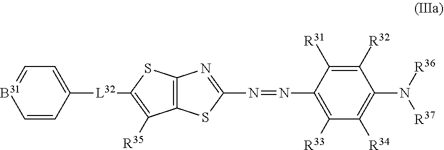

In the formula, R³¹ to R³⁵ are the same as those in the above-described formula (III), and also the preferable range thereof is the same as for the formula (III). B³¹ represents a nitrogen atom or a carbon atom optionally having a substituent; L³² represents an azo group, an acyloxy group (—C(═O)O—), an oxycarbonyl group (—OC(═O—) or an imino group.

In the above-described formula (IIIa), R³⁵ represents preferably a hydrogen atom or a methyl group and more preferably a hydrogen atom.

The substituent optionally carried when B³¹ is a carbon atom in the above-described formula (IIIa) is the same as the substituent optionally carried on Q³¹ in the above-described formula (III), and also the preferable range thereof is the same as for the formula (III).

In the above-described formula (IIIa), L³² represents an azo group, an acyloxy group, an oxycarbonyl group or an imino group, preferably an azo group, an acyloxy group or an oxycarbonyl group and more preferably an azo group.

Specific examples of the compound represented by the formula (III) include, but are not limited to, the following specific example.

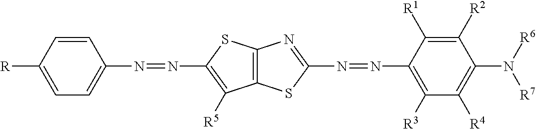

| No. | R¹ | R² | R³ | R⁴ | R⁵ | R⁶ | R⁷ | R |
|---|---|---|---|---|---|---|---|---|
| A3-1 | —H | —H | —H | —H | —H | —C₂H₅ | —C₂H₅ | —C₄H₉ |
| A3-2 | —H | —H | —H | —H | —H | —C₂H₅ | —C₂H₅ | —C₆H₁₃ |
| A3-3 | —H | —H | —H | —H | —H | —C₂H₅ | —C₂H₅ | —C₇H₁₅ |
| A3-4 | —H | —H | —H | —H | —H | —C₂H₅ | —C₂H₅ | —OC₄H₉ |
| A3-5 | —H | —H | —H | —H | —H | —C₂H₅ | —C₂H₅ | —CF₃ |
| A3-6 | —H | —H | —H | —H | —H | —C₂H₅ | —C₂H₅ | —OH |
| A3-7 | —H | —H | —H | —H | —H | —C₂H₅ | —C₂H₅ | —CN |
| A3-8 | —H | —H | —H | —H | —H | —C₂H₅ | —C₂H₅ | —NO₂ |
| A3-9 | —H | —H | —H | —H | —H | —C₂H₅ | —C₂H₅ | —F |
| A3-10 | —H | —H | —H | —H | —H | —C₂H₅ | —C₂H₅ | —Br |
| A3-11 | —H | —H | —H | —H | —H | —C₂H₅ | —C₂H₅ | —I |
| A3-12 | —H | —H | —H | —H | —H | —CH₃ | —H | —C₄H₉ |
| A3-13 | —H | —H | —H | —H | —H | —CH₃ | —CH₃ | —C₄H₉ |
| A3-14 | —H | —H | —H | —H | —H | —CH₃ | —C₆H₁₃ | —C₄H₉ |
| A3-15 | —H | —H | —H | —H | —H | —CH₃ | —CH₂CH₂OH | —C₄H₉ |
| A3-16 | —H | —H | —H | —H | —H | —CH₃ | —CH₂CH₂OCH₃ | —C₄H₉ |
| A3-17 | —H | —H | —H | —H | —H | —CH₃ | —CH₂CH₂OCOCH═CH₂ | —C₄H₉ |
| A3-18 | —H | —H | —H | —H | —H | —CH₃ | —CH₂CH₂CN | —C₄H₉ |
| A3-19 | —H | —H | —H | —H | —H | —CH₂CH₂OCOCH═CH₂ | —CH₂CH₂OCOCH═CH₂ | —C₄H₉ |
| A3-20 | —CH₃ | —H | —H | —H | —H | —C₂H₅ | —C₂H₅ | —C₄H₉ |
| A3-21 | —F | —H | —H | —H | —H | —C₂H₅ | —C₂H₅ | —C₄H₉ |
| A3-22 | —Cl | —H | —H | —H | —H | —C₂H₅ | —C₂H₅ | —C₄H₉ |
| A3-23 | —OH | —H | —H | —H | —H | —C₂H₅ | —C₂H₅ | —C₄H₉ |
| A3-24 | —OCH₃ | —H | —H | —H | —H | —C₂H₅ | —C₂H₅ | —C₄H₉ |
| A3-25 | —H | —OCH₃ | —OCH₃ | —H | —H | —C₂H₅ | —C₂H₅ | —C₄H₉ |
| A3-26 | —H | —H | —H | —H | —CH₃ | —C₂H₅ | —C₂H₅ | —C₄H₉ |

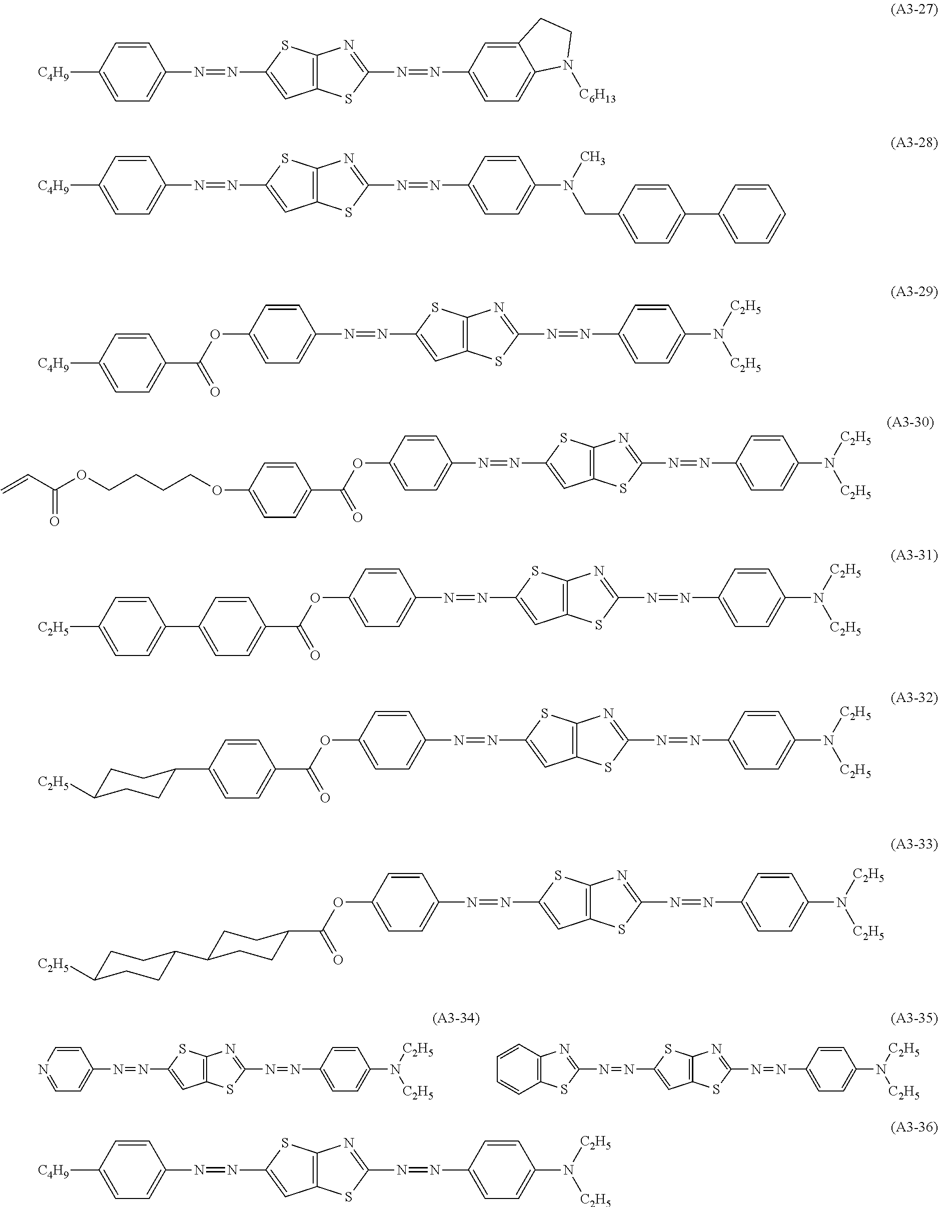

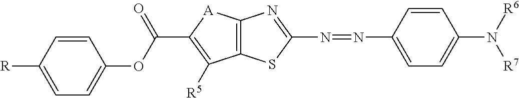

| No. | A | R⁵ | R⁶ | R⁷ | R |
|---|---|---|---|---|---|
| A3-37 | S | —H | —C₂H₅ | —C₂H₅ | —C₄H₉ |
| A3-38 | S | —H | —C₂H₅ | —C₂H₅ | —C₇H₁₅ |
| A3-39 | S | —H | —C₂H₅ | —C₂H₅ | —CN |
| A3-40 | S | —H | —C₂H₅ | —C₂H₅ | —Br |
| A3-41 | S | —CH₃ | —C₂H₅ | —C₂H₅ | —C₄H₉ |
| A3-42 | S | —H | —CH₃ | —CH₃ | —C₄H₉ |
| A3-43 | O | —H | —C₂H₅ | —C₂H₅ | —C₄H₉ |

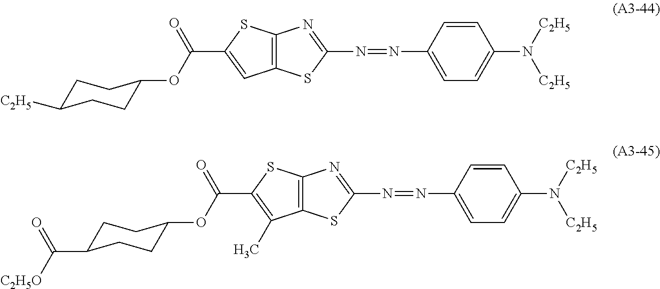

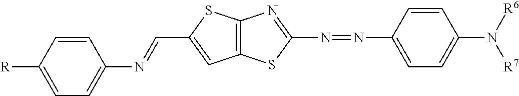

| No. | R⁶ | R⁷ | R |
|---|---|---|---|
| A3-46 | —C₂H₅ | —C₂H₅ | —C₄H₉ |
| A3-47 | —C₂H₅ | —C₂H₅ | —OC₄H₉ |
| A3-48 | —C₂H₅ | —C₂H₅ | —CF₃ |
| A3-49 | —C₂H₅ | —C₂H₅ | —F |
| A3-50 | —CH₃ | —CH₃ | —C₄H₉ |

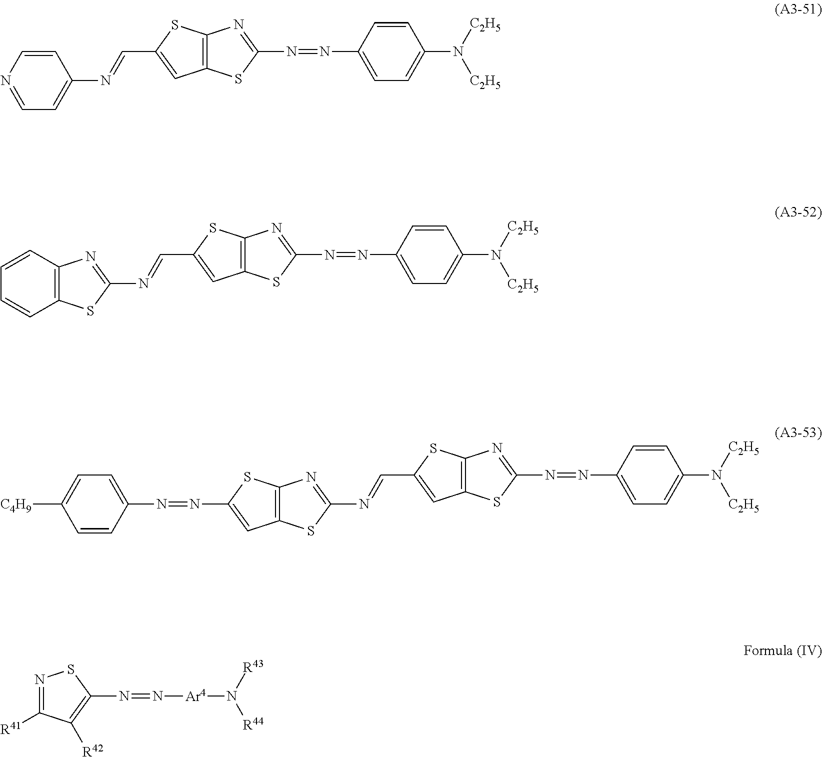

In the formula, R⁴¹ and R⁴² each represent a hydrogen atom or a substituent, and may be mutually linked to form a ring; Ar⁴ represents an optionally substituted divalent aromatic hydrocarbon group or aromatic heterocyclic group; R⁴³ and R⁴⁴ each represent a hydrogen atom or an optionally substituted alkyl group, and may be mutually linked to form a hetero ring.

Examples of the substituent each represented by R⁴¹ and R⁴² in the formula (IV) are the same as examples of the substituent each represented by R¹¹ to R¹⁴ in the above-described formula (I). R⁴¹ and R⁴² include preferably a hydrogen atom, an alkyl group, an alkoxy group, a halogen atom, a cyano group, a nitro group and a sulfo group, more preferably a hydrogen atom, an alkyl group, a halogen atom, a cyano group and a nitro group, further preferably a hydrogen atom, an alkyl group and a cyano group and more further preferably a hydrogen atom, a methyl group and a cyano group.

It is also preferable that R⁴¹ and R⁴² are mutually linked to form a ring. Particularly, it is preferable to form an aromatic hydrocarbon group or an aromatic heterocyclic group. As the aromatic heterocyclic group, groups derived from monocyclic or bicyclic hetero rings are preferable. The atoms other than carbon, constituting the aromatic heterocyclic group, include a nitrogen atom, a sulfur atom and an oxygen atom. When the aromatic heterocyclic group has two or more ring constituent atoms other than carbon, these may be the same or different. The aromatic heterocyclic group includes, specifically, a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The cyclic group formed by mutually linking R⁴¹ and R⁴² is preferably a benzene ring, a naphthalene ring, a pyridine ring, a pyrazine ring, a pyrimidine ring or a pyridazine ring, more preferably a benzene ring or a pyridine ring and most preferably a pyridine ring.

The cyclic group formed by mutually linking R⁴¹ and R⁴² may have a substituent, and the range thereof is the same as the range of the group represented by R¹ and R², and also the preferable range thereof is the same as for the group represented by R¹ and R².

Examples of the compound represented by the above-described formula (IV) include compounds represented by the following formula (IV′).

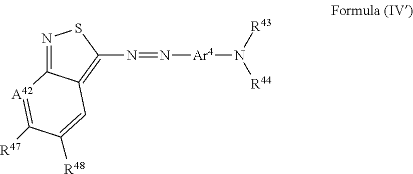

In the formula, the same symbols as in the formula (IV) have the same meanings, and also the preferable range thereof is the same. A⁴² represents N or CH, and R⁴⁷ and R⁴⁸ each represent a hydrogen atom or a substituent. It is preferable that one of R⁴⁷ and R⁴⁸ is a substituent, and it is also preferable that R⁴⁷ and R⁴⁸ both represent a substituent. Preferable examples of the substituent are the same as examples of the substituent represented by R⁴¹ and R⁴², that is, preferable are an alkyl group, an alkoxy group, a halogen atom, a cyano group, a nitro group and a sulfo group, more preferable are an alkyl group, a halogen atom, a cyano group and a nitro group, further prferable are an alkyl group and a cyano group and most prferable are a methyl. group and a cyano group. For example, compounds in which one of R⁴⁷ and R⁴⁸ is an alkyl group having the number of carbon atoms of 1 to 4 and the other is a cyano group are also preferable.

As the aromatic heterocyclic group represented by Ar⁴ in the formula (IV′), groups derived from monocyclic or bicyclic hetero rings are preferable. The atoms other than carbon, constituting the aromatic heterocyclic group, include a nitrogen atom, a sulfur atom and an oxygen atom. When the aromatic heterocyclic group has two or more ring constituent atoms other than carbon, these may be the same or different. The aromatic heterocyclic group includes, specifically, a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The group represented by Ar⁴ is preferably a benzene ring, a naphthalene ring, a pyridine ring, a pyrazine ring, a pyrimidine ring, a pyridazine ring, a quinoline ring or a thiophene ring, more preferably a benzene ring, a naphthalene ring, a pyridine ring or a thiophene ring and most preferably a benzene ring.

Ar⁴ may have a substituent, and the range thereof is the same as for the group represented by R⁴¹ and R⁴² described above.

The substituent optionally carried on Ar⁴ is preferably an alkyl group, an alkoxy group or a halogen atom, more preferably a hydrogen atom, an alkyl group or an alkoxy group, more further preferably a methyl group. It is also preferable that Ar⁴ has not substituent.

It is preferable that a linkage of Ar⁴ and an amino group is parallel to a linkage of Ar⁴ and an azo group, since linearity of a molecule is enhanced and a larger molecular length and larger aspect ratio are obtained in this condition. for example, when Ar⁴ contains a 6-membered ring linked to an azo group and amino group, it is preferable that an amino group is lined to 4-position with respect to an azo group, and when Ar⁴ contains a 5-membered ring lined to an azo group and amino group, it is preferable that an amino group is lined to 3- or 4-position with respect to an azo group.

The range of the alkyl group represented by R⁴³ and R⁴⁴ in the formula (IV′) is the same as for the alkyl group represented by R⁴¹ and R⁴² described above. The alkyl group may have a substituent, and examples of the substituent are the same as examples of the substituent represented by R⁴¹ and R⁴². When R⁴³ and R⁴⁴ represent an optionally substituted alkyl group, these may be mutually linked to form a hereto ring. If possible, these may be linked to the substituent carried on Ar⁴ to form a ring.

It is preferable that R⁴³ and R⁴⁴ are mutually linked to form a ring. A 6-membered ring or a 5-membered ring is preferable and a 6-membered ring isomer preferable. The cyclic group may have an atom other than carbon as the constituent atom, together with carbon. The constituent atom other than carbon includes a nitrogen atom, a sulfur atom and an oxygen atom. When the cyclic group has two or more ring constituent atoms other than carbon, these may be the same or different.

The cyclic group composed of R⁴³ and R⁴⁴ includes, specifically, a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepan ring, an azocan ring and the like.

The cyclic group composed of R⁴³ and R⁴⁴ is preferably a pyrrolidine ring, a piperidine ring, a piperazine ring or a morpholine ring, more preferably a piperidine ring or a piperazine ring and most preferably a piperazine ring.

The cyclic group composed of R⁴³ and R⁴⁴ may have a substituent, and the range thereof is the same as for the group represented by R⁴¹ and R⁴². It is preferable that the cyclic group has one rigid linear substituent and a linkage of the cyclic group and the substituent is parallel to a linkage of the cyclic group and Ar⁴, since linearity of a molecule is enhanced and a larger molecular length and larger aspect ratio are obtained in this condition.

Among dichroic dyes represented by the formula (IV), particularly preferable are dichroic dyes represented by the following formula (IVa).

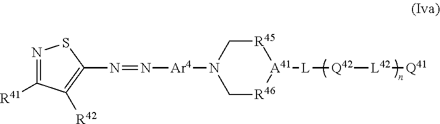

In the formula, R⁴¹ and R⁴² each represent a hydrogen atom or a substituent, and may be mutually linked to form a ring; Ar⁴ represents an optionally substituted divalent aromatic hydrocarbon group or aromatic heterocyclic group; A⁴¹ represents a carbon atom or a nitrogen atom; L⁴¹, L⁴², R⁴⁵ and R⁴⁶ represent a single bond or a divalent linking group; Q⁴¹ represents an optionally substituted cyclic hydrocarbon group or heterocyclic group; Q⁴² represents an optionally substituted divalent cyclic hydrocarbon group or heterocyclic group; n represents an integer of 0 to 3, and when n is 2 or more, a plurality of L⁴²s and a plurality of Q⁴²s may each be mutually the same or different.

The range of the group represented by R⁴¹ and R⁴² in the formula (IVa) is the same as for R⁴¹ and R⁴² in the formula (Iva), and also the preferable range thereof is the same as in the formula (IVa).

The range of the divalent aromatic hydrocarbon group or the aromatic heterocyclic group represented by Ar⁴ in the formula (IVa) is the same as for Ar⁴ in the formula (IV), and also the preferable range thereof is the same as in the formula (IV).

In the formula (IVa), A⁴¹ is preferably a nitrogen atom.

The linking group represented by L⁴¹, L⁴², R⁴⁵ and R⁴⁶ in the formula (IVa) includes alkylene groups (preferably having 1 to 20 carbons, more preferably having 1 to 10 carbons and particularly preferably having 1 to 6 carbons, and examples thereof include a methylene group, an ethylene group, a propylene group, a butylene group, a pentylene group, a cyclohexane-1,4-diyl group and the like), alkenylene groups (preferably having 2 to 20 carbons, more preferably having 2 to 10 carbons and particularly preferably having 2 to 6 carbons, and examples thereof include an ethenylene group and the like), alkynylene groups (preferably having 2 to 20 carbons, more preferably having 2 to 10 carbons and particularly preferably having 2 to 6 carbons, and examples thereof include an ethynylene group and the like), alkyleneoxy groups (preferably having 1 to 20 carbons, more preferably having 1 to 10 carbons and particularly preferably having 1 to 6 carbons, and examples thereof include a methyleneoxy group and the like), an amide group, an ether group, an acyloxy group (—C(═O)O—), an oxycarbonyl group (—OC(═O)—), an imino group (—CH═N— or —N═CH—), a sulfoamide group, a sulfonate group, a ureide group, a sulfonyl group, a sulfinyl group, a thioether group, a carbonyl group, an —NR— group (here, R represents a hydrogen atom, an alkyl group or an aryl group), an azo group, an azoxy group, or divalent linking groups having 0 to 60 carbons constituted or two or more of them in combination.

The linking group represented by L⁴¹ includes preferably a single bond, an alkylene group, an alkenylene group, an alkyleneoxy group, an oxycarbonyl group, an acyl group and a carbamoyl group, more preferably a single bond and an alkylene group and further preferably a single bond and an ethylene group.

The linking group represented by L⁴² includes preferably a single bond, an alkylene group, an alkenylene group, an oxycarbonyl group, an acyl group, an acyloxy group, a carbamoyl group, an imino group, an azo group and an azoxy group, more preferably a single bond, an oxycarbonyl group, an acyloxy group, an imino group, an azo group and an azoxy group and further preferable a single bond, an oxycarbonyl group and an acyloxy group.

The linking group represented by R⁴⁵ and R⁴⁶ includes preferably a single bond, an alkylene group, an alkenylene group, an alkyleneoxy group and an acyl group, more preferably a single bond and an alkylene group and further preferably a single bond and a methylene group.

The number of constituent atoms of the ring formed of a nitrogen atom, a methylene group, R⁴⁵, R⁴⁶, and A⁴¹ in the formula (IVa) is determined by R⁴⁵ and R⁴⁶, and for example, when R⁴⁵ and R⁴⁶ both represent a single bond, the ring can be a 4-membered ring; when one of them is a single bond and the other is a methylene group, it can be a 5-membered ring; and further, when R⁴⁵ and R⁴⁶ both represent a methylene group, it can be a 6-membered ring.

In the formula (IVa), the ring formed of a nitrogen atom, a methylene group, R⁴⁵, R⁴⁶ and A⁴¹ is preferably a 6-membered ring or a 5-membered ring and more preferably a 6-membered ring.

The group represented by Q⁴¹ in the formula (IVa) includes preferably an aromatic hydrocarbon group (preferably having 1 to 20 carbons and more preferably having 1 to 10 carbons, and examples thereof include a phenyl group, a naphthyl group and the like), an aromatic heterocyclic group and a cyclohexane ring group.

The aromatic heterocyclic group represented by Q⁴¹ is preferably a group derived from a monocyclic or bicyclic hetero ring. The atom other than carbon constituting the aromatic heterocyclic group includes a nitrogen atom, a sulfur atom and an oxygen atom. When the aromatic heterocyclic group has two or more ring constituent atoms other than carbon, these may be the same or different. The aromatic heterocyclic group includes specifically a pyridine ring, a pyrazine ring, a pyrimidine ring, a pyridazine ring, a quinoline ring, a thiophene ring, a thiazole ring, a benzothiazole ring, a thiadiazole ring, a quinolone ring, a naphthalimide ring, a thienothiazole ring and the like.

The group represented by Q⁴¹ includes preferably a benzene ring, a naphthalene ring, a pyridine ring, a pyrazine ring, a pyrimidine ring, a pyridazine ring, a thiazole ring, a benzothiazole ring, a thiadiazole ring, a quinoline ring, a thienothiazole ring and a cyclohexane ring, more preferably a benzene ring, a naphthalene ring, a pyridine ring, a thiazole ring, a benzothiazole ring, a thiadiazole ring and a cyclohexane ring and most preferably a benzene ring, a pyridine ring and a cyclohexane ring.

Q⁴¹ may have a substituent, and the range thereof is the same as the range of the group represented by R⁴¹ and R⁴² described above.

The substituent optionally carried on Q⁴¹ includes preferably an alkyl group optionally having a substituent, an alkenyl group optionally having a substituent, an alkynyl group optionally having a substituent, an aryl group optionally having a substituent, an alkoxy group optionally having a substituent, an oxycarbonyl group optionally having a substituent, an acyloxy optionally having a substituent, an acylamino group optionally having a substituent, an amino group optionally having a substituent, an alkoxycarbonylamino group optionally having a substituent, a sulfonylamino group optionally having a substituent, a sulfamoyl group optionally having a substituent, a carbamoyl group optionally having a substituent, and alkylthio group optionally having a substituent, a sulfonyl group optionally having a substituent, a ureide group optionally having a substituent, a nitro group, a hydroxy group, a cyano group, an imino group, an azo group and a halogen atom, more preferably an alkyl group optionally having a substituent, an alkenyl group optionally having a substituent, an aryl group optionally having a substituent, an alkoxy group optionally having a substituent, an oxycarbonyl group optionally having a substituent, an acyloxy group optionally having a substituent, a nitro group, an imino group and an azo group. The preferable range of the number of carbon atoms of one having carbon atoms among the above-described substituents is the same as the preferable range of the number of carbon atoms of the group represented by R⁴¹ and R⁴² described above.

It is preferable that Q⁴¹ has one substituent and a linkage of Q⁴¹ and the substituent is parallel to a linkage of Q⁴¹ and L⁴¹ or L⁴², since linearity of a molecule is enhanced and a larger molecular length and larger aspect ratio are obtained under this condition. Particularly when n=0, it is preferable that Q⁴¹ has a substituent at the above-described position.

In the formula (IVa), Q⁴² represents an optionally substituted divalent cyclic hydrocarbon group or heterocyclic group.

The divalent cyclic hydrocarbon group represented by Q⁴² may be aromatic or non-aromatic. Preferable examples of the divalent cyclic hydrocarbon group include aromatic hydrocarbon groups (preferably having 1 to 20 carbons and more preferably having 1 to 10 carbons, and examples thereof include a phenyl group, a naphthyl group and the like) and a cyclohexane ring group.

The divalent cyclic heterocyclic group represented by Q⁴² may also be aromatic or non-aromatic. The heterocyclic group is preferably a group derived from a monocyclic or bicyclic hetero ring. The atom other than carbon constituting the heterocyclic group includes a nitrogen atom, a sulfur atom and an oxygen atom. When the heterocyclic group has two or more ring constituent atoms other than carbon. these may be the same or different. the heterocyclic group includes specifically a pyridine ring, a pyrazine ring, a pyrimidine ring, a pyridazine ring, a quinoline ring, a thiophene ring, a thiazole ting, a benzothiazole ring, a thiadiazole ring, a quinolone ring, a naphthalimide ring, a thienothiazole ring, a 3-pyrroline ring, a pyrrolidine ring, a 3-imidazoline ring, an imidazolidine ring, a 4-oxazoline ring, an oxazolidine ring, a 4-thiazoline ring, a thiazolidine ring, a piperidine ring, a piperazine ring, a morpholine ring, a thiomorpholine ring, an azepan ring, an azocan ring and the like.

The group represented by Q⁴² is preferably a benzene ring, a naphthalene ring, a pyridine ring, a pyrazine ring, a pyrimidine ring, a pyridazine ring, a piperidine ring, a piperazine ring, a quinoline ring, a thiophene ring, a thiazole ring, a benzothiazole ring, a thiadiazole ring, a quinolone ring, a naphthalimide ring, a thienothiazole ring or a cyclohexane ring, more preferably a benzene ring, a naphthalene ring, a pyridine ring, a piperdine ring, a piperazine ring, a thiazole ring, a thiadiazole ring or a cyclohexane ring and more further preferably a benzene ring, a cyclohexane ring or a piperazine ring.

Q⁴² may have substituent, and the range thereof is the same as for the group represented by R^{41 and R}⁴² described above.

The range of the substituent optionally carried on Q⁴² is the same as for the substituent optionally carried on Ar⁴ described above, and also the preferable range thereof is the same as for the substituent optionally carried on Ar⁴.

It is preferable that linkages of Q⁴² and L⁴¹ and L⁴² or tow L⁴²s are parallel, since linearity of a molecule is enhances and a larger molecular length and larger aspect ration are obtained under this condition.

In the formula (IVa), n represents an integer of 0 to 3, preferably 0 to 2, more preferably 0 or 1 and most preferably 1.

Among dichroic dyes represented by the formula (IVa), dichroic dyes represented by the following formula IIVb) are particularly preferable.

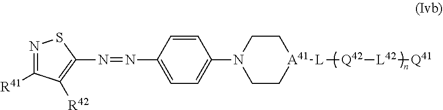

In the formula, R⁴¹ and R⁴² each represent a hydrogen atom or a substituent; A⁴¹ represents a carbon atom or a nitrogen atom; L⁴¹ and L⁴² each represent a single bond or a divalent linking group; Q⁴¹ represents an optionally substituted cyclic hydrocarbon group or optionally substituted heterocyclic group; Q⁴² represents an optionally substituted divalent cyclic hydrocarbon group or heterocyclic group; n represents an integer of 0 to 3, and when n is 2 or more, a plurality of L⁴²s and a plurality of Q⁴²s may each be mutually the same or different.

The range of the group represented by R⁴¹, R⁴², L⁴¹, L⁴², Q⁴¹ and Q⁴² in the formula (IVb) is the same as for R⁴¹, R⁴², L⁴¹, L⁴², Q⁴¹ and Q⁴² in the formula (IV), and also the preferable range thereof is the same as in the formula (IV).

In the formula (IVb), A⁴¹ is preferably a nitrogen atom.

Specific examples of the compound represented by the formula (IV) include, but are not limited to, the following specific examples.

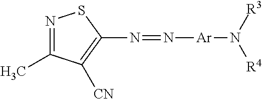

| No. | Ar | R³ | R⁴ |
|---|---|---|---|
| A4-1 | 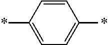 [SMILES: *c1ccc(*)cc1] | —CH₃ | —CH₂Ph |
| A4-2 | 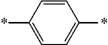 [SMILES: *c1ccc(*)cc1] | —CH₃ | —C₁₂H₂₅ |
| A4-3 | 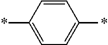 [SMILES: *c1ccc(*)cc1] | —CH₃ | —(CH₂CH₂O)₂CH₃ |
| A4-4 | 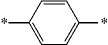 [SMILES: *c1ccc(*)cc1] | —CH₃ | —CH₂CH₂OCH₂Ph |
| A4-5 | 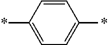 [SMILES: *c1ccc(*)cc1] | —H | —CH₂Ph |
| A4-6 | 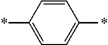 [SMILES: *c1ccc(*)cc1] | —C₂H₅ | —CH₂Ph |
| A4-7 | 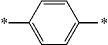 [SMILES: *c1ccc(*)cc1] | 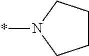 [SMILES: *N1CCCC1] | |
| A4-8 | 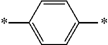 [SMILES: *c1ccc(*)cc1] | 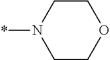 [SMILES: *N1CCOCC1] | |
| A4-9 | 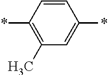 [SMILES: *c1ccc(*)c(C)c1] | —CH₃ | —CH₂Ph |
| A4-10 | 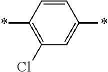 [SMILES: *c1ccc(*)c(Cl)c1] | —CH₃ | —CH₂Ph |
| A4-11 | 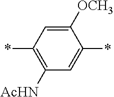 [SMILES: *c1cc(OC)c(*)cc1NC(C)=O] | —CH₃ | —CH₂Ph |
| A4-12 | 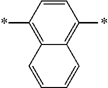 [SMILES: *c1ccc(*)c2ccccc12] | —CH₃ | —CH₂Ph |

| | | |
|---|---|---|
| A4-13 | 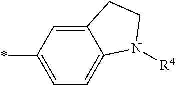 | —CH₂Ph |

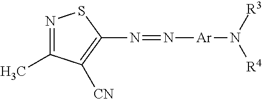

| No. | Ar | R3 | R4 |
|---|---|---|---|
| A4-14 | 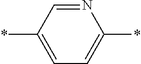 [SMILES: *c1ccc(*)nc1] | —CH₃ | —CH₂Ph |
| A4-15 | 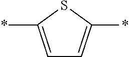 [SMILES: *c1ccc(*)s1] | —CH₃ | —CH₂CH₂OCH₂Ph |

| | | |
|---|---|---|
| A4-16 | 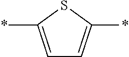 [SMILES: *c1ccc(*)s1] | 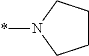 [SMILES: *N1CCCC1] |
| A4-17 | 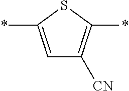 [SMILES: *c1cc(C#N)c(*)s1] | 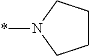 [SMILES: *N1CCCC1] |

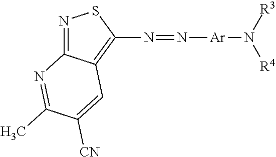

| No. | Ar | R³ | R⁴ |
|---|---|---|---|
| A4-18 | 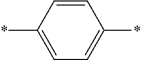 [SMILES: *c1ccc(*)cc1] | —CH₃ | —CH₂Ph |
| A4-19 | 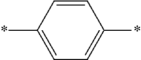 [SMILES: *c1ccc(*)cc1] | 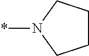 [SMILES: *N1CCCC1] | |
| A4-20 | 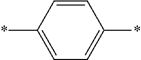 [SMILES: *c1ccc(*)cc1] | 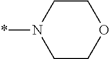 [SMILES: *N1CCOCC1] | |
| A4-21 | 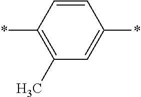 [SMILES: *c1ccc(*)c(C)c1] | —C₂H₅ | —C₂H₅ |
| A4-22 | 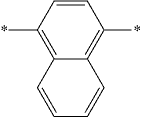 [SMILES: *c1ccc(*)c2ccccc12] | —C₂H₅ | —C₂H₅ |
| A4-23 | 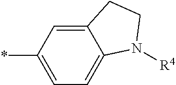 | | —CH₂Ph |
| A4-24 | 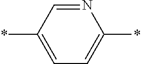 [SMILES: *c1ccc(*)nc1] | —CH₃ | —CH₂Ph |

| | | |
|---|---|---|
| A4-25 | 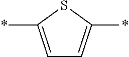 [SMILES: *c1ccc(*)s1] | 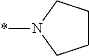 [SMILES: *N1CCCC1] |

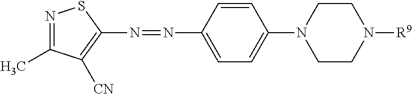

| No. | R⁹ |
|---|---|
| A4-26 | —C₅H₁₁ |
| A4-27 | —C₁₂H₂₅ |
| A4-28 | —CH₂CH(C₂H₅)C₄H₉ |
| A4-29 | —(CH₂CH₂O)₂CH₃ |
| A4-30 | —COOC₈H₁₇ |
| A4-31 | —C(═O)C₁₁H₂₃ |
| A4-32 | CONHC₈H₁₇ |

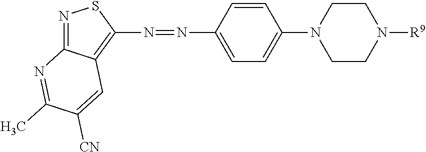

| No. | R⁹ |
|---|---|
| A4-33 | —C₅H₁₁ |
| A4-34 | —C₁₂H₂₅ |
| A4-35 | —CH₂CH(C₂H₅)C₄H₉ |
| A4-36 | —(CH₂CH₂O)₂CH₃ |
| A4-37 | —COOC₈H₁₇ |
| A4-38 | —C(═O)C₁₂H₂₅ |
| A4-39 | CONHC₈H₁₇ |

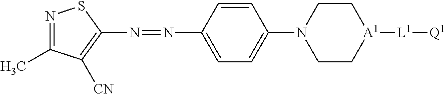

| No. | A¹ | L¹ | Q¹ |
|---|---|---|---|
| A4-40 | >CH— | — | —Ph |
| A4-41 | >N— | — | —Ph |
| A4-42 | >N— | — | 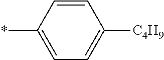 |
| A4-43 | >N— | — | 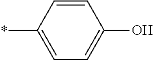 [SMILES: *c1ccc(O)cc1] |
| A4-44 | >N— | — | 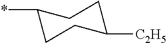 [SMILES: *C1CCC(CC)CC1] |
| A4-45 | >N— | —COO— | 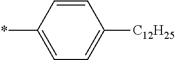 |
| A4-46 | >N— | —COOCH₂— | —Ph |
| A4-47 | >N— | —CONH— | 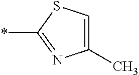 [SMILES: *c1nc(C)cs1] |
| A4-48 | >N— | —CONH— | 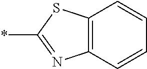 [SMILES: *c1nc2ccccc2s1] |
| A4-49 | >N— | —CO— | 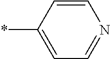 [SMILES: *c1ccncc1] |
| A4-50 | >N— | —CO— | 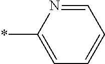 [SMILES: *c1ccccn1] |
| A4-51 | >N— | —CH₂CH₂— | —Ph |
| A4-52 | >N— | —CH₂CH₂O— | 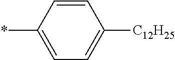 |
| A4-53 | >N— | —CH₂CH₂OCO— | 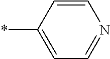 [SMILES: *c1ccncc1] |
| A4-54 | >N— | —CH₂CH₂OCO— | 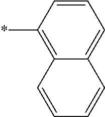 [SMILES: *c1cccc2ccccc12] |
| A4-55 | >N— | —CH₂CH₂OCO— | 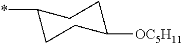 |

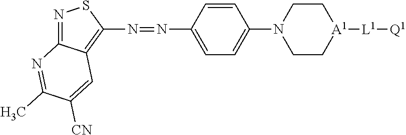

| No. | A¹ | L¹ | Q¹ |
|---|---|---|---|
| A4-56 | >CH— | — | —Ph |
| A4-57 | >N— | — | —Ph |
| A4-58 | >N— | — | 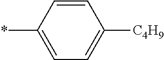 |
| A4-59 | >N— | — | 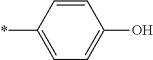 [SMILES: *c1ccc(O)cc1] |
| A4-60 | >N— | — | 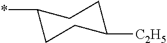 [SMILES: *C1CCC(CC)CC1] |
| A4-61 | >N— | —COO— | 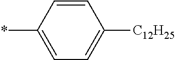 |
| A4-62 | >N— | —COOCH₂— | —Ph |
| A4-63 | >N— | —CONH— | 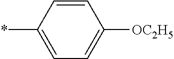 [SMILES: *c1ccc(OCC)cc1] |
| A4-64 | >N— | —CONH— | 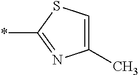 [SMILES: *c1nc(C)cs1] |
| A4-65 | >N— | —CONH— | 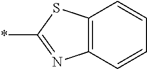 [SMILES: *c1nc2ccccc2s1] |
| A4-66 | >N— | —CO— | 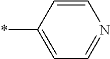 [SMILES: *c1ccncc1] |
| A4-67 | >N— | —CO— | 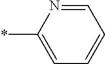 [SMILES: *c1ccccn1] |
| A4-68 | >N— | —CH₂CH₂— | —Ph |
| A4-69 | >N— | —CH₂CH₂O— | 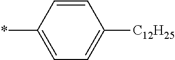 |
| A4-70 | >N— | —CH₂CH₂OCO— | 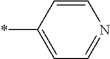 [SMILES: *c1ccncc1] |
| A4-71 | >N— | —CH₂CH₂OCO— | 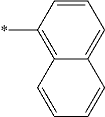 [SMILES: *c1cccc2ccccc12] |
| A4-72 | >N— | —CH₂CH₂OCO— | 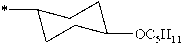 |

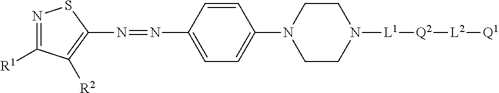

| No. | R¹ | R² | L¹ | Q² | L² | Q¹ |
|---|---|---|---|---|---|---|
| A4-73 | —CH₃ | —CN | — | 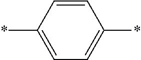 [SMILES: *c1ccc(*)cc1] | — | —Ph |
| A4-74 | —CH₃ | —CN | — | 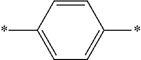 [SMILES: *c1ccc(*)cc1] | — | 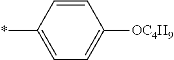 |
| A4-75 | —CH₃ | —CN | — | 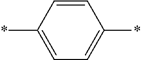 [SMILES: *c1ccc(*)cc1] | —COO— | 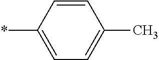 [SMILES: *c1ccc(C)cc1] |
| A4-76 | —CH₃ | —CN | — | 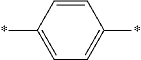 [SMILES: *c1ccc(*)cc1] | —COO— | 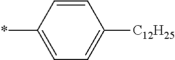 |
| A4-77 | —CH₃ | —CN | — | 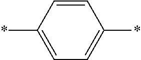 [SMILES: *c1ccc(*)cc1] | —COO— | 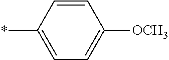 [SMILES: *c1ccc(OC)cc1] |
| A4-78 | —CH₃ | —CN | — | 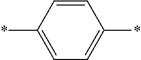 [SMILES: *c1ccc(*)cc1] | —COOCH₂— | —Ph |
| A4-79 | —CH₃ | —CN | — | 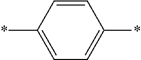 [SMILES: *c1ccc(*)cc1] | —CONH— | 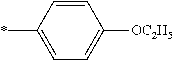 [SMILES: *c1ccc(OCC)cc1] |
| A4-80 | —CH₃ | —CN | — | 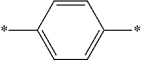 [SMILES: *c1ccc(*)cc1] | —CONH— | 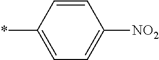 [SMILES: *c1ccc([N+](=O)[O-])cc1] |
| A4-81 | —CH₃ | —CN | — | 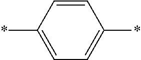 [SMILES: *c1ccc(*)cc1] | —CONH— | 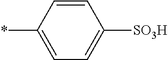 [SMILES: *c1ccc(S(=O)(=O)O)cc1] |
| A4-82 | —CH₃ | —CN | — | 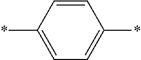 [SMILES: *c1ccc(*)cc1] | —OCO— | 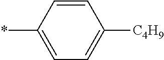 |
| A4-83 | —CH₃ | —CN | — | 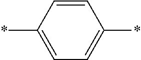 [SMILES: *c1ccc(*)cc1] | —OCO— | 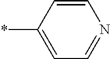 [SMILES: *c1ccncc1] |
| A4-84 | —CH₃ | —CN | — | 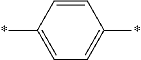 [SMILES: *c1ccc(*)cc1] | —NHCO— | 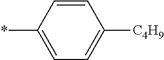 |
| A4-85 | —CH₃ | —CN | — | 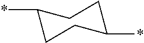 [SMILES: *C1CCC(*)CC1] | —OCO— | 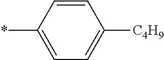 |

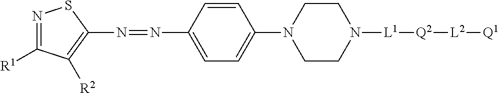

| No. | R¹ | R² | L¹ | Q² | L² | Q¹ |
|---|---|---|---|---|---|---|
| A4-86 | —CH₃ | —CN | —COO— | 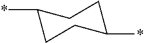 [SMILES: *C1CCC(*)CC1] | —OCO— | 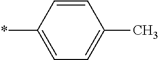 [SMILES: *c1ccc(C)cc1] |
| A4-87 | —CH₃ | —CN | —COO— | 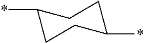 [SMILES: *C1CCC(*)CC1] | —COO— | 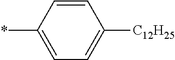 |
| A4-88 | —CH₃ | —CN | —CO— | 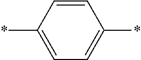 [SMILES: *c1ccc(*)cc1] | — | —Ph |
| A4-89 | —CH₃ | —CN | —CO— | 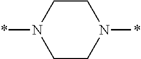 [SMILES: *N1CCN(*)CC1] | —COO— | 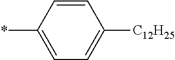 |
| A4-90 | —CH₃ | —CN | —CH₂CH₃— | 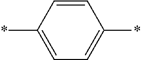 [SMILES: *c1ccc(*)cc1] | —OCO— | 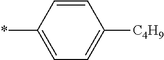 |
| A4-91 | —CH₃ | —CN | —CH₂CH₃— | 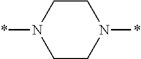 [SMILES: *N1CCN(*)CC1] | — | —Ph |
| A4-92 | —CH₃ | —CN | —CH₂CH₃— | 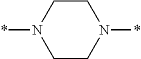 [SMILES: *N1CCN(*)CC1] | —COO— | 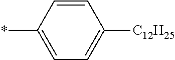 |
| A4-93 | —CH₃ | —CN | —CH₂CH₃— | 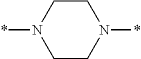 [SMILES: *N1CCN(*)CC1] | —CO— | 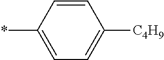 |
| A4-94 | —CH₃ | —CN | —CH₂CH₃— | 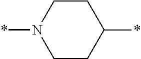 [SMILES: *C1CCN(*)CC1] | — | —Ph |
| A4-95 | —CH₃ | —CN | —CH₂CH₂O— | 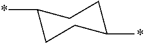 [SMILES: *C1CCC(*)CC1] | —OCO— | 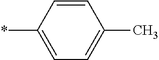 [SMILES: *c1ccc(C)cc1] |
| A4-96 | —CH₃ | —CN | —CH₂CH₂OCO— | 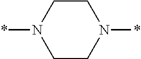 [SMILES: *N1CCN(*)CC1] | —COO— | 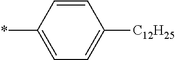 |
| A4-97 | —CH₃ | —H | —CH₂CH₂OCO— | 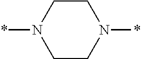 [SMILES: *N1CCN(*)CC1] | — | —Ph |
| A4-98 | —H | —H | —CH₂CH₂OCO— | 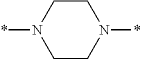 [SMILES: *N1CCN(*)CC1] | — | —Ph |
| A4-99 | —H | —Cl | —CH₂CH₂OCO— | 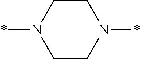 [SMILES: *N1CCN(*)CC1] | — | —Ph |
| A4-100 | —H | —SO₃H | —CH₂CH₂OCO— | 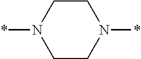 [SMILES: *N1CCN(*)CC1] | — | —Ph |
| A4-101 | —H | —NO₂ | —CH₂CH₂OCO— | 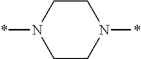 [SMILES: *N1CCN(*)CC1] | — | —Ph |

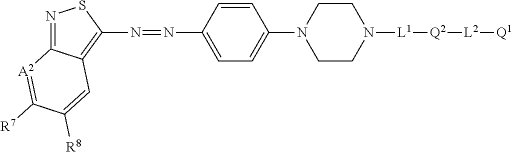

| No. | A² | R⁷ | R⁸ | L¹ | Q² | L² | Q¹ |
|---|---|---|---|---|---|---|---|
| A4-102 | —N═ | —CH₃ | —CN | — | 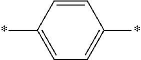 [SMILES: *c1ccc(*)cc1] | — | —Ph |
| A4-103 | —N═ | —CH₃ | —CN | — | 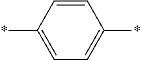 [SMILES: *c1ccc(*)cc1] | — | 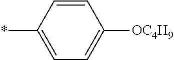 |
| A4-104 | —N═ | —CH₃ | —CN | — | 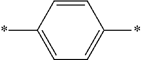 [SMILES: *c1ccc(*)cc1] | —COO— | 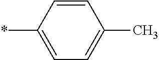 [SMILES: *c1ccc(C)cc1] |
| A4-105 | —N═ | —CH₃ | —CN | — | 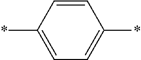 [SMILES: *c1ccc(*)cc1] | —COO— | 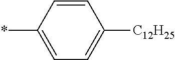 |
| A4-106 | —N═ | —CH₃ | —CN | — | 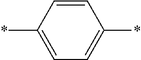 [SMILES: *c1ccc(*)cc1] | —COO— | 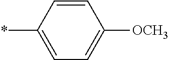 [SMILES: *c1ccc(OC)cc1] |
| A4-107 | —N═ | —CH₃ | —CN | — | 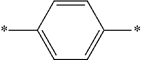 [SMILES: *c1ccc(*)cc1] | —COOCH₂— | —Ph |
| A4-108 | —N═ | —CH₃ | —CN | — | 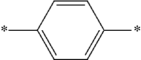 [SMILES: *c1ccc(*)cc1] | —CONH— | 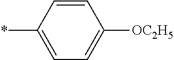 [SMILES: *c1ccc(OCC)cc1] |
| A4-109 | —N═ | —CH₃ | —CN | — | 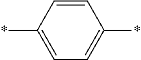 [SMILES: *c1ccc(*)cc1] | —CONH— | 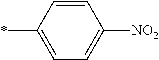 [SMILES: *c1ccc([N+](=O)[O-])cc1] |
| A4-110 | —N═ | —CH₃ | —CN | — | 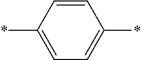 [SMILES: *c1ccc(*)cc1] | —CONH— | 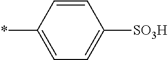 [SMILES: *c1ccc(S(=O)(=O)O)cc1] |
| A4-111 | —N═ | —CH₃ | —CN | — | 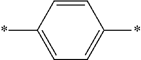 [SMILES: *c1ccc(*)cc1] | —OCO— | 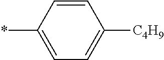 |
| A4-112 | —N═ | —CH₃ | —CN | — | 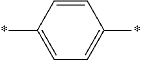 [SMILES: *c1ccc(*)cc1] | —OCO— | 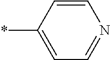 [SMILES: *c1ccncc1] |
| A4-113 | —N═ | —CH₃ | —CN | — | 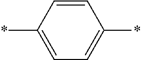 [SMILES: *c1ccc(*)cc1] | —NHCO— | 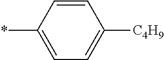 |
| A4-114 | —N═ | —CH₃ | —CN | — | 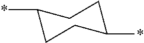 [SMILES: *C1CCC(*)CC1] | —OCO— | 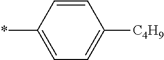 |
| A4-115 | —N═ | —CH₃ | —CN | —COO— | 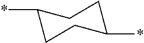 [SMILES: *C1CCC(*)CC1] | —OCO— | 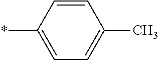 [SMILES: *c1ccc(C)cc1] |
| A4-116 | —N═ | —CH₃ | —CN | —COO— | 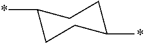 [SMILES: *C1CCC(*)CC1] | —COO— | 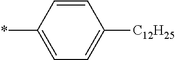 |
| A4-117 | —N═ | —CH₃ | —CN | —CO— | 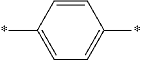 [SMILES: *c1ccc(*)cc1] | —COO— | —Ph |
| A4-118 | —N═ | —CH₃ | —CN | —CO— | 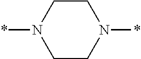 [SMILES: *N1CCN(*)CC1] | —COO— | 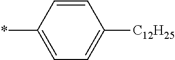 |
| A4-119 | —N═ | —CH₃ | —CN | —CH₂CH₂— | 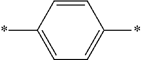 [SMILES: *c1ccc(*)cc1] | —OCO— | 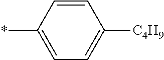 |
| A4-120 | —N═ | —CH₃ | —CN | —CH₂CH₂— | 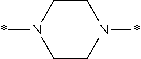 [SMILES: *N1CCN(*)CC1] | —OCO— | —Ph |

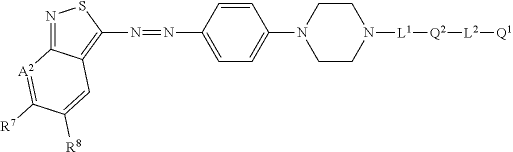

| No. | A² | R⁷ | R⁸ | L¹ | Q² | L² | Q¹ |
|---|---|---|---|---|---|---|---|
| A4-121 | —N═ | —CH₃ | —CN | —CH₂CH₂— | 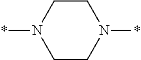 [SMILES: *N1CCN(*)CC1] | —COO— | 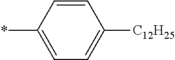 |
| A4-122 | —N═ | —CH₃ | —CN | —CH₂CH₂— | 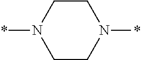 [SMILES: *N1CCN(*)CC1] | —CO— | 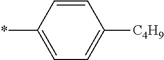 |
| A4-123 | —N═ | —CH₃ | —CN | —CH₂CH₂— | 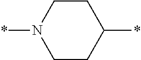 [SMILES: *C1CCN(*)CC1] | — | —Ph |
| A4-124 | —N═ | —CH₃ | —CN | —CH₂CH₂O— | 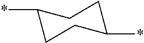 [SMILES: *C1CCC(*)CC1] | —OCO— | 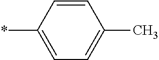 [SMILES: *c1ccc(C)cc1] |
| A4-125 | —N═ | —CH₃ | —CN | —CH₂CH₂OCO— | 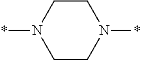 [SMILES: *N1CCN(*)CC1] | —COO— | 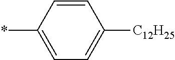 |
| A4-126 | —N═ | —CH₃ | —H | —CH₂CH₂— | 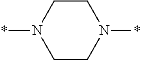 [SMILES: *N1CCN(*)CC1] | — | —Ph |
| A4-127 | —N═ | —H | —H | —CH₂CH₂— | 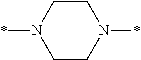 [SMILES: *N1CCN(*)CC1] | — | —Ph |
| A4-128 | —N═ | —H | —Cl | —CH₂CH₂— | 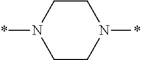 [SMILES: *N1CCN(*)CC1] | — | —Ph |
| A4-129 | —N═ | —H | —SO₃H | —CH₂CH₂— | 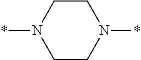 [SMILES: *N1CCN(*)CC1] | — | —Ph |
| A4-130 | —N═ | —H | —NO₂ | —CH₂CH₂— | 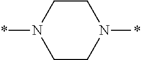 [SMILES: *N1CCN(*)CC1] | — | —Ph |
| A4-131 | —CH═ | —CH₃ | —CN | —CH₂CH₂— | 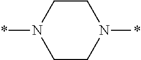 [SMILES: *N1CCN(*)CC1] | — | —Ph |
| A4-132 | —CH═ | —CH₃ | —H | —CH₂CH₂— | 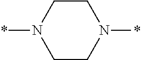 [SMILES: *N1CCN(*)CC1] | — | —Ph |
| A4-133 | —CH═ | —H | —H | —CH₂CH₂— | 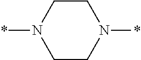 [SMILES: *N1CCN(*)CC1] | — | —Ph |
| A4-134 | —CH═ | —H | —Cl | —CH₂CH₂— | 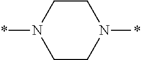 [SMILES: *N1CCN(*)CC1] | — | —Ph |
| A4-135 | —CH═ | —H | —SO₃H | —CH₂CH₂— | 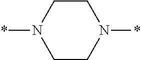 [SMILES: *N1CCN(*)CC1] | — | —Ph |
| A4-136 | —CH═ | —H | —NO₂ | —CH₂CH₂— | 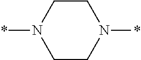 [SMILES: *N1CCN(*)CC1] | — | —Ph |

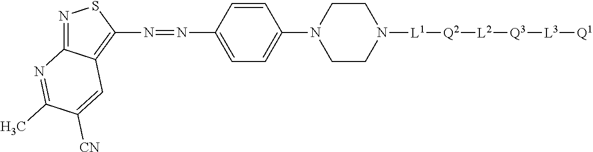

| No. | L¹ | Q² | L² | Q³ | L³ | Q¹ |
|---|---|---|---|---|---|---|
| A4-137 | — | 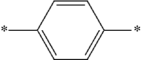 [SMILES: *c1ccc(*)cc1] | — | 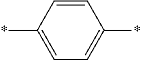 [SMILES: *c1ccc(*)cc1] | —COO— | 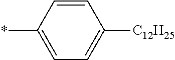 |
| A4-138 | — | 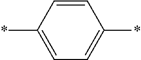 [SMILES: *c1ccc(*)cc1] | —COO— | 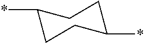 [SMILES: *C1CCC(*)CC1] | —OCO— | 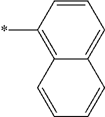 [SMILES: *c1cccc2ccccc12] |
| A4-139 | — | 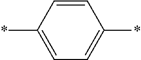 [SMILES: *c1ccc(*)cc1] | —OCO— | 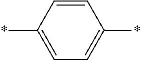 [SMILES: *c1ccc(*)cc1] | —CONH | 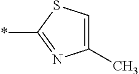 [SMILES: *c1nc(C)cs1] |
| A4-140 | —CH₂CH₂— | 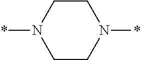 [SMILES: *N1CCN(*)CC1] | —COO— | 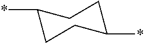 [SMILES: *C1CCC(*)CC1] | —OCO— | 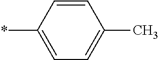 [SMILES: *c1ccc(C)cc1] |
| A4-141 | —CH₂CH₂— | 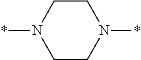 [SMILES: *N1CCN(*)CC1] | — | 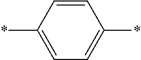 [SMILES: *c1ccc(*)cc1] | —N═N— | 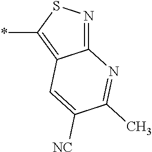 [SMILES: *c1snc2nc(C)c(C#N)cc12] |
| A4-142 | —COO— | 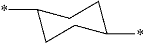 [SMILES: *C1CCC(*)CC1] | —OCO— | 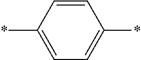 [SMILES: *c1ccc(*)cc1] | — | —Ph |

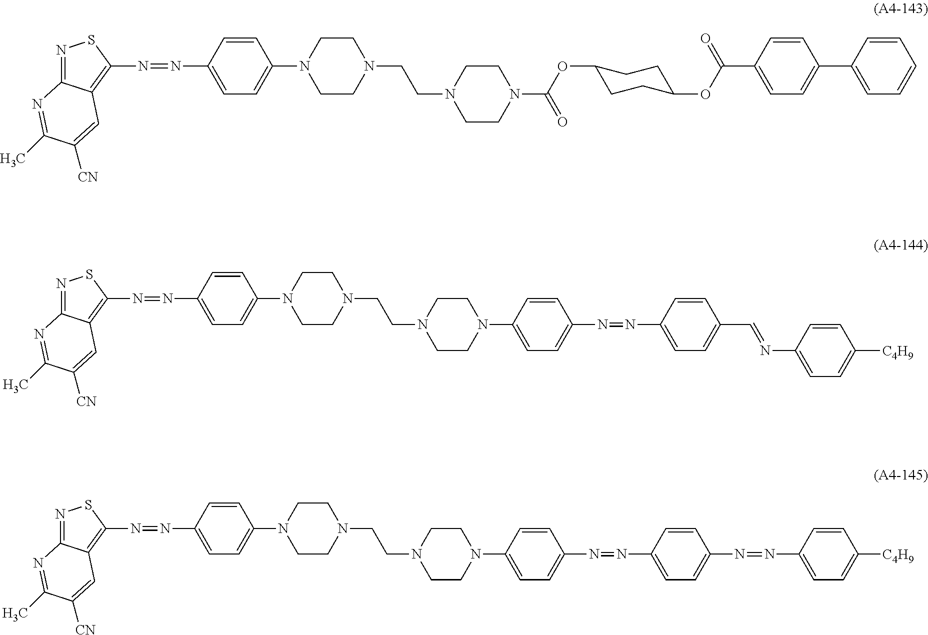

Compounds (azo dyes) described by the above-described formula (I), (II), (III), or (IV) can be synthesized by reference to methods described in “Dichroic Dyes for Liquid Crystal Display” (A. V. Ivashchenko ed., CRC 1004), “Review on Synthetic Dyes (Sosetsu Gosei Senryo)” (Hiroshi Horiguchi ed., Sankyo Publishing, 1968) and literature cited in them.

Azo dyes represented by the above-described formula (I), (II), (III) or (IV) in the present invention can be synthesized easily according to methods described in the journal of Materials Chemistry (1999) 9(11), 2755-2763 and the like.

The azo dye represented by the above-described formula (I), (II), (III) or (IV) in the present invention can be synthesized easily realizing by itself liquid crystallinity, particularly nematic liquid crystallinity since the molecular shape is flat and has good linearity, has a rigid core part and a flexible side chain part, and a polar amino group is present at the molecular long axis end of the azo dye, as apparent from its molecular structure.

As described above, the dichroic dye composition containing at least one kid of dichroic dye represented by the above-described (I), (II), (III) or (IV) has liquid crystallinity, in the present invention.

Further, the azo dye represented by the above-described formula (I), (II), (III) or (IV) also has a nature of easily forming an associated state of molecules by the action of strong intermolecular interaction because of high flatness of the molecule.

The dichroic dye composition containing the azo dye represented by Formula (I), (II), (III), or (IV) according to the present invention not only exhibits high absorbance in a wide visible wavelength region due to the formation of the association, but also has liquid crystallinity, specifically, nematic liquid crystallinity. Accordingly, for example, a high degree or molecular alignment can be achieved through a lamination process such as coating over the surface of a polyvinyl alcohol alignment film treated by rubbing. Therefore, a stereo image print produced by forming the dichroic dye layer from the dichroic dye composition containing the azo dye represented by formula (I), (II), (III), or (IV) according to the present invention exhibits high polarization characteristics and can provide a clear stereoscopic image without crosstalk or ghost images.

The dichroic dye composition can increase the dichroic dye ratio (D) calculated by the method described in the example described below to 15 or more, preferably to 18 or more.

The azo dye represented by Formula (I), (II), (III), or (IV) has liquid crystallinity to exhibit a nematic liquid crystal phase preferably at 10° C. to 300° C. and more, preferably at 100° C. to 250° C.

The dichroic dye composition in the present invention preferably contains one or more azo dyes represented by Formula (I), (II), (III), or (IV). Though the composition may contain any combination of the azo dyes without particular limitation, two or more azo dyes may be mixed in order to allow the resulting stereo image print to achieve high degrees of polarization and hue.

The azo dye represented by Formula (Ia) is a magenta azo dye, the azo dyes represented by Formulae (Ib) and (II) are yellow or magenta azo dyes, and the azo dyes represented by Formulae (III) and (IV) are cyan azo dyes.

Furthermore, the dichroic dye may be any dye other than the azo dyes represented by Formula (I), (II), (III), or (IV), The dye other than the azo dyes represented by Formula (I), (II), (III), or (IV) is also preferably selected from compounds exhibiting liquid crystallinity. Examples of such a dye include cyanine dyes, azo metal complexes, phthalocyanine dyes, pyrylium dyes, thiopyrylium dyes, azolenium dyes, squarylium dyes, quinone dyes, triphenylmethane dyes, and triallylmethane dyes, Among them, squarylium dyes are preferable. In particular, those described in “Dichroic Dyes for Liquid Crystal Display” (A. V. Ivashchenko, published by CRC, 1994) can also be used.

In particular, the squarylium dyes that can be used in the present invention are preferably represented by Formula (VI):

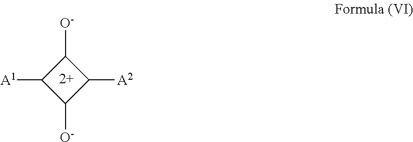

In Formula (VI), A¹ and A² each independently represent a substituted or unsubstituted hydrocarbon ring or heterocyclic group.

The hydrocarbon ring group is preferably a 5 to 20-membered monocyclic or condensed ring group. The hydrocarbon ring group may be an aromatic ring or a non-aromatic ring. Carbon atoms constituting the hydrocarbon ring may be replaced with atoms other than hydrogen atoms. For example, one or more carbon atoms constituting the hydrocarbon ring may be C═O, C═S, or C═NR (R represents a hydrogen atom or a C₁₋₁₀ alkyl group). Furthermore, one or more carbon atoms constituting the hydrocarbon ring may have substituents, and specific examples of the substitutents can be selected from the Substituent Group G described below. Examples of the hydrocarbon ring group include, but not limited to, the following groups.

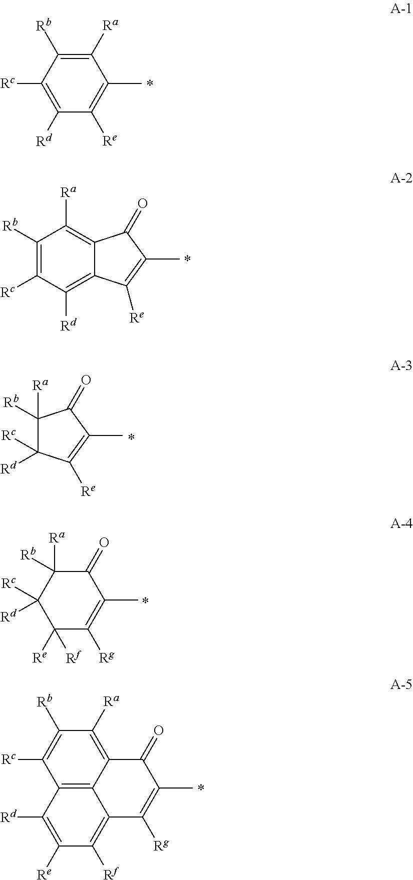

In the above-described formula, * represents a site linking to a squarylium skeleton, and R^{a} to R^{g} each represent a hydrogen atom or a substituent, and if possible, these may be mutually linked to from a cyclic structure. The substituent can be selected from the substituent Group G described later.

Particularly, the following examples are preferable.

Groups represented by the formula A-1 in which R^{c} represents —N(R^{c1}) (R^{c2}), R^{c1} and R^{c2} each represent a hydrogen atom or a substituted or un-substituted alkyl group having 1 to 10 carbons and R^{b} and R^{d} represent a hydrogen atom, that is, groups represented by the following formula A-1a.

Groups represented by the formula A-2 in which R^{e} represents a hydroxy group, that is, groups represented by the following formula A-2a.

Groups represented by the formula A-3 in which R^{e} represents a hydroxy group, that is, groups represented by the following formula A-2a.

Groups represented by the formula A-4 in which R^{g} represents a hydroxy group and R^{a}, R^{b}, R^{e} and R^{f} represent a hydrogen atom, that is groups represented by the following formula A-4a.

Groups represented by the formula A-5 in which R^{g} represents a hydroxy group, that is, groups represented by the following formula A-5a.

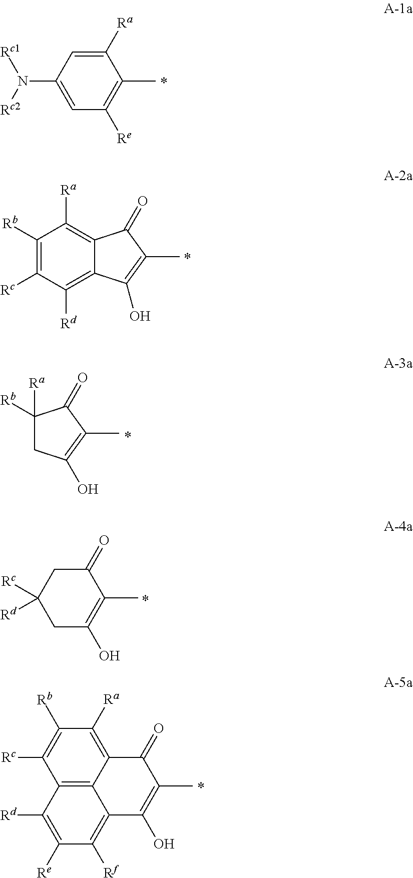

In the above-described formula A-1a, R^{c1} and R^{c2} each represent independently a hydrogen atom or a substituted or un-substituted alkyl group having 1 to 10 carbons; other symbols in the above-described formula have the same meaning as those in the above-described formulae A-1 to A-5, respectively. Examples of the substituent on the alkyl group include substituents in the substituent Group G described later, and also the preferable range thereof is the same as for the substituent Group G. When R^{c1} and R^{c2} represent a substituted or un-substituted alkyl group, these may be mutually linked to form a nitrogen-containing heterocyclic group. At least one of R^{c1} and R^{c2} may be lined to a carbon atom of a benzene ring in the formula A-1a to form a condensed ring. For example, the following formulae A-1b and A-1c may be used.

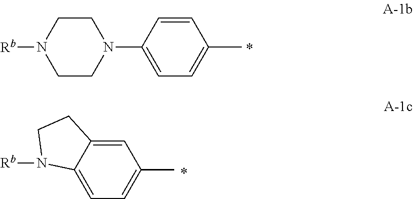

In the formula, * represents a site linking to a squarylium skeleton, and R^{h} represents a hydrogen atom or a substituent. Examples of the substituent include substituents in the substituent Group G described later R^{h} is preferably a substituent containing at least one benzene ring.

The heterocyclic group is preferably a 5 to 20-membered monocyclic or condensed ring group. The heterocyclic group has at least one of a nitrogen atom, a sulfur atom and an oxygen atom as a ring constituent atom. At least one carbon atom may be contained as a ring constituent atom, and a hetero atom or a carbon atom constituting a hetero ring may be substituted with an atom other than a hydrogen atom. For example, at least one sulfur atom constituting a hetero ring may be a sulfur atom of S═O or S(O)₂, and at least one carbon atom constituting a hetero ring may be a carbon atom of C═O, C═S or C═NR (R represents a hydrogen atom or a C₁₋₁₀ alkyl group). The heterocyclic group may be an aromatic ring or a non-aromatic ring. At least one hetero atom and/or carbon atom constituting a heterocyclic group may have a substituent, and specific examples of the substituent can be selected from the substituent group G described later. Examples of the above-described heterocyclic group include, but are not limited to, the following groups.

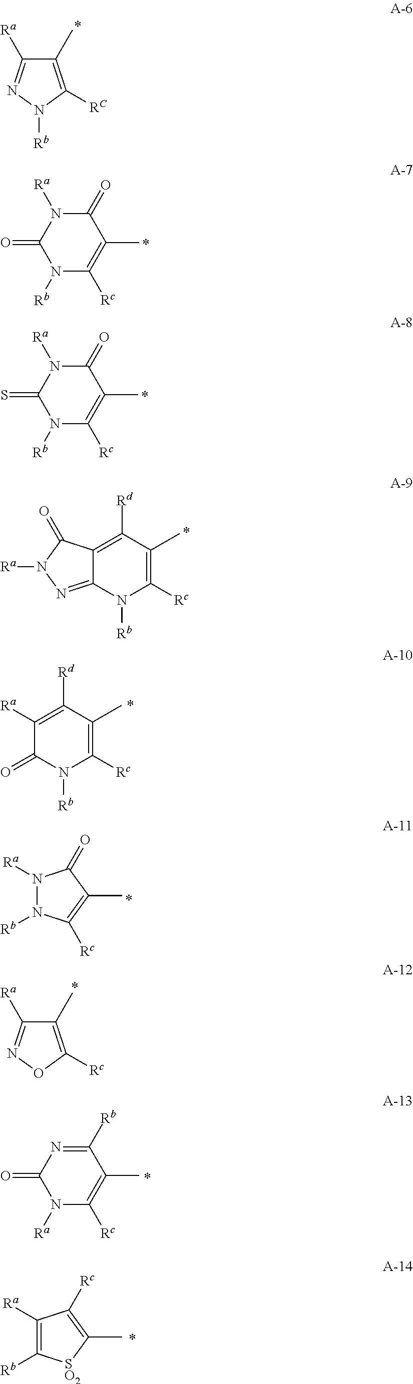

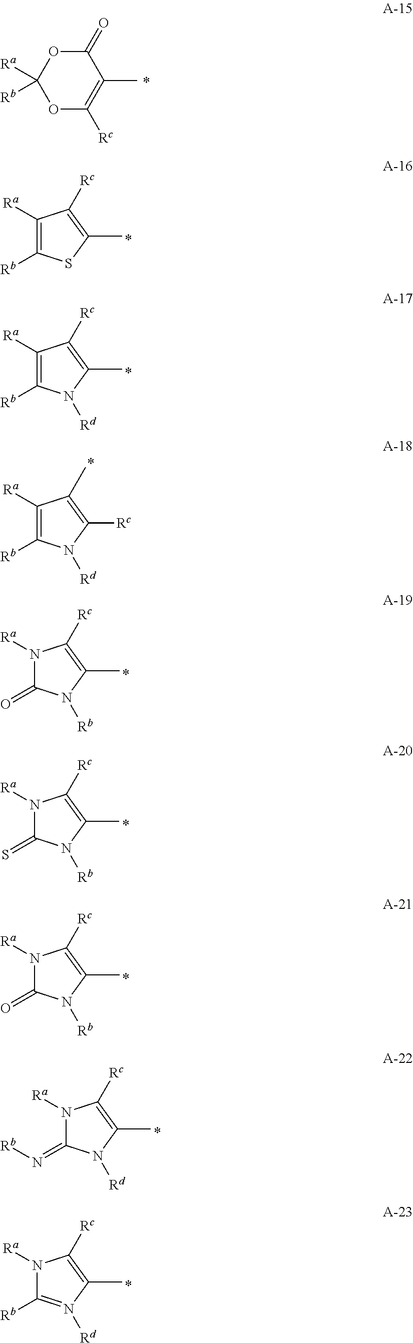

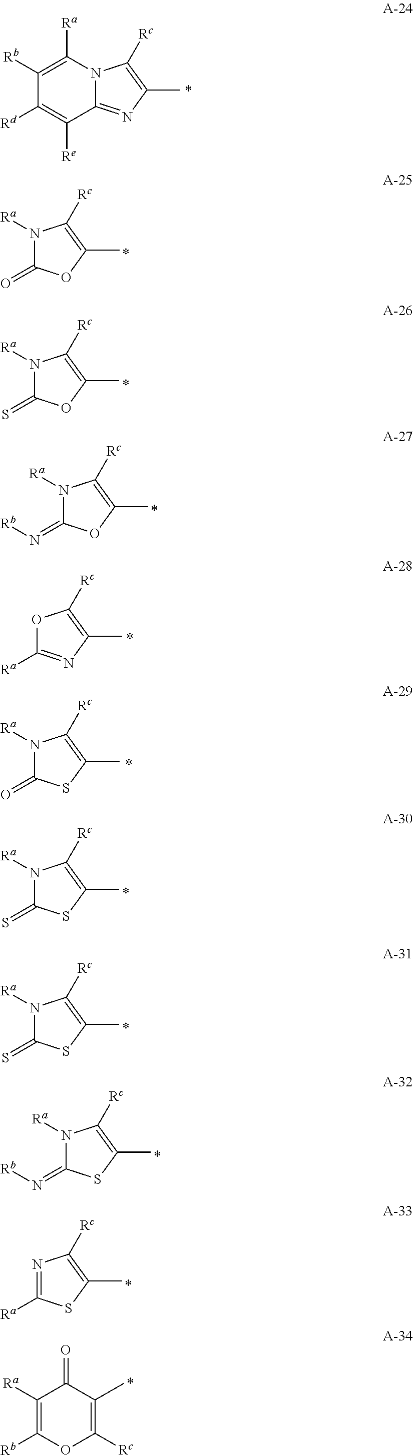

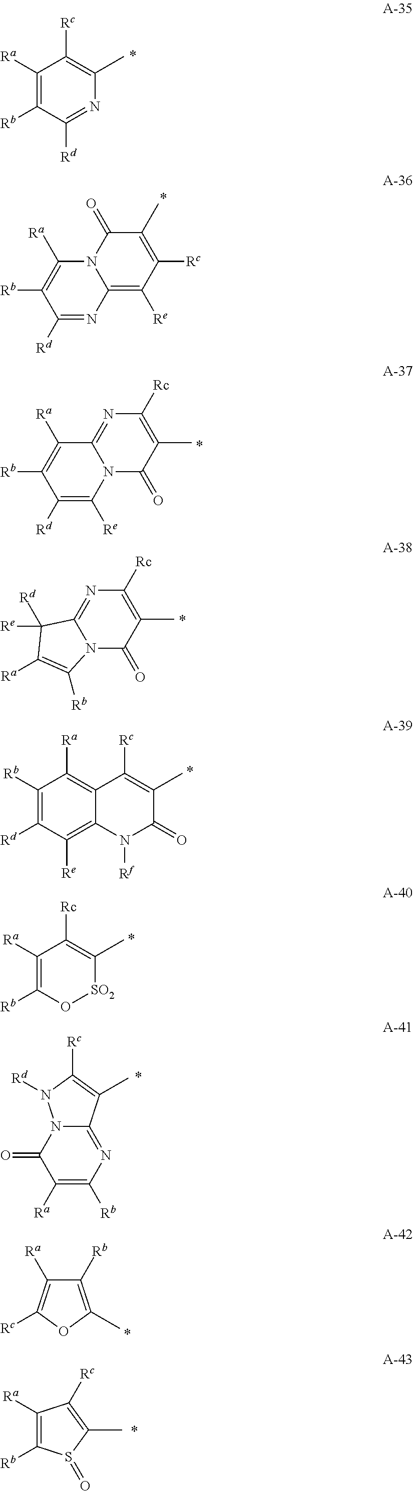

In the above-described formula, * represents a site linking to a squarylium skeleton, R^{a} to R^{f} each represent a hydrogen atom or a substituent, and if possible, these may be mutually linked to form a cyclic structure. The substituent can be selected from the substituent Group G described later.

In the formulae A-6 to A-43, Rc represents preferably a hydroxy group (OH) or a hydrothioxy group (SH).

Hydrocarbon ring groups represented by A-1, A-2 and A-4 are preferable. A-1a, A-2a and A-4a are more preferable. Hydrocarbon ring groups represented by A-1 and A-2 are particularly preferable, and A-1a and A-2a are more preferable. Hydrocarbon ring groups represented by A-1a are further preferable, and among them, hydrocarbon ring groups represented by A-1a in which R^{a} and R^{e} represent a hydrogen atom or a hydroxyl group are preferable.

Heterocyclic groups represented by A-6, A-7, A-8, A-9, A-10, A-11, A-14, A-24, A-34, A-37 and A-39 are preferable. Heterocyclic groups represented by A-6, A-7, A-8, A-9, A-11, A-14, A-35 and A-39 are particularly preferable. In these formulae, Rc represents more preferably a hydroxy group (OH) or a hydrothioxy group (SH).

It is particularly preferable that at least one of A¹ and A² in the above-described formula (VI) is A-1 (more preferably A-1a).

The above-described hydrocarbon ring group and the heterocyclic group may have at least one substituent, and examples of the substituent include substituents in the substituent Group G as described below.

Substituent Group G:

substituted or un-substituted linear chain, branched chain or cyclic alkyl groups having 1 to 18 carbons (preferably having 1 to 8 carbons) (for example, methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, trifluoromethyl and the like); substituted or un-substituted aralkyl groups having 7 to 18 carbons (preferably having 7 to 12 carbons) (for example, benzyl, carbonybenzyl and the like); substituted or un-substituted alkenyl groups having 2 to 18 carbons (preferably having 2 to 8 carbons) (for example, vinyl and the like); substituted or un-substituted alkynyl groups having 2 to 18 carbons (preferably having 2 to 8 carbons) (for example, ethynyl and the like); substituted or un-substituted aryl groups having 6 to 18 carbons (preferably having 6 to 10 carbons) (for example, phenyl, 4-methylphenyl, 4-methoxyphenyl, 4-carboxyphenyl, 3,5-dicarboxyphenyl and the like);

substituted or un-substituted acyl groups having 2 to 18 carbons (preferably having 2 to 8 carbons) (for example, acetyl, propionyl, butanoyl, chloroacetyl and the like); substituted or un-substituted alkyl or arylsulfonyl groups having 1 to 18 carbons (preferably having 1 to 8 carbons) (for example, methanesulfonyl, p-toluenesulfonyl and the like); alkylsulfinyl groups having 1 to 18 carbons (preferably having 1 to 8 carbons) (for example, methanesulfinyl, ethanesulfinyl, octanesulfinyl and the like); alkoxycarbonyl groups having 2 to 18 carbons (preferably having 2 to 8 carbons) (for example, methoxycarbonyl, ethoxycarbonyl and the like); aryloxycarbonyl groups having 7 to 18 carbons (preferably having 7 to 12 carbons) (for example, phenoxycarbonyl, 4-methylphenoxycarbonyl, 4-methoxyphenylcarbonyl and the like); substituted or un-substituted alkoxyl groups having 1 to 18 carbons (preferably having 1 to 8 carbons) (for example, methoxy, ethoxy, n-butoxy, methoxyethoxy and the like); substituted or un-substituted aryloxy groups having 6 to 18 carbons (preferably having 6 to 10 carbons) (for example, phenoxy, 4-metholxphenoxy and the like); alkylthio groups having 1 to 18 carbons (preferably having 1 to 8 carbons) (for example, methylthio, ethylthio and the like); arylthio groups having 6 to 10 carbons (for example, phenylthio and the like);

substituted or un-substituted acyloxy groups having 2 to 18 carbons (preferably having 2 to 8 carbons) (for example, acetoxy, ethylcarbonyloxy, cyclohexylcarbonyloxy, benzoyloxy, chloroacetyloxy and the like); substituted or un-substituted sulfonyloxy groups having 1 to 18 carbons (preferably having 1 to 8 carbons) (for example, methanesulfonyloxy and the like); substituted or un-substituted carbamoyloxy groups having 2 to 18 carbons (preferably having 2 to 8 carbons) (for example, methylcarbamoyloxy, diethyloarbamoyloxy and the like); an un-substituted amino group or substituted amino groups having 1 to 18 carbons (preferably having 1 to 8 carbons) (for example, methylamino, dimethylamino, diethylamino, anilino, methoxyphenylamino, chlorophenylamino, morpholino, piperidino, pyrrolidino, pyridylamino, methoxycarbonylamino, n-butoxycarbonylamino, phenoxycarbonylamino, methylcarbamolyamino, phenylcarbamoylamino, ethylthiocarbamoylamino, methylsulfamoylamino, phenylsulfamoylamino, acetylamino, ethylcarbonylamino, ethlthiocarbonylamino, cyclohexylcarbonylamino, benzoylamino, chloroacetylamino, methanesulfonylamino, benzenesulfonylamino and the like);

substituted or un-substituted carbamoyl groups having 1 to 18 carbons (preferably having 1 to 8 carbons) (for example, un-substituted carbamoyl, methylcarbamoyl, ethylcarbamoyl, n-butylcarbamoyl, t-butylcarbamoyl, dimethylcarbamoyl, morpholinocarbamoyl, pyrrolidinocarbamoyl and the like); an un-substituted sulfamoyl group, substituted sulfamoyl groups having 1 to 18 carbons (preferably having 1 to 8 carbons) (for example, methylsulfamoyl, phenylsulfamoyl and the like); halogen atoms (for example, fluorine, chlorine, bromine and the like); a hydroxyl group; a nitro group; a cyano group; a carboxyl group; hetero ring groups (for example, oxazole, benzoxazole, thiazole, benzothiazole, imidazole, benzoimidazole, indolenine, pyridine, sulfolane, furan, thiophene, pyrazole, pyrrole, chromane, coumarin and the like).

Examples of the dichroic squarylium dye represented by the formula (VI) include, but are not limited to, the following exemplary compounds.

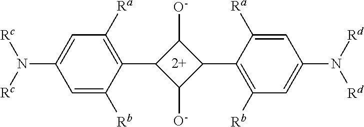

| No. | R^{a} | R^{b} | R^{c} | R^{d} |
|---|---|---|---|---|
| VI-1 | H | H | CH₃ | CH₃ |
| VI-2 | H | H | C₂H₅ | C₂H₅ |
| VI-3 | H | H | CH₃ | C₂H₅ |
| VI-4 | OH | H | CH₃ | CH₃ |
| VI-5 | OH | H | C₂H₅ | C₂H₅ |
| VI-6 | OH | H | CH₃ | C₂H5 |
| VI-7 | OH | OH | CH₃ | CH₃ |
| VI-8 | OH | OH | C₂H₅ | C₂H₅ |
| VI-9 | OH | OH | CH₃ | C₂H₅ |
| VI-10 | OH | CH3 | CH₃ | CH₃ |

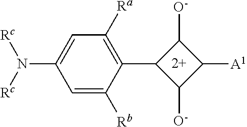

| No. | R^{a} | R^{b} | R^{c} | A |
|---|---|---|---|---|
| VI-11 | H | H | CH₃ | 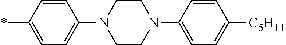 |
| VI-12 | H | H | C₂H₅ | 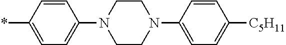 |
| VI-13 | OH | H | C₂H₅ | 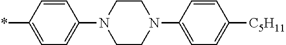 |
| VI-14 | OH | H | C₂H₅ | 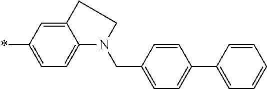 [SMILES: *c1ccc2c(c1)CCN2Cc1ccc(-c2ccccc2)cc1] |
| VI-15 | OH | H | C₂H₅ | 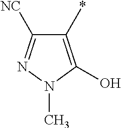 [SMILES: *c1c(C#N)nn(C)c1O] |
| VI-16 | OH | H | C₂H₅ | 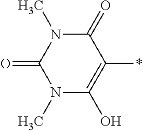 [SMILES: *c1c(O)n(C)c(=O)n(C)c1=O] |
| VI-17 | OH | H | C₂H₅ | 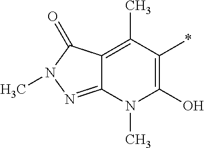 [SMILES: *c1c(C)c2c(=O)n(C)nc-2n(C)c1O] |
| VI-18 | OH | H | C₂H₅ | 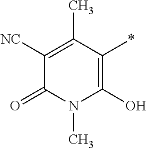 [SMILES: *c1c(C)c(C#N)c(=O)n(C)c1O] |
| VI-19 | OH | H | C₂H₅ | 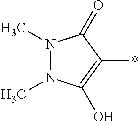 [SMILES: *c1c(O)n(C)n(C)c1=O] |
| VI-20 | OH | H | C₂H₅ | 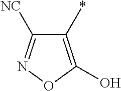 [SMILES: *c1c(C#N)noc1O] |
| VI-21 | OH | H | C₂H₅ | 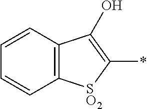 [SMILES: *C1=C(O)c2ccccc2S1(=O)=O] |
| VI-22 | OH | H | C₂H₅ | 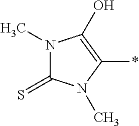 [SMILES: *c1c(O)n(C)c(=S)n1C] |
| VI-23 | OH | H | C₂H₅ | 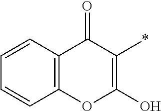 [SMILES: *c1c(O)oc2ccccc2c1=O] |
| VI-24 | OH | H | C₂H₅ | 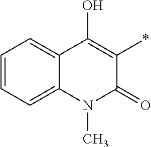 [SMILES: *c1c(O)c2ccccc2n(C)c1=O] |
| VI-25 | H | H | C₂H₅ | 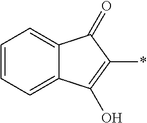 [SMILES: *C1=C(O)c2ccccc2C1=O] |
| VI-26 | H | H | C₂H₅ | 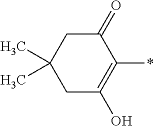 [SMILES: *C1=C(O)CC(C)(C)CC1=O] |

The dichroic squarylium dye represented by the above-described formula (VI) in the present invention can be easily synthesized according to methods described in the Journal en Chemical Society, Perkin Trans. 1 (2000), 599-603, Synthesis (2002), No. 3, 413-417 and the like.

In the dichroic dye to be used in the present invention, the angle made by the transition moment and the molecular long axis is preferably 0° or more and 20° or less, more preferably 0° or more and 15° or less, further preferably 0° or more and 10° or less, particularly preferably 0° or more and 5° or less. Here, the molecular long axis means an axis linking two atoms at which the interatomic distance is maximum in a compound. The direction of the transition moment, can be determined by molecular orbital calculation, and the angle made by the molecular long axis can also be calculated therefrom.

The dichroic dye that is used in the present invention preferably has a rigid linear structure. Specifically, the molecular length is preferably 17 Å or more, more preferably 20 Å or more, and most preferably 25 Å or more. The aspect ratio is preferably 1.7 or more, more preferably 2 or more, and most preferably 2.5 or more. In such a case, satisfactory uniaxial alignment is achieved to provide a dichroic dye layer and a stereo image print exhibiting high polarization performance.

Here, the molecular length is the sum of the van der Waals radii of two atoms on both ends of a compound and the maximum interatomic distance in the compound. The aspect ratio is a value of the molecular length to the molecular width. The molecular width is the sum of the van der Weals radii of two atoms on both ends of a compound and the maximum atomic distance where each atom of the compound is projected onto a plane perpendicular to the molecular major axis.

The dichroic dye composition contains at least one dye represented by Formula (I), (II), (III), (IV), or (VI) as the main component. Specifically, the content of the dye represented by Formula (I), (II), (III), (IV), or (VI) is preferably 80% by mass or more and most preferable 90% by mass or more relative to the total dye content. The upper limit is 100% by mass, i.e., all the dyes contained in the composition may be dyes represented by Formula (I), (II), (III), (IV), or (VI).

The content of the at least one kind of dichroic dye represented by Formula (I), (II), (III), (IV), or (VI) is preferably 20% by mass or more and most preferably 30% by mass or more relative to the total solid content excluding the solvent contained in the dichroic dye composition. Though the upper limit is not particularly defined, the content of the at least one kind of dichroic dye represented by Formula (I), (II), (III), (IV), or (VI) is preferably 95% by mass or less and more preferably 90% by mass or less relative to the total solid content excluding the solvent contained in the dichroic dye composition, in order to develop the advantageous effects of the additives, in the case containing other additives such as a surfactant mentioned below.

When a coating solution of the dichroic dye composition is applied onto an alignment film, the dichroic dye aligns at a tilt angle or the alignment film at the interface to the alignment film and at a tilt angle of the air interface at the interface to the air. After the application of the coating solution of the dichroic dye composition of the present invention onto the surface of the alignment film, the dichroic dye is uniformly aligned (monodomain alignment) to achieve horizontal alignment.

In the present invention, the tilt angle is defined by the long axis direction of the dichroic dye molecule and the interface (to the alignment film or the air). Preferred optical performance as a stereo image print can be effectively achieved by reducing the tilt angle on the alignment film side to some extent to horizontally align the dichroic dye. Accordingly, from the viewpoint of preventing crosstalk and ghost images, the tilt angle on the alignment film side is preferably 0° to 10°, more preferably 0° to 5°, more preferably 0° to 2°, and most preferably 0°to 1°. The tilt angle on the air surface side is preferably 0°to 10°, more preferably 0°to 5°, and most preferably 0°to 2°.

In general, the tilt angle of the dichroic dye on the interface to the air can be adjusted by selecting any optional additive (e.g., horizontal alignment enhancers described in Japanese Patent Laid-Open Nos. 2005-99248, 2005-134884, 2006-126768, and 2006-267183) to achieve a preferable horizontally aligned state in a dichroic dye layer of the present invention.

The tilt angle of the dichroic dye on the alignment film side can be controlled using an agent controlling the tilt angle of the alignment film.

The dichroic dye composition may contain one or more additives in addition to the dichroic dye. The dichroic dye composition may contain reagents having at least one function as a non-liquid crystalline multifunctional, monomer having a radically polymerizable group, a polymerization initiator, a wind unevenness-preventing agent, a repelling-preventing agent, a saccharide, a fungicide, an antibacterial agent, or a germicide.

In a preferred stereo image print of the present invention, the X-ray diffractometry of the image layer shows a diffraction peak based on a periodic structure in the direction perpendicular to the alignment axis, where at least one diffraction peak has a period or 3.0 to 15.0 Å, and the maximum intensity of the diffraction peak is not present in the range of ±70° of the film normal direction in a plane perpendicular to the alignment axis.

Here, the alignment axis is the direction in which the dichroic image layer shows the highest absorbance for linearly polarized light and usually coincides with the direction of alignment treatment. For example, in a film of the dichroic dye composition fixed in the horizontal alignment, the alignment axis is in the film surface plane and coincides with the alignment treatment direction (in the present invention, in a rubbing alignment film, the alignment axis coincides with the rubbing direction; and in a photoalignment film, the alignment axis coincides with the direction of the highest birefringence developed by irradiation of the photoalignment film with light).

In general, the dichroic dye (in particular, azo dichroic dye) forming the image layer is composed of a rod-like molecule having a high aspect ratio (the length of the major axis of the molecule/the length of the minor axis of the molecule) and has a transition moment absorbing visible light in the direction approximately coincident with the direction of the molecular long axis (Non-Patent Literature: Dichroic Dyes for Liquid Crystal Displays). The image layer composed of the dichroic dye, therefore, has a higher dichroic ratio with decreases in the average angle defined by the long axis of the dichroic dye molecules and the alignment axis and the variation of the angle.

The image layer preferably shows a diffraction peak based on the period in the direction perpendicular to the alignment axis. The period corresponds to, for example, the intermolecular distance in the direction of the molecular minor axis of the dichroic dye aligned so as to have the molecular major axis in the alignment axis direction. In the present invention, the period is preferably in the range of 3.0 to 15.0 Å, more preferably 3.0 to 10.0 Å, more preferably 3.0 to 6.0 Å, and most preferably 3.3 to 5.5 Å.

Furthermore, it is preferred that no maximum value is observed in the intensity distribution of diffraction peaks of the dichroic image layer measured in the range of ±70° of the film normal direction in a plane perpendicular to the alignment axis. A maximum value of the diffraction peak intensity observed in such measurement indicates that the molecular packing is anisotropic in the direction perpendicular to the alignment axis, i.e., in the molecular minor axis direction. Specific examples of such an aggregation state include crystals, hexatic phases, and crystal phases. In anisotropic packing, the discontinuous packing generates domains and grain boundaries, which may cause haze, alignment disorder in each domain, and depolarization. In the image layer according to the present invention, since the packing in the direction perpendicular to the alignment axis is not anisotropic, a uniform film is formed without generating domains and grain boundaries. Specific examples of such an aggregation state include, but not limited to, nematic phases, smectic A phases, and supercooling states of these phases. Furthermore, the aggregation state may be a mixture of multiple aggregation states that can develop the above-described, characteristics of diffraction peaks as a whole.

The dichroic image layer is generally used for incident light at an angle of perpendicular or approximately perpendicular to the film and therefore has a high dichroic ratio in the in-plane direction. Accordingly, the dichroic image layer preferably has a periodic structure in the in-plane direction to show a diffraction peak based on the periodic structure.

The dichroic image layer preferably shows a diffraction peak based on the period in the direction parallel to the alignment axis. In particular, molecules adjacent to each other in the direction perpendicular to the alignment axis preferably form a layer that is laminated in the direction parallel to the alignment axis. Such an aggregation state is similar to a highly well-oriented smectic phase rather than a nematic phase and provides a high dichroic ratio. The period may be, for example, a length corresponding to the molecular length or twice thereof and is preferably in the range of 3.0 to 50.0 Å, more preferably 10.0 to 45.0 Å, more preferably 15.0 to 40.0 Å, and most preferably 25.0 to 35.0 Å.

The dichroic image layer preferably shows a diffraction peak having a half-value width of 1.0 Å or less.

Here, the half-value width in one diffraction peak obtained by X-ray diffractometry is a difference in period between two points, at a height half the peak height from the baseline, on both sides of the peak of the diffraction curve.

An image layer showing a diffraction peak having a half-value width of 1.0 Å or less in X-ray diffractometry is presumed to have a high dichroic ratio by the following reasons.

A large variation in angle defined by the long axis of dichroic dye molecules and an alignment axis makes a variation in intermolecular distance large. If a periodic structure is present, the periodic value of the structure also varies to make the diffraction peak obtained by X-ray diffractometry broad, resulting in a large half-value width.

In contrast, a sharp diffraction peak having a half-value width of less than a certain value indicates a small variation in the intermolecular distance and a small average angle defined by the major axis of dichroic dye molecules and an alignment axis, i.e., indicates that the molecules are aligned in a highly oriented state, in other words, they develop a high dichroic ratio.

In the present invention, the half-value width of the diffraction peak is 1.0 Å or less, preferably 0.90 Å or less, more preferably 0.70 Å or less, and most preferably 0.50 Å or less and preferably 0.05 Å or more. A half-value width exceeding the upper limit allows the variation in intermolecular distance of the dye large to inhibit the alignment from being well ordered, whereas a half-value width lower than the lower limit tends to cause alignment distortion to generate domains and grain boundaries, which may cause haze, alignment disorder in each domain, and depolarization.

The period and the half-value width of the diffraction peak of a dichroic image layer can be determined from an X-ray profile measured with an X-ray diffractometer tor thin-film evaluation (manufactured by Rigaku Corp., trade name: “ATX-G”, an in-plane optical system) or an equivalent apparatus.

The X-ray diffractometry of an image layer according to the present invention is performed, for example, by the following procedure.

The image layer is subjected to in-plane measurement for every 15° in all directions. Diffraction is measured by rotating the sample in a plane parallel to the substrate under the state that the angle at which a peak is observed is fixed, i.e., by φ scan, and the direction showing high peak intensity in the substrate surface plane is determined. The period and half-value width can be determined using the peak of in-plane measurement in the resulting direction.

### Protective Layer

The protective layer protects the dichroic image of the image layer. For example, a polymer film can be used as the protective layer. The polymer film that can be used as the protective layer is the same as the polymer film that can be used as the transparent support. The protective layer preferably contains a UV absorber. The durability of the stereo image print can be improved by addition of a UV absorber to the protective layer. Any UV absorber can be used without particular limitation. Specifically, the UV absorbers described in Japanese Patent Laid-Open No. Hei 7-11056 can be used.

The protective layer may have a laminated structure of two or more layers. The protective layer may be a coating film or a hardened film formed by coating. Such a case is described below. In the case of a protective layer composed of two or more layers, at least one layer may contain a UV absorber.

### Patterned Linearly Polarising Layer

The stereo image print of the present invention includes a patterned linearly polarizing layer. Any linearly polarizing layer that can linearly polarize light vibrating in any direction, such as natural light, can be used without particular limitation, and the linearly polarizing layer may be appropriately selected depending on the purpose. The polarizing layer preferably has a monolayer transmittance of 30% or more, more preferably 35% or more, and most preferably 40% or more. If the monolayer transmittance of the polarizing layer is less than 30%, the light utilization efficiency is considerably reduced. The polarizing layer preferably has an order parameter of 0.7 or more, more preferably 0.8 or more, and most preferably 0.9 or more. If the order parameter of the polarizing layer is less than 0.7, the light utilization efficiency is considerably reduced. The absorption axis of the polarizing layer preferably has an optical concentration of 1 or more, more preferably 1.5 or more, and most preferably 2 or more. If the optical concentration of the absorption axis of the polarizing layer is less than 1, the degree of polarization is considerably reduced to cause crosstalk and ghost images. The wavelength bandwidth of the polarizing layer preferably covers a range of 400 to 800 nm, from the viewpoint of converting the polarization of visible light. The polarizing layer may have any thickness without particular limitation. The thickness may be appropriately determined depending on the purpose, but is preferably 0.01 to 2 μm and more preferably 0.05 to 2 μm from the viewpoints of exhibiting intended optical characteristics, avoiding occurrence of parallax, and facilitating production.

The linearly polarizing layer may be made from any material and by any process. For example, an iodine polarizing plate, a dye polarizing plate containing a dichroic dye, or a polyene polarizing plate can be suitably used. The iodine polarizing plate and the dye polarizing plate can be generally produced by stretching a polyvinyl alcohol film and adsorbing iodine or a dichroic dye to the film. In this case, the transmission axis of the polarizing layer is in the direction perpendicular to the stretching direction of the film.

In addition to these polarizing plates of stretching type, the following linearly polarizing films can be also suitably used as the linearly polarizing layer in the present invention, from the viewpoint of having a relatively high degree of polarization. Preferable examples of such films include linearly polarizing plates utilizing polymerizable cholesteric liquid crystals described in Japanese Patent Laid-Open No. 2000-352611; guest-host-type linearly polarizing plates containing a dichroic dye and utilizing uniaxially aligned liquid crystals described in Japanese Patent Laid-Open Nos. Hei 11-101964, 2006-161051, and 2007-199237, PCT Japanese Translation Parent Publication Nos. 2002-527706, 2006-525382, 2007-536415, and 2008-547062, and Japanese Patent No. 3335173; wire grid polarizing plates utilizing a metal grid, such as aluminum, described in Japanese Patent Laid-Open No. 2002-365427; polarizing plates made of a polymer compound or liquid crystal compound in which carbon nanotubes are dispersed and aligned described in Japanese Patent Laid-Open No. 2002-365427; polarizing plates made of a polymer compound in which metal microparticles are dispersed and aligned described in Japanese Patent Laid-Open No. 2000-184624; polyvinylene-type linearly polarizing plates described in Japanese Patent Laid-Open No. Hei 11-248937 and PCT Japanese Translation Patent Publication Nos. Hei 10-508123, 2005-522726, 2005-522727, and 2000-522365; polarizing plates made of a lyotropic liquid crystalline dye represented by, for example, (chromogen) (SO₃M)ₙ described in Japanese Patent Laid-Open Nos. Hei. 7-261024 , Hei 8-286029, 2002-180052, 2002-90526, 2002-357720, 2005-154746, 2006-47966, 2006-48078, 2006-98927, 2006-193722, 2006-206878, 2006-215396, 2006-225671, 2006-328157, 2007-126628, 2007-133184, 2007-145995, 2007-186428, 2007-199333, 2007-291246, 2007-302807, and 2008-9417 and PCT Japanese Translation Patent Publication Nos. 2002-515075, 2006-518871, 2006-508034, 2006-531636, 2006-526013, and 2007-512236; and polarizing plates made of a dichroic dye described in Japanese Patent Laid-Open Nos. Hei 8-278409 and Hei 11-305036. Though the cholesteric liquid crystals usually can separate circularly polarized light, they can also function as a linearly polarizing plate in combination with a ¼ wavelength layer. In this case, the ¼ wavelength layer is preferably formed from a composition containing at least one kind of liquid crystal compound preferably by forming a liquid crystal phase from a composition containing at least one kind of liquid crystal compound having a polymerizable group and hardening the phase by application of heat and/or irradiation with ultraviolet light. From the viewpoint of the degree of polarization, the iodine polarizing plate, the dye polarizing plate containing a dichroic dye, the polarizing plate of a lyotropic liquid crystalline dye, and the polarizing plate or a dichroic dye are preferred.

The linearly polarizing layer used in the present invention is patterned into first domains and second domains, where the polarization axis direction of the first domains and the polarization axis direction of the second domains are in 90°with respect to each other. The linearly polarizing layer satisfying the characteristics above is preferably formed by aligning the dichroic dye composition in a desired alignment state and fixing the state through a hardening reaction and is further preferably formed by hardening a dichroic dye composition of which alignment is regulated by a pattern-exposed photoalignment film. The linearly polarizing layer of this embodiment will now be described in detail.

In the formation of the coating type linearly polarizing layer, a dichroic dye composition containing at least one kind of azo dichroic dye having nematic liquid crystallinity is preferably used. Preferred examples of the dichroic dye are the same as those that can be used in the formation of the image layer, i.e., dichroic dyes represented by Formula (I), (II), (III), (IV), (V), or (IV). In order to form a linearly polarizing layer having a high dichroic ratio, the linearly polarizing layer is preferably composed of a black dichroic dye composition. The azo dye represented by Formulae (Ia) is a magenta azo dye, the azo dyes represented by Formulae (Ib) and (II) are yellow or magenta azo dyes, and the azo dyes represented by Formulae (III) and (IV) are cyan azo dyes. The black composition may be prepared by mixing these azo dyes. The dichroic dye composition that can be used in the linearly polarizing layer may contain one or more additives in addition to the dichroic dye. The dichroic dye composition may contain reagents having at least one function as a non-liquid crystalline multifunctional monomer having a radically polymerizable group, a polymerization initiator, a wind, unevenness-preventing agent, a repelling-preventing agent, a saccharide, a fungicide, an antibacterial agent, or a germicide.

The formation of the patterned linearly polarizing layer can utilize a photo alignment layer. The photoalignment layer has alignment-regulating ability by light irradiation and has a property of determining the alignment axis depending on the direction of light irradiation. Accordingly, domains having alignment axes orthogonal to each other can be formed by pattern exposure. Furthermore, a dichroic dye composition is horizontally aligned to form a linearly polarizing layer composed of domains having polarization axes orthogonal to each other.

The photoalignment material to be formed into a photoalignment film by light irradiation is described in many documents. Preferred examples of the material for the alignment film of this embodiment include azo compounds described in Japanese Patent Laid-Open Nos. 2006-285197, 2007-76839, 2007-138138, 2007-94071, 2007-121721; 2007-140465, 2007-156439, 2007-133184, and 2009-109831 and Japanese Patent Nos. 3883848 and 4151746; aromatic ester compounds described in Japanese Patent Laid-Open No. 2002-229039; maleimide and/or alkenyl substituted nadimide compounds having photoalignment units described in Japanese Patent Laid-Open Nos. 2002-265541 and 2002-317013; photocrosslinking silane derivatives described in Japanese Patent Nos. 4205195 and 4205198; and photocrosslinking polyimides, polyamides, and esters described in PCT Japanese Translation Patent Publication Nos. 2003-520578 and 2004-529220 and Japanese Patent No. 4162850. Particularly preferred photoalignment materials are azo compounds and photocrosslinking polyimide, polyamides, and esters.

The photoalignment film composed of the material mentioned above is irradiated with linearly polarized light or unpolarized light to produce a photoalignment film.

Throughout the specification, the term “irradiation with linearly polarized light” refers to a process for generating a photoreaction of the photoalignment material. The wavelength of the irradiation light varies depending on the photoalignment material, and any wavelength causing the photoreaction can be used without limitation. the peak wavelength of the irradiation light is preferably 200 to 700 nm, and ultraviolet light having a peak wavelength of 400 nm or less is more preferred.

The light source for the light irradiation may be one that is usually used. Examples of the light source include lamps such as a tungsten lamp, a halogen lamp, a xenon lamp, a xenon flash lamp, a mercury lamp, a mercury-xenon lamp, and a carbon arc lamp; various lasers (e.g., a semiconductor laser, a helium-neon laser, an argon ion laser, a helium-cadmium laser, and a YAG laser); light-emitting diodes; and cathode-ray tubes.

The linearly polarized light can be generated by a method using a polarizing plate (e.g., an iodine polarizing plate, dichroic dye polarizing plate, or wire grid polarizing plate), a method using a prism element (e.g., a Glan-Thompson prism) or a reflection polarizer utilizing Brewstar's angle, or a method using light emitted from a polarized laser light source. Alternatively, only light having a necessary wavelength may be selectively employed for irradiation using, for example, a filter or wavelength converter.

The irradiation time is preferably 1 to 60 minutes and more preferably 1 to 10 minutes.

The patterned photoalignment layer is preferably prepared by pattern-exposing a film formed from a photoalignment material. In the pattern exposure, an exposure mask having a light-shielding portion and a light-transmitting portion is preferably used. Alternatively, a pattern may be directly drawn by focusing a laser beam or electron beam on a predetermined position of the film without using any mask

An example production process of the photoalignment film for forming a linearly polarizing layer 20 composed of first domains 20x and second domains 20y orthogonal to each other will be shown below.

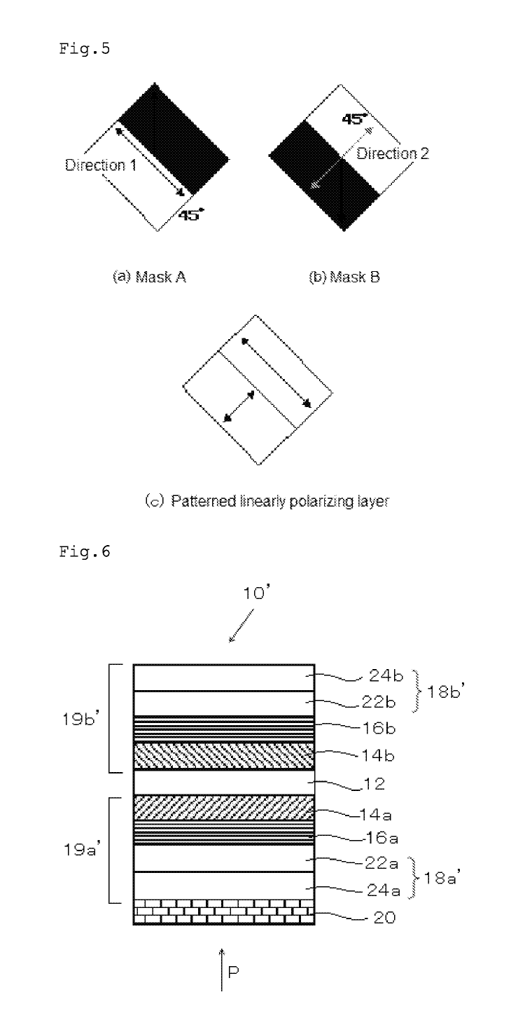

A composition for a photoalignment film is applied to the surface of a polymer film serving as the support or to the surface of, for example, a polymer film serving as a protective layer included in the first laminate to form a film. Subsequently, the film is irradiated with linearly polarized light using a wire grid. Specifically, as shown in FIG. 5(a), a wire grid polarizer is placed in the direction 1 tilting by +45° with respect to the horizontal direction, and exposure is performed through the mask A (in the figure, the black portion is a light-shielding portion, and the white portion is a light-transmitting portion. The same is applied to the mask B). Subsequently, as shown in FIG. 5(b), the wire grid polarizer is placed in the direction 2 tilting by −45° with respect to the horizontal direction, and exposure is performed through the mask B. As a result, first and second photoalignment film domains having their alignment axes in the directions of +45° and −45°, respectively, so as to be orthogonal to each other are formed. Furthermore, the alignment of the dichroic dye composition on the photoalignment film allows the liquid crystalline dichroic dye molecules on the first photoalignment film domain to align according to the alignment axis of the first domain and the liquid crystalline dichroic dye molecules on the second photoalignment film domain to align according to the alignment axis of the second domain. These states are fixed to form a linearly polarizing layer patterned into first and second domains of which polarization axes are in 90° with respect to each other (FIG. 5(c)).

The patterned linearly polarizing layer can also be formed using a rubbing alignment layer instead of the photoalignment layer. In such a case, a rubbing alignment film having separated domains subjected to rubbing treatment in directions orthogonal to each other is used.

FIG. 6 is a schematic cross-sectional view of another example of a stereo image print of the present invention. The members that are the same as those in FIG. 1 are denoted with the same reference numerals, and detailed descriptions thereof will be omitted.

In the stereo image print 10′ shown in FIG. 6, the first and the second laminates 19a and 19b include the protective layers 18a′ and 18b′, respectively. The protective layer 18a′ is composed of an oxygen-shielding layer 22a and a transparent resin hardened layer 24a formed by coating, and the protective layer 18b′ is composed of an oxygen-shielding layer 22b and a transparent resin hardened layer 21b formed by coating. The oxygen-shielding layers 22a and 22b have oxygen-shielding ability of preventing oxygen from penetrating into the image layers 16a and 16b and thereby preventing the dichroic dye and other components from being deteriorated and decolored. The transparent resin hardened, layers 24a and 24b are disposed for increasing the physical strength and durability of the stereo image print or for imparting optical characteristics to the stereo image print. The oxygen-shielding layers 22a and 22b may be used as intermediate layers that contribute to prevention of mixing of interlaminar components at the coating step and during storage after the coating. The intermediate layer is referred to as “separation layer” in Japanese Patent Laid-Open No. Hei 5-72724 and it is incorporated herein.

The oxygen-shielding layer preferably shows low oxygen permeability and can be dispersed or dissolved in water or an aqueous alkali solution and can be appropriately selected from known films. In particular, the oxygen-shielding layer is preferably a film of which main component is polyvinyl alcohol, more preferably a film composed of a composition containing polyvinyl alcohol and polyvinyl pyrrolidone.

The oxygen-shielding layer preferably has a thickness in the range of 0.1 to 10 μm, more preferably 0.5 to 5 μm.

### Transparent Resin Hardened Layer

The transparent resin hardened layer preferably has a thickness in the range of 1 to 30 μm, more preferably 1 to 10 μm.

The transparent resin hardened layer is preferably formed by crosslinking or polymerization of an ionizing radiation hardening compound. The transparent resin hardened layer in the present invention can be formed by applying a composition containing an ionizing radiation hardening multifunctional monomer or oligomer to the surface of a layer such as a dichroic dye layer or an oxygen-shielding layer and crosslinking or polymerizing the multifunctional monomer or oligomer.

The ionizing radiation hardening multifunctional monomer and oligomer each preferably have a photo-, electron beam-, or radiation-polymerizable functional group, particularly, a photo-polymerizable functional group.

Examples of the photo-polymerizable functional group include unsaturated polymerizable functional groups such as a (meth)acryloyl group, a vinyl group, a styryl group, and an allyl group. In particular, a (meth)acryloyl group is preferred. The transparent resin hardened layer may contain inorganic microparticles.

Specific examples of the photo-polymerizable multifunctional monomer having a photo-polymerizable functional group include:

(meth)acrylate diesters of alkylene glycols such as neopentyl glycol acrylate, 1,6-hexanediol (meth)acrylate, and propylene glycol di(meth)acrylate;

(meth)acrylate diesters of polyoxy alkylene glycols such as triethylene glycol di(meth)acrylate, dipropylene glycol di(meth)acrylate, polyethylene glycol di(meth)acrylate, and polypropylene glycol di(meth)acrylate;

(meth)acrylate diesters of multivalent alcohols such as pentaerythritol di(meth)acrylate, and

(meth)acrylate diesters of ethylene or propylene oxide adducts such as 2,2-bis[4-(acryloxy diethoxy)phenyl]propane and 2-2-bis[4-(acryloxy polypropoxy)phenyl]propane.

Furthermore, epoxy (meth)acrylates, urethane (meth)acrylates, and polyester (meth)acrylates can also be preferably used as the photo-polymerizable multifunctional monomers.

In particular, esters of multivalent alcohols and (meth)acrylic acid are preferred. Multifunctional monomers having three or more (meth)acryloyl groups in one molecule are more preferred. Specific examples thereof include trimethylol propane tri(meth)acrylate, trimethylol ethane (meth)acrylate, 1,2,4,-cyclohexane tetra(meth)acrylate, pentaglycerol triacrylate, pentaerytritol tetra(meth)acrylate, pentaerythritol tri(meth)acrylate, dipentaerythitol triacrylate, depentaerythritol pentaacrylate, dipentaerythritol tetra(meth)acrylate, dipentaerythritol hexa(meth)acrylate, tripentaerythritol triacrylate, and tripentaerythritol hexatriacrylate. The multifunctional monomers may be used in combination of two or more thereof.

In the hardening reaction of the composition, a polymerization initiator is preferably used. The photo-polymerization initiator, is preferably a photo-radical polymerization initiator or a photo-cationic polymerization initiator, most preferably a photo-radical polymerization initiator.

Examples of the photo-radical polymerization initiator include acetophenones, benzophenones, Michler's benzoyl benzoate, α-amidoxime ester, tetramethyl thiuram monosulfide, and thioxanthones.

Commercially available examples of the photo-radical polymerization initiator include Kayacure series (e.g., DETX-S, BP-100 BDMK, CTX, BMS, 2-EAQ, ABQ, CPTX, EPD, ITX, QTX, BTC, and MCA: trade names) manufactured by Nippon Kayaku Co., Ltd.; Irgacure series (e.g., 651, 184, 127, 500, 907, 369, 1173, 2959, 4265, and 4263: trade names) manufactured by Ciba Specialty Chemicals Inc; and Esacure series (KIP100F, KB1, EB3, BP, X33-KT046, KT37, KIP150, and TZT: trade names) manufactured by Sartomer Company Inc.

In particular, a photo-cleavage-type photo-radical polymerization initiator is preferred. The photo-cleavage-type photo-radical polymerization initiator is described in Saishin UV Koka Gijutsu (Advanced UV Curing Technology) (p. 159, Publisher: Kazuhiro Takausu, Publishing office: Technical Information Institute Co., Ltd., 1991).

Commercially available examples of the photo-cleavage-type photo-radical polymerization initiator include Irgacure series (651, 184, 127, and 907: trade names) manufactured by Ciba Specialty Chemicals Inc.

The content of the photo-polymerization initiator is preferably 0.1 to 15 parts by mass, more preferably 1 to 10 parts by mass, based on 100 parts by mass of the curable resin.

In addition to photo-polymerization initiator, a photosensitizer may also be used. Specific examples of the photosensitizer include n-butylamine, triethylamine, tri-n-butylphosphine, Michler's ketone, and thioxanthone.

Commercially available examples of the photosensitizer include Kayacure series (e.g., DMBI and EPA: trade names) manufactured by Nippon Kayaku Co., Ltd.

The photo-polymerization is preferably performed by irradiating an applied and dried transparent resin layer with ultraviolet light to provide a hardened layer.

The transparent resin hardened layer may contain an oligomer and/or a polymer having a mass average molecular weight of 500 or more for obtaining brittleness.

Examples of the oligomer and the polymer include (meth)acrylates, cellulose, and styrene polymers; urethane acrylates; and polyester acrylates. Preferred examples of the oligomer and the polymer include poly(glycidyl (meth)acrylate) and poly(allyl (meth)acrylate) that have functional groups in side chains.

The total amount of the oligomer and the polymer contained in the transparent resin hardened layer is preferably 5 to 80% by mass, more preferably 25 to 70% by mass, and most preferably 35 to 65% by mass relative to the total mass of the resin layers

The transparent resin hardened layer preferably has a strength of “H” or more, more preferably “2H” or more, and most preferably “3H” or more, measured by a pencil hardness test in accordance with JIS K5400.

In a Taber abrasion test in accordance with JIS K7204, a low abrasion loss of a test piece after the test is preferred.

When the transparent resin hardened layer is formed by crosslinking or polymerization of an ionizing radiation hardening compound, the crosslinking or polymerization is preferably performed under an atmosphere of an oxygen concentration of 10 vol % or less, which allows formation of a transparent resin hardened layer having excellent physical strength and durability.

The oxygen concentration as the condition for forming the layer by crosslinking or polymerization of an ionizing radiation hardening compound is preferably 6 vol % or less, more preferably 4 vol % or less, more preferably 2 vol % or less, and most preferably 1 vol % or less.

An oxygen concentration of 10 vol % or less is preferably achieved by replacing the air (nitrogen concentration: about 79 vol %, oxygen concentration: about 21 vol %) with another gas, in particular, with nitrogen (nitrogen purging).

The transparent resin hardened layer is preferably constructed by applying a coating composition for a transparen resin hardened layer to the surface of the dichroic dye layer.

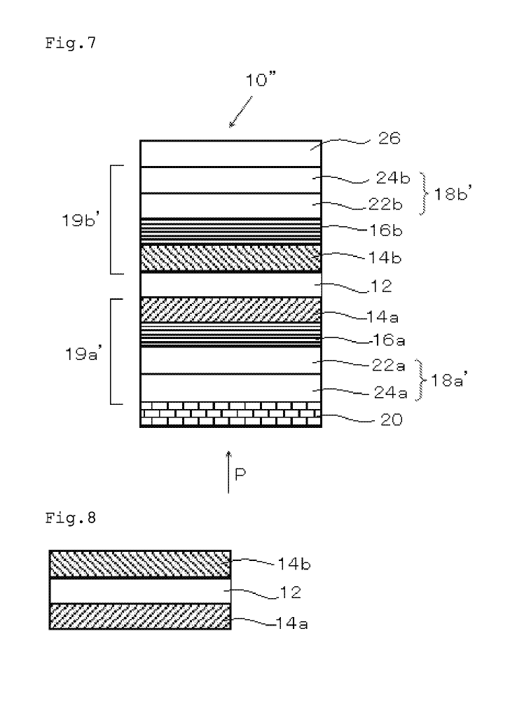

Though the protective layer, as shown in FIG. 6, may include two or more functional lavers such as an oxygen-shielding layer and a transparent resin hardened layer, the protective layer 18a′ included in the first laminate 19a′ on the viewer side is required to have en in-plane retardation value (Re) of 10 nm or less for visible light as a whole, preferably 0 to 5 nm, and most preferably 0 to 3 nm. These requirements are also applied to the embodiment shown in FIG. 7.

FIG. 7 illustrates a schematic cross-sectional view of another example of the stereo image print of the present invention.

In the embodiment of the stereo image print shown in FIG. 7, a non-depolarizing reflecting layer 26 is disposed on the back surface of the second laminate 19b′, i.e., on the back side of the stereo image print shown in FIG. 6. In this embodiment, a stereoscopic image can be observed with reflected light of natural light.

### Reflecting Layer

The non-depolarizing reflecting layer that can be used in this embodiment is preferably, for example, paper coated with a thin metal film, a thin metal film mirror, metal foil, or metal flakes floating in plastic.

### 2. Method of Producing Stereo Image Print

The present invention also relates to a method of producing the stereo image print of the present invention.

The method of producing the stereo image print of the present invention at least involves:

applying a dichroic dye composition at least containing an organic solvent and at least one kind of dichroic dye dissolved in the organic solvent, simultaneously or separately, onto the front surface and the back surface of the transparent support so as to form respective dichroic images with pixels for the left eye and pixels for the right eye arranged in a predetermined array (Step a); and

horizontally aligning the at least one kind of dichroic dye spontaneously or passively by evaporating the organic solvent in the composition (Step b). Each step is as follows.

A printing sheet having image-receiving layers (e.g., alignment films) on both surfaces of a transparent support is prepared. FIG. 8 is a schematic cross-sectional view of an example printing sheet. The printing sheet includes a transparent support 12 and image-receiving layers 14a and 14b respectively disposed on both surfaces of the transparent support 12. Preferred embodiments of the transparent support and the image-receiving layers are as described above.

### Step a:

In the meshed of the present invention, an image is formed from a dichroic dye composition at least containing an organic solvent and at least one kind of dichroic dye dissolved in the solvent. The composition is applied onto the image-receiving layers disposed on the front and the back surfaces of the transparent support to form a dichroic image on each surface with pixels for the left eye and pixels for the right eye arranged in a predetermined array. Though the coating may be performed by any method, ink jetting is suitable for a case of applying the composition to the printing sheet so as to form an image based on digitized image data. An example using ink jetting is as follows.

Image data is digitized with an image data processor into image data for the left eye and image data for the right eye having parallax. Examples of the digitized image data include image data photographed with a digital camera, more specifically, digital data such as an image photographed with a digital camera equipped with taking lenses of two systems for right and left. In the image data processor, image data for the left eye and image data for the right eye are each decomposed into a predetermined pattern (e.g., stripe pattern) to generate image data composed of pixels for the left eye and pixels of the right eye arranged in a predetermined pattern. The dichroic dye composition is stored in an ink dispenser of an ink-jet apparatus connected to the image data processor. The ink-jet apparatus is controlled so as to discharge the composition from an ink-jet head according to digital signals transmitted from the image data processor. The composition discharged from the ink-jet head lands on a predetermined position of the image-receiving layer of the printing sheet that has been positioned and supported to form a dichroic image.

Images on both image-receiving layers may be formed simultaneously or separately. The mechanism of the ink-jet apparatus will be adjusted depending on the procedure.

The dichroic composition is applied preferably at a temperature of about 0° C. or more and 80° C. or less and a humidity of about 10% RH or more and 80% RH or less. These ranges preferably enable uniform application without causing evaporation of the solvent before landing of the coating solution on the alignment film surface.

When the dichroic dye is applied to the image-receiving layers (e.g., alignment films) so as to form respective images, the printing sheet may be warmed or cooled. In the case of using alignment films as the image-receiving layers of the printing sheet, the temperature of each alignment film is preferably 10° C. or more and 60° C. or less. A temperature higher than this upper limit may cause drying involving disordered alignment, whereas a temperature lower than this lower limit may form droplets of water on the base material surface to disadvantageously affect the application.

The dichroic dye composition at least contains an organic solvent and at least one kind of dichroic dye dissolved in the organic solvent. The dichroic dye preferably has liquid crystallinity. Preferred examples of the dichroic dye are the same as those described above. The dichroic dye composition is preferably prepared as a liquid composition that can be applied by ink jetting. Examples of the organic solvent include amides (e.g., N,N-dimethylformamide), sulfoxides (e.g., dimethylslfoxide), heterocyclic compounds (e.g., pyridine), hydrocarbons (e.g., benzene and hexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Alkyl halides and ketones are preferred. The organic solvents may be used in combination of tow or more thereof.

The dichroic dye composition preferably has a viscosity of 0.5 cP or more, more preferably 1 cP or more, more preferably 5 cP or more, and most preferably 10 cP or more. The composition preferably has a surface tension of 20 dyn/cm or more, more preferably 25 dyn/cm or more, and most preferably 30 dyn/cm or more.

The total solid content in the dichroic dye composition is preferably 1 to 20% by mass, more preferably 1 to 10% mass, and most preferably 1 to 5% by mass.

### Step b:

Subsequently, the at least one kind of dichroic dye is spontaneously or passively horizontally aligned through evaporation of the organic solvent from the composition applied onto the image-receiving layers (e.g., alignment films) by, for example, ink jetting to form respective dichroic images. For example, in the case of using alignment films as the image-receiving layers, each dichroic image is formed by horizontally aligning the dichroic dye molecules spontaneously or passively on the alignment film along the alignment axis of the alignment film. In the case of using molecularly aligned films as the image-receiving layers, each dichroic image is formed by allowing the dichroic dye to permeate the molecularly aligned film and horizontally aligning the dichroic dye molecules spontaneously or passively along the molecular alignment of the film. Drying is preferably performed not to disorder the alignment state of the dye molecules (to avoid thermal relaxation, etc.). From such a viewpoint, the drying temperature is preferably room temperature. That is, natural drying is preferred. On the contrary, in order to facilitate the alignment of the dichroic dye molecules in drying, the printing sheet may be heated. The temperature of the printing sheet on such occasion is therefore preferably 50° C. to 200° C. and more preferably 70° C. to 180° C. In order to decrease this alignment temperature, the composition may contain additives such as a plasticizer.

In this step, the dichroic dye molecules are horizontally aligned. For example, in the case of using alignment films as the image-receiving layers, for example, the alignment axes of the alignment films are in the directions of −45° and +45°, respectively, to define an angle of 90°. In the case of using molecularly aligned films as the image-receiving layers, for example, the molecularly aligned films are stretched in the directions of −45° and +45°, respectively, to be molecularly aligned to define an angle of 90°. When the dichroic dye molecules having the absorption axis in the major axis direction are aligned such that the major axis is parallel to the alignment axis of the alignment film or to the molecular alignment direction of the molecularly aligned film, a dichroic image having the absorption axis in the direction of −45 ° is formed on one of the image-receiving layers, and a dichroic image having the absorption axis in the direction of +45° is formed on the other image-receiving layer.

In Step b, the dichroic dye molecules are preferably aligned horizontally to the layer surface of each image-receiving layer. the liquid crystal phase in an alignment state may be a nematic phase, a smectic phase, or an intermediate therebetween.

After Step b, a protective layer may be formed on each dichroic image. The protective layer may be formed by coating or may be bonding a polymer film. Furthermore, after the step, a patterned linearly polarizing layer may be formed on the surface, on the viewer side, of the protective layer. The patterned linearly polarizing layer may be formed as described above.

### EXAMPLES

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be imitatively interpreted by the Examples mentioned below.

### 1. Example 1

### Preparation of Printing Sheet for Stereoscopic Image

### Preparation of Transparent Support

The components for the cellulose acetate solution composition shown below were put into a mixing tank and were heated with stirring to dissolve tire components to prepare a cellulose acetate solution as a dope.

### Composition of Cellulose Acetate Solution

Cellulose acetate having a degree of acetylation of 60.9%: 100 parts by mass

Triphenyl phosphate (plasticizer): 7.8 parts by mass

Biphenyl diphenyl phosphate (plasticizer): 3.9 parts by mass

Methylene chloride (first solvent): 318 parts by mass

Methanol (second Solvent): 47 parts by mass

The resulting dope was flow-cast with a band flow-casting machine. A film having a residual solvent content of 15% by mass was laterally stretched into a stretching ratio of 15% by free-end uniaxial stretching at 150° C. to produce a cellulose acetate film (thickness: 92 μm).

The Re value at 550 nm of the resulting cellulose acetate film was measured using light having a wavelength of 550 nm incident on the normal direction of the film with KOBRA 21ADH (trade name, manufactured by Oji Keisoku Kiki Co., Ltd.). The Re value was 7 nm.

### Preparation of Rubbing Alignment Film

An aqueous solution of 4% “PVA103”, polyvinyl alcohol manufactured by Kuraray Co., Ltd., was applied to the front and the back surfaces of the cellulose acetate film with a No. 12 bar, followed by drying at 80° C. for 5 minutes. Subsequently, both the resulting coating films were subjected to rubbing treatment involving three reciprocating movements at 400 rpm in the directions (±45°) shown in FIG. 3 such that the directions on the front surface and the back surface are orthogonal to each other to prepare a printing sheet for a stereoscopic image. On the resulting alignment films, the liquid crystal molecules are horizontally aligned such that the major axis is coincident with the rubbing axis.

A printing sheet having a structure shown in FIG. 8 was produced in such a manner. That is, a printing sheet including a transparent support 12 of a cellulose acetate film and alignment films 14a and 14b on both surfaces of the transparent support 12 was produced.

### Preparation of Ink for Forming Stereoscopic Image

### Preparation of Dochroic Dye Composition

The following composition was stirred and dissolved to prepare inks for stereoscopic image. The yellow ink, magenta ink, and cyan ink each had a viscosity of 0.6 cP and a surface tension of 30 dyn/cm.

### Yellow Ink for Stereoscopic Image

Yellow azo dye A2-3 having the following structure (compound of Formula (II)): 1 part by mass

Chloroform (solvent): 99 parts by mass

Magenta ink for stereoscopic image

Magenta azo dye C-9 having the following structure (compound of formula (I)): 1 part by mass

Chloroform (solvent): 99 parts by mass

Cyan ink for stereoscopic image

Cyan azo dye A3-1 having the following structure (compound of Formula (III)): 0.87 parts by mass

Cyan squarylium dye VI-5 having the following structure: 0.13 parts by mass

Chloroform (solvent): 99 parts by mass

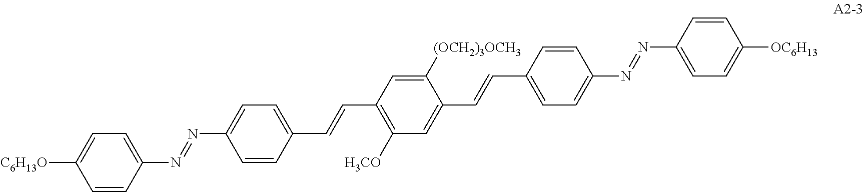

K: 138° C., N: 284° C., I

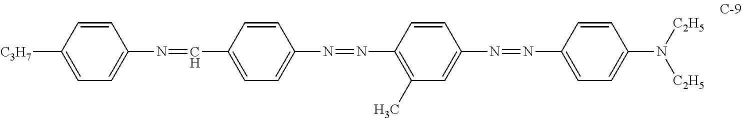

K: 167° C., N: 288° C., I

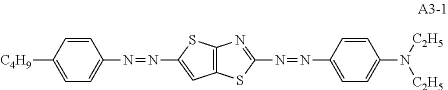

### K: 200° C., N: 237° C., I

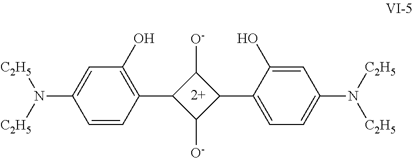 [SMILES: CCN(CC)c1ccc(C2C([O-])C(c3ccc(N(CC)CC)cc3O)C2[O-])c(O)c1]

K: crystal phase
N: nematic phase
I: isotropic phase

### Production of Stereo Image Print

### Formation of Dichroic Image

Data for the right eye and data for the left eye photographed with a digital camera equipped with taking lenses of two systems for right and left were each converted into digital data, and droplets of the ink for stereoscopic image prepared above were ejected on both rubbing alignment films with a piezoelectric ink-jet head. The pixels for the right eye and the pixels for the left eye were each separated into a predetermined stripe pattern and were alternately arranged to constitute an image in each of the front and the back printing surfaces such that the positions of the pixels for the right eye in the front printing surface correspond to those of the pixels for the left eye in the back printing surface. The solvent was evaporated at room temperature to fix the aligned state to form dichroic images. The gradation corresponding to the image date can be controlled by controlling the amount and the density of ink ejected. The dichroic images on the front surface and the back surface were each horizontally aligned within a range of ±1° such that the alignment directions of both images were orthogonal to each other. The dichroic dye layers of the front surface and the back surface each had a thickness of 1 μm.

### Measurement of Dichroic Ratio of Dichroic Dye Layer

A dichroic image was separately formed using the same ink and fixing under the same conditions as described above, and the dichroic ratio thereof was measured.

The absorbance of the dichroic dye layer was measured with a spectrophotometer having an incident optical system equipped with an iodine polarizer, and the dichroic ratio was calculated by the following expression:

Dichroic ratio (D)=Az/Ay

Az: absorbance of light absorbing anisotropic film for polarized light in the absorption axis direction

Ay: absorbance of light absorbing anisotropic film for polarized light in the polarization axis direction

The results of the measurement are shown in Table 1.

### Preparation of coating Solution for Oxygen-Shielding Layer

The following composition was put into a mixing tank and was stirred to prepare a coating solution for oxygen-shielding layer.

A mixture of 3.2 parts by mass of polyvinyl alcohol (PVA205 (trade name), manufactured by Kuraray co., Ltd.), 1.5 parts by mass of polyvinyl pyrrolidone (PVP K-30 (trade name), manufactured by Nippon Shokubai Co., Ltd.), 44 parts by mass of methanol, and 56 parts by mass of water was stirred and was filtered through a polypropylene filter having a pore size of 0.4 μto prepare a coating solution for oxygen-shielding layer.

### Production of Oxygen-Shielding Layer

The coating solution for oxygen-shielding layer was applied onto the surface of each of the dichroic dye layers on the front surface and the back surface described above, followed by drying at 100° C. for 2 minutes to prepare oxygen-shielding layers. The oxygen-shielding layers each had a thickness of 1 μm.

### Preparation of Coating Solution for Transparent Resin Hardened Layer

The following composition was put into a mixing tank and was stirred to prepare a coating solution for transparent resin hardened layer.

A mixture of 2.7 parts by mass of poly(glycidyl methacrylate) having a mass average molecular weight of 15000, 7.3 parts by mass of methyl ethyl ketone, 5.0 parts by mass of cyclohexanone, and 0.5 parts by mass of a photo-polymerization initiator (Irgacure 184 (trade names), manufactured by Ciba Specialty Chemicals Inc.) to 7.5 parts by mass of trimethylolpropane triacrylate (Viscoat #295 (trade name), manufactured by Osaka Organic Chemical Industry Ltd.) was stirred and was filtered through a polypropylene filter having a pore size of 0.4 μm to prepare a coating solution for transparent resin hardened layer.

### Production of Transparent Resin Hardened Layer

The costing solution for transparent resin hardened layer was applied onto the surface of each of the oxygen-shielding layers on the front surface and the back surface described above, followed by drying at 100° C. for 2 minutes. Subsequently, irradiation with 5 J of ultraviolet light was performed under a nitrogen atmosphere (oxygen concentration: 100 ppm or less) for polymerization. Thus, a stereo image print having an oxygen-shielding layer having a thickness of 1 μm and a transparent resin hardened layer having a thickness of 2 μm stacked on the surface of true dichroic dye layer (thickness: 1.0 μm) in this order was produced. The transparent resin hardened layer had an Re value of 0 nm at a wavelength of 550 nm and a strength of “H” measured by a pencil hardness test in accordance with JIS K5400.

### Production of Patterned Linearly Polarizing Layer

### Production of Photoalignment Film

An aqueous solution containing 1% photoalignment material E-1 having a structure shown below was applied to one surface of a cellulose acetate film by spin coating, followed by drying at 100° C. for 1 minute. The resulting coating film was irradiated with ultraviolet light at 160 W/cm in air using an air-cooling metal halide lamp (manufactured by Eye Graphics Co., Ltd.). On this occasion, a wire grid polarizer (manufactured by Moxtek, Inc., ProFlux PPL02) was placed in the direction 1 as shown in FIG. 5 and was then exposed to light through a mask A (a quartz exposure mask having an image pattern). Subsequently, the wire grid polarizer was placed in the direction 2 orthogonal to the direction 1 and was then exposed to light through a mask B. The distance between the exposure mask surface and the photoalignment film was set to be 200 μm. the illuminace of the ultraviolet light used on this occasion was set to 100 mW/cm² in a UV-A region (integration in the wavelength range of 380 to 320 nm), and the dose was set to 1000 mJ/cm² in the UV-A region.

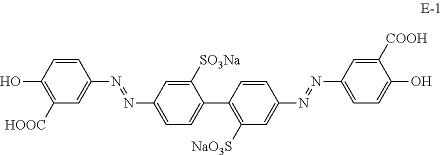

### Production of Patterned Linearly Polarizing Layer

A mixture of 0.24 parts by mass or yellow azo dye A2-3 having a structure shown below (compound represented by Formula (II)), 0.33 parts by mass or magenta azo dye A-46 having a structure shown below (compound represented by Formula (I)), 0.37 parts by mass or cyan azo dye A3-1 having a structure shown below (compound represented by Formula (III)), and 0.06 parts by mass of squarylium dye VI-5 having a structure shown below to 99 parts by mass of chloroform was dissolved by stirring, followed by filtration to yield a seating solution for linearly polarizing layer. The coating solution was then applied onto the pattern-exposed photoalignment film, followed by natural drying at room temperature to produce a patterned linearly polarizing layer. FIG. 5(c) is a plan view of the patterned linearly polarizing layer. The patterned linearly polarizing layer had polarization axes orthogonal to each other, a thickness of 0.4 μm, and a dichroic ratio of 42. The composition for linearly polarizing layer had a thermotropic liquid crystallinity of which isotropic phase transition temperature is 240° C.

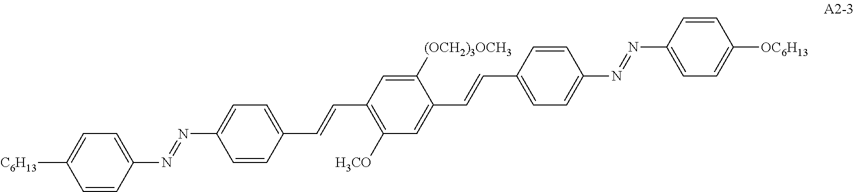

### K: 138° C., N: 284° C., I

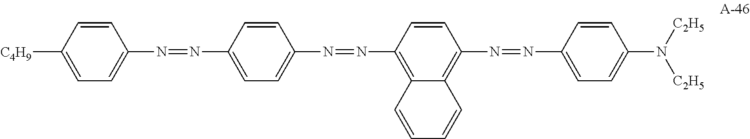

### K: 158° C., N: 240° C., I

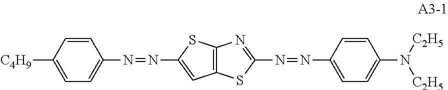

### K: 200° C., N: 237° C., I

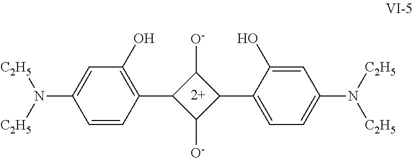 [SMILES: CCN(CC)c1ccc(C2C([O-])C(c3ccc(N(CC)CC)cc3O)C2[O-])c(O)c1]

### K: 281° C., I

### Bonding of Stereo Image Print and Patterned Linearly Polarizing Layer

An adhesive sheet was attached to the patterned linearly polarizing layer on the cellulose acetate film side, and the patterned linearly polarizing layer was bonded to the transparent resin hardened layer of the stereo image print. Thus, a stereo image print having a structure shown in FIG. 6 (note that the adhesive layer, cellulose acetate film, and photoalignment film disposed between the first laminate 19a′ and the patterned linearly polarizing layer 20 were omitted) was produced. That is, a stereo image print was produced which was composed of a first laminate 1940 stacked on the front surface of the transparent support 12 and composed of a rubbing alignment film 14a, an image layer 16a having a dichroic image including pixels for the right eye and pixels for the left eye arranged in a predetermined stripe pattern, and a protective layer 18a′ consisting of an oxygen-shielding layer 22a and a transparent ream hardened layer 24a; a second laminate 19b′ stacked on the back surface of the transparent support 12 and composed of a rubbing alignment film 14b, an image layer 16b having a dichroic image including pixels for the right eye and pixels for the left eye arranged in a predetermined stripe pattern, and a protective layer 18b′ consisting of an oxygen-shielding layer 22b and a transparent resin hardened layer 24b; and a patterned linearly polarizing layer 20 disposed on the viewer-side surface of the first laminate 19a′.

The patterned linearly polarizing layer 20 was bonded to the stereo image print that the absorption axis direction of the dichroic dye forming each of the pixels for the right eye and the pixels for the left eye of the stereo image print is coincident with the polarization axis of the linearly polarizing layer, when viewed from each position of the right eye and the left eye of a viewer, as shown in FIG. 2.

### Observation of a Steroscopic Image

A viewer observed the produced stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

### 2. Example 2

### Production of Stereo Image Print

An aluminum reflecting layer was stacked on the back surface of the stereo image print produced in Example 1 to produce a stereo image print having a structure shown in FIG. 7 (note that the adhesive layer, cellulose acetate film, and photoalignment film were disposed between the first laminate 19a′ and the patterned linearly polarizing layer 20). That is, a stereo image print was produced which was composed of a first laminate 19a′ stacked on the front surface of the transparent support 12 and composed of a rubbing alignment film 14a, an image layer 16a having a dichroic image including pixels for the right eye and pixels for the left eye arranged in a predetermined stripe pattern, and a protective layer 18a′ consisting of an oxygen-shielding layer 22a and a transparent resin hardened layer 24a; a second laminate 19b′ stacked on the back surface of the transparent support 12 and composed of a rubbing alignment film 14b, an image layer 16b having a dichroic image including pixels for the right eye and pixels for the left eye arranged in a predetermined stripe pattern, and a protective layer 18b′ consisting of an oxygen-shielding layer 22b and a transparent resin hardened layer 24b; a patterned linearly polarizing layer 20 disposed on the viewer-side surface of the first laminate 19a′; and a reflecting layer 26 disposed on the rear surface of the second laminate 19b′.

The patterned linearly polarizing layer 20 was bonded to the stereo image print such that the absorption axis direction of the dichroic dye forming each of the pixels for the right eye and the pixels for the left eye of the stereo image print is coincident with the polarization axis of the linearly polarizing layer, when viewed from the positions of the right eye and the left eye of a viewer, as shown in FIG. 2.

### Observation of Stereoscopic Image

A viewer observed the thus produced from stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

### Production of Printing Sheet for Stereoscopic Image

A stereo image print was produced as in Example 1 except that a photoalignment film shown below was used instead of the rubbing alignment film.

### Production of Photoalignment Film

An aqueous solution containing 1% photoalignment material E-1 was applied to the front surface and the back surface of the cellulose acetate film by spin coating, followed by drying at 100° C. for 1 minute. The resulting coating film was irradiated with linearly polarized ultraviolet light (illuminance: 140 mW, irradiation time: 35 seconds, dose: 5 J/cm²) using a polarized ultraviolet light exposure device to produce a printing sheet for stereoscopic image. The irradiation was performed for both the front surface and the back surface. As shown in FIG. 4, the front and the back surfaces were irradiated with light such that the irradiation directions were perpendicular to the respective surfaces and were orthogonal to each other.

### Production of Stereo Image Print

### Production of Dichroic Dye Layer

Data for the right eye and data for the left eye photographed with a digital camera equipped with taking lenses of two systems for right and left were converted into digital data, and droplets of the ink for stereoscopic image prepared in Example 1 were ejected on the photoalignment film with a piezoelectric ink-jet head. The pixels for the right eye and the pixels for left eye were each separated into a predetermined stripe pattern and were alternately arranged to constitute an image in each of the front and the back printing surfaces such that the positions of the pixels for the right eye in the front printing surface correspond to those of the pixels for the left eye in the back printing surface. The solvent was evaporated at room temperature to fix the aligned state to form dichroic dye layers. The gradation corresponding to the image data can be controlled by controlling the amount and the density of ink ejected. The dichroic dye layers on the front surface and the back surface were each horizontally aligned within a range of ±1° such that the alignment directions of both layers were orthogonal to each other. The dichroic dye layers of the front surface and the back surface each had a thickness of 1 μm.

### Measurement of Dichroic Ratio of Dichroic Dye Layer

A dichroic image was separately formed using the same ink and fixing under the same conditions as described above, and the dichroic ratio thereof was measured.

The results of the measurement are shown in Table 1.

### Stereo Image Print

A stereo image print was produced by the same procedure as that in Example 1.

### Observation of Stereoscopic Image

A viewer observed the thus produced stereo image print from the designed viewing position without wearing polarized glasses. A clear stereoscopic image was observed without crosstalk and ghost images. In addition, in the stereo image print of this Example, the resolution was not decreased, whereas the resolution was decreased to a half when a conventional parallax barrier was used.

TABLE 1

| No. | Dichroic dye | Dichroic ratio |
|---|---|---|
| Example 1 | A2-3 | 39 |
| | C-9 | 37 |
| | A3-1 | 24 |
| | VI-5 | 25 |
| Example 3 | A2-3 | 39 |
| | C-9 | 37 |
| | A3-1 | 24 |
| | VI-5 | 25 |

### 4. Examples 4 and 5

### Production of Image Print for Stereoscopic Image

An image print for stereoscopic image was produced as in Example 1 except that A1-16 or A1-46 was used as the magenta ink for stereoscopic image.

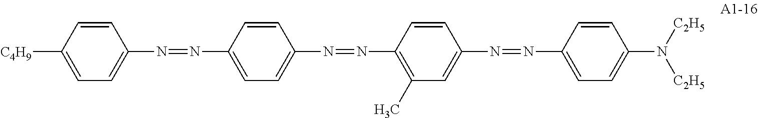

### K: 137° C., N: 266° C., I

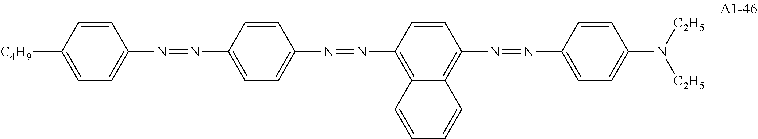

### K: 158° C., N: 240° C., I

### Measurement of Dichroic Ratio of Dichroic Dye Layer

A dichroic dye layer was separately formed using the same magenta ink and fixing under the same conditions as described above, and the dichroic ratio thereof was measured.

The results of the measurement are shown in the following table.

### Measurement of Periodic Structure of Dichroic Dye Layer

The period and the half-value width of a dichroic dye layer separately formed using the magenta ink were determined from an in-plane profile and a φ profile measured with an X-ray diffractometer for thin-film evaluation (manufactured by Rigaku Corp., trade name: “ATX-G”, an in-plane optical system). Both measurements were performed using CuKα at an incident angle of 0.18°.

The relationship between the angle of diffraction and the distance was converted by the following expression:

d=λ/(2*sin θ)

(d: distance, λ: incident X-ray wavelength (CuKα: 1.54 Å)).

The results of fire measurement are shown in the following table.

TABLE 2

| | | | Perpendicular to the | | | Parallel to the | | |
|---|---|---|---|---|---|---|---|---|
| | | Dichroic | alignment axis | | | alignment axis | | |
| No. | Dichroic dye | ratio | Peak 1 | Peak 2 | Peak 3 | Peak 1 | Peak 2 | Peak 3 |
| Example 1 | C-9 | 37 | 4.79 Å | 3.95 Å | | 10.56 Å | 3.93 Å | |
| | | | 0.46 Å | 0.25 Å | | 0.61 Å | 0.09 Å | |
| Example 4 | A1-16 | 80 | 4.84 Å | 4.03 Å | 3.35 Å | 4.01 Å | | |
| | | | 0.17 Å | 0.14 Å | 0.08 Å | 0.09 Å | | |
| Example 5 | A1-46 | 21 | 5.57 Å | 4.57 Å | | 7.56 Å | 4.56 Å | |
| | | | 0.19 Å | 0.89 Å | | 0.36 Å | 0.45 Å | |

Note:
The numbers on the upper row denote the periods, and the numbers of the lower row denote the half-value widths.

### Observation of Stereoscopic Image

A viewer observed the prepared stereo image prints. In Examples 1 and 4 using dichroic dyes C-9 and A1-16, respectively, as the magenta ink, the half-value widths of diffraction peaks in the direction perpendicular to the alignment axis and in the direction parallel to the alignment axis were each 0.5 Å or less, indicating a sharp peak. The variation in intermolecular distance was also small, providing a high dichroic ratio. As a result, the viewer observed clear and deep stereoscopic images without causing crosstalk and ghost images. In Example 5 using dichroic dye A1-46 as the magenta ink, however, the half-value width of diffraction peak in the direction perpendicular to the alignment axis was 0.89 Å, indicating a broad peak, a slight variation in the intermolecular distance was observed, and dichroic ratio was slightly low, 21. As a result, some ghost images were observed in the stereoscopic image.

### 5. Example 6

### Production of Image Print for Stereoscopic Image

An image print for stereoscopic image was produced as in Example 1 except that an ink having the composition shown below was used as the magenta ink for stereoscopic image.

### Preparation of Magenta Ink for Stereoscopic Image

The following components were dissolved by stirring to prepare a magenta ink for stereoscopic image.

Magenta ink for stereoscopic image

Rod-like liquid crystal (B) having a structure shown below: 20 parts by mass

Magenta azo dye A1-16 having a structure shown below: 1 part by mass

Chloroform (solvent): 79 parts by mass

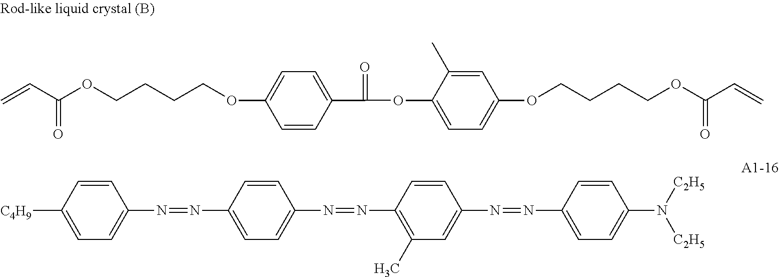

### K: 137° C., N: 266° C., I

### Measurement of Dichroic Ratio of Dichroic Dye Layer

A dichroic dye layer was separately formed using the same magenta ink and fixing under the same conditions as described above, and the dichroic ratio thereof was measured.

The results of the measurement are shown in the following table.

### Measurement of Periodic Structure of Dichroic Dye Layer

A dichroic dye layer was separately formed using the magenta ink mentioned above under the same conditions as in Examples 4 and 5, and the period and the half-value width of the layer were measured.

The results of the measurement are shown in the following table.

TABLE 3

| | | | Perpendicular to the | | | Parallel to the | | |
|---|---|---|---|---|---|---|---|---|
| | | Dichroic | alignment axis | | | alignment axis | | |
| No. | Dichroic dye | ratio | Peak 1 | Peak 2 | Peak 3 | Peak 1 | Peak 2 | Peak 3 |

| | | | |
|---|---|---|---|
| Example 6 | Food-like | 12 | 4.55 Å |
| | liquid crystal (B) | | 1.48 Å |
| | A1-16 | | |

Note:
The number on the upper row denotes the period, and the number of the lower row denotes the half-value width.

### Observation of Stereoscopic Image

A viewer observed the stereo image print. In Example 7 using a guest-host-type magenta ink, the half-value width of diffraction peak in the direction perpendicular to the alignment axis was 1.46 Å, indicating a broad peak. Thus, a high variation in the intermolecular distance was observed, and a low dichroic ratio of 12 was also observed. As a result, some ghost images were observed in the stereoscopic image.

### 6. Example 7

### Production of Image Print for Stereoscopic Image

An image print for stereoscopic image was produced as in Example 3 except that inks for stereoscopic image shown below were used and that the photoalignment material E-2 having a structure shown below was used as the alignment film.

### Production of Ink for Stereoscopic Image

### Preparation of Dichroic Dye Composition

The following composition was stirred and dissolved at 80° C. for 24 hours to prepare an ink for stereoscopic image. Observation of these dichroic dyes with a polarizing microscope showed that they were lyotropic liquid crystals soluble in water to show liquid crystallinity.

### Red Ink for Stereoscopic Image

C.I. Direct Red 81: 5 parts by mass

Surfactant Emal 20C (manufactured by Kao Corporation): 0.2 parts by mass

Water (solvent): 94.8 parts by mass

### Green Ink for Steroscopic Image

C.I. Direct Green 59: 5 parts by mass

Surfactant Emal 20C (manufactured by Kao Corporation): 0.2 parts by mass

Water (solvent): 94.8 parts by mass

### Blue Ink for Stereoscopic Image

C.I. Direct Blue 67: 5 parts by mass

Surfactant Emal 20C (manufactured by Kao Corporation): 0.2 parts by mass

Water (solvent):94.8 parts by mass

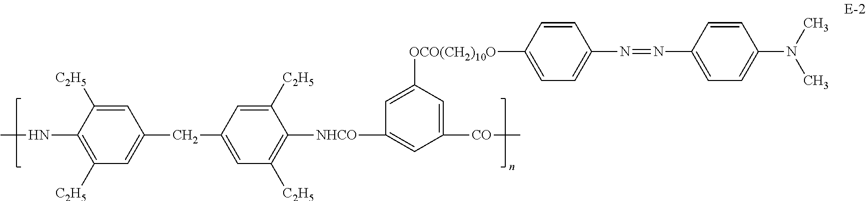

### Measurement of Dichroic Ratio of Dichroic Dye Layer

A dichroic dye layer was separately formed using the same ink and fixing under the same conditions as described above, and the dichroic ratio thereof was measured.

The results of the measurement are shown in the following table.

TABLE 4

| No. | Dichroic dye | Dichroic ratio |
|---|---|---|
| Example 7 | C.I. Direct Red 81 | 7 |
| | C.I. Direct Green 59 | 12 |
| | C.I. Direct Blue 67 | 10 |

### Observation of Stereoscopic Image

A viewer observed the stereo image print. In Example 7 using hydrophilic lyotropic liquid crystals as the dichroic dye for inks, the dichroic dyes formed a layer structure due to strong intermolecular interaction to considerably constrain the free movement of the molecules. As a result, the weak alignment-regulating force of the alignment film was insufficient for regulating the alignment to reduce the dichroic ratio. As a result, a stereoscpic image was observed with ghost images.

### 7. Example 8

### Production of Image Print for Stereoscopic Image

An image print for stereoscopic image was produced as in Example 1 except that the thickness of the transparent support was 200 μm. The Re value of this transparent support (cellulose acetate film) was 15 nm at 500 nm.

### Observation of Stereoscopic Image

A viewer observed the stereo image print. Though a stereoscopic image was observed, the image on the opposite side of the transparent support with respect to the viewer was recognized as a ghost image due to the Re of the support.

### REFERENCE SIGNS LIST

10, 10′, 10″ stereo image print
12 transparent support
14a, 14b image-receiving layer
16a, 16b image layer
18a, 18b protective layer
20 patterned linearly polarizing layer
22a, 22b oxygen-shielding layer
24a, 24b resin hardened layer
26 reflecting layer

The present disclosure related tot he subject matter contained in Japanese Patent Application No. 139317/2010, filed on Jun. 18, 2010, and PCT/JP2011/063929 filed on June 17, which are expressly incorporated herein by reference in their entirety. All the publications referred to in the present specification are also expressly incorporated herein by reference in their entirety.

The foregoing description of preferred embodiments of the invention has been presented for purposes of illustration and description, and it s not intended to be exhaustive or to limit the invention to the precise from disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A stereo image print comprising:
a transparent support;
a first laminate and a second laminate disposed on a front surface and a basic surface, respectively, of the transparent support; each laminate comprising an image layer satisfying the following condition (1) and a protective layer comprising at least one layer satisfying the following condition (2), the image layer and the protective layer being disposed in this order from the transparent support side:
(1) each image layer has a dichroic image including pixels for a left eye and pixels for a right eye arranged in a predetermined array, each pixel comprises at least one kind of horizontally aligned dichroic dye, and the dichroic images in the first and second laminates having absorption axes being orthogonal to each other,
(2) the protective layer comprising at least one layer included in the first laminate has an in-plane retardation value (Re) of 10 nm or less for visible light; and
comprising a linearly polarizing layer haying patterned first and second domains on the surface of the first laminate, the first and second domains having polarization axes being orthogonal to each other, the stereo image print being viewed from exterior of the patterned linearly polarizing layer,
wherein the stereo image print is configured such that only the dichroic image for a left eye enters an designed viewing position for a left eye and that only the dichroic image for a right eye enters an designed viewing position for the right eye.

2. The stereo image print according to claim 1, wherein the pixels for a right eye and the pixels for a left eye in the dichroic images each included in the first and second laminates are alternately adjacently arranged, respectively; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate.

3. The stereo image print according to claim 1, wherein the transparent support shows an in-plane retardation value (Re of 10 nm or less for visible light.

4. The stereo image print according to claim 1, wherein the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

5. The stereo image print according to claim 4, wherein the first and second alignment films are rubbing alignment films formed from a composition primarily composed of a polymer compound by rubbing the surfaces of the films such that the rubbing directions of the films are orthogonal to each other.

6. The stereo image print according to claim 4, wherein the first and second alignment films are photoalignment films aligned by light irradiation in directions orthogonal to each other.

7. The stereo image print according to claim 4, wherein the at least one kind of liquid crystalline dichroic dye is hydrophobic; and the first and second alignment films each comprise a hydrophilic polymer as a main component.

8. The stereo image print according to claim 1, wherein the first laminate and/or the second laminate comprises an oxygen-shielding layer formed from a composition primarily composed of polyvinyl alcohol as one layer of the protective layer comprising one or more layers.

9. The stereo image print according to claim 1, wherein the first laminate and/or the second laminate comprises a layer containing a UV absorber as one layer of the protective layer comprising one or more layers.

10. The stereo image print according to claim 1, wherein the at least one kind of dichroic dye is a liquid crystalline dichroic dye represented by formula (I), Formula (II), formula (III), Formula (IV), or Formula (VI): 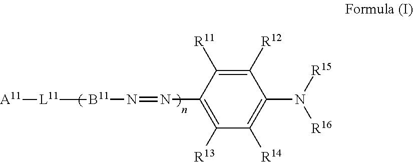
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═))—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other); 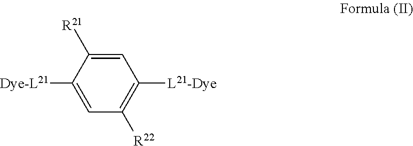
(in the formula, R²¹ and R²² each represent a hydrogen atom, an alkyl group, an alkoxy group, or a substituent represented by -L²²-Y, provided that at least one of R²¹ and R²² represents a group other than, a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a liner selected from the group consisting of an azo group (—N═N—), a carbonyloxy group (—C(═O)O—), an oxycarbonyl group (—O—C(═O)—), an imino group (—N═CH—), and a vinylene group (—C═C—); and each Dye represents an azo dye residue represented by formula (IIa): 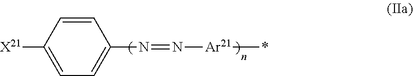
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 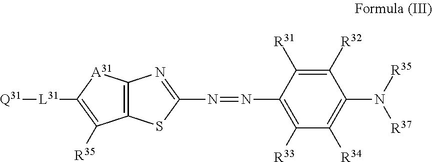
(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom); 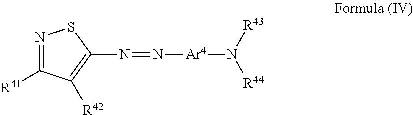
(in the formula, R⁴¹ and R⁴² each represent a hydrogen atom or a substituent or may be bonded to each other for form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 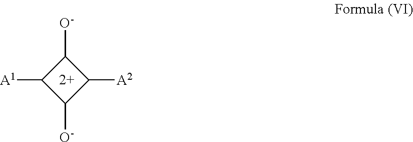
(in the formula, A¹ and A² each independently represent a substituted or unsubstituted hydrocarbon ring or heterocyclic group).

11. The stereo image print according to claim 1, wherein the patterned linearly polarizing layer is a coating-type linearly polarizing layer formed by coating.

12. The stereo image print according to claim 11, wherein the coating-type linearly polarizing layer contains at least one kind of dichroic dye represented by Formula (I), Formula (II), Formula (III), Formula (IV), or Formula (VI) according to claim 9.

13. The stereo image print according to claim 1, further comprising a non-depolarizing reflecting layer on the surface opposite to the viewer side.

14. The stereo image print according to claim 1, wherein the pixels for a right eye and the pixels for a left eye in the dichroic images each included in the first and second laminates are alternately adjacently arranged; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included is the second laminate; and
the at least one kind of dichroic dye has liquid crystallinity; and
which comprises a first alignment film disposed between the image laser of the first laminate and the transparent support and a second alignment film disposed between the image layer of the second laminate and the transparent support; and the first and second alignment films have alignment axes orthogonal to each other,

15. The stereo image print according to claim 1, wherein the transparent support shows an in-plane retardation value (Re) of 10 nm or less for visible light, and the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

16. The stereo image print according to claim 1, wherein the pixels for a right eye and the pixels for a left eye in the dichroic images each included in the first and second laminates are alternately adjacently arranged; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate;
the transparent support shows an in-plane retardation value (Re) of 10 nm or less for visible light;
the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other.

17. The stereo image print according to claim 1, wherein the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other; and
wherein the at least one kind of dichroic dye is a liquid crystalline dichroic dye represented by Formula (I), Formula (II), formula (III), Formula (IV), or Formula (VI): 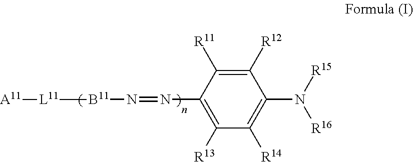
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —OC(═)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different form each other); 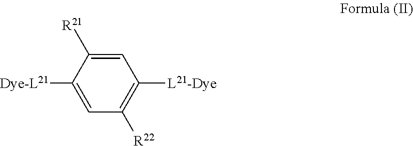
(in the formula, R²¹ and R²² each represent a hydrogen atom, an alkyl group, an alkoxy group, or a substituent represented by -L²²-Y, provided that at least one of R²¹ and R²² represents a group other than a hydrogen atom, wherein L²² represents and alkylene group, where on CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), and oxycarbonyl group (—O—C(═O)—), an imino group (—N═CH—), and a vinylene group (—C═C—); and each Dye represents an azo dye residue represented by Formula (IIa); 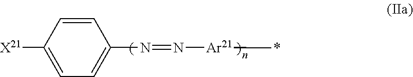
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or dir-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 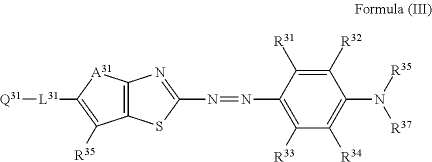
(in the formula, R³¹ R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent liner; and A³¹ represents an oxygen atom or a sulfur atom); 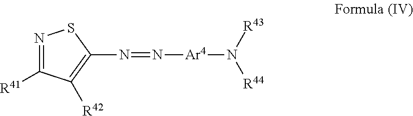
(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 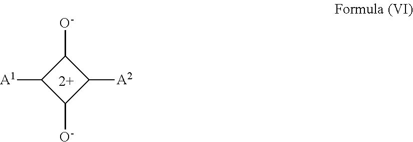
(in the formula, A¹ and A² each independently represent a substituted or unsubstituted hydrocarbon ring or heterocyclic group).

18. The stereo image print according to claim 1, wherein the pixels for a right eye and the pixels for a left eye in the dichroic images each included in the first and second laminates are alternately adjacently arranged; and the dichroic image included in the first laminate and the dichroic image included in the second laminate are positioned such that the pixels for a left eye in the dichroic image included in the first laminate correspond to the pixels for a right eye in the dichroic image included in the second laminate, or the pixels for a right eye in the dichroic image included in the first laminate correspond to the pixels for a left eye in the dichroic image included in the second laminate; and the at least one kind of dichroic dye has liquid crystallinity; and
which comprises a first alignment film disposed between the image layer of the first laminate and the transparent support and a second alignment film disposed between the image layer of the second laminate and the transparent support; and the first and second alignment films have alignment axes orthogonal to each other; and
wherein the at least one kind of dichroic dye is a liquid crystalline dichroic dye represented by formula (I), Formula (II), formula (III), Formula (IV), or Formula (VI): 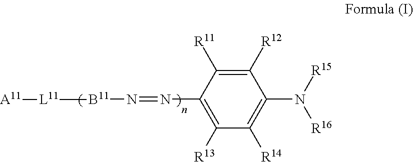
(in the formula, R¹¹ to R¹⁴ each independently represent a hydrogen atom or a substituent; R¹⁵ and R¹⁶ each independently represent a hydrogen atom or an optionally substituted alkyl group; L¹¹ represents —N═N—, —CH═N—, —N═CH—, —C(═O)O—, —OC(═O)—, or —CH═CH—; A¹¹ represents an optionally substituted phenyl group, an optionally substituted naphthyl group, or an optionally substituted aromatic heterocyclic group; B¹¹ represents an optionally substituted divalent aromatic hydrocarbon group or divalent aromatic heterocyclic group; and n represents an integer of 1 to 5, provided that when n represents an integer of 2 or more, a plurality of B¹¹'s may be the same as or different from each other); 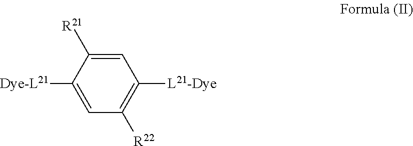
(in the formula, R²¹ and R²² each represent a hydrogen atom, an alkyl group, an alkoxy group, or a substituent represented by -L²²-Y, provided that at least one of R²¹ R²² represents a group other than a hydrogen atom, wherein L²² represents an alkylene group, where one CH₂ group or two or more nonadjacent CH₂ groups in the alkylene group are each optionally substituted by —O—, —COO—, —OCO—, —OCOO—, —NRCOO—, —OCONR—, —CO—, —S—, —SO₂—, —NR—, —NRSO₂—, or —SO₂NR— (R represents a hydrogen atom or an alkyl group having 1 to 4 carbon atoms); and Y represents a hydrogen atom, a hydroxy group, an alkoxy group, a carboxyl group, a halogen atom, or a polymerizable group; each L²¹ represents a linker selected from the group consisting of an azo group (—N═N—), a carbonyloxy group (—C(═O)O—), an oxycarbonyl group (—O—C(═O)—), an imino group (—N═CH—), and a vinylene group (—C═C—); and each Dye represents an azo dye residue represented by Formula (IIa): 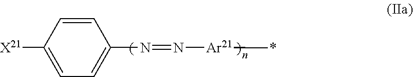
in Formula (IIa), * represents a bonding site to L²¹; X²¹ represents a hydroxy group, a substituted or unsubstituted alkyl group, a substituted or unsubstituted alkoxy group, an unsubstituted amino group, or a mono- or di-alkylamino group; each Ar²¹ represents an optionally substituted aromatic hydrocarbon ring or aromatic heterocyclic group; and n represents an integer of 1 to 3, and when n is an integer of 2 or more, a plurality of Ar²¹'s may be the same as or different from each other); 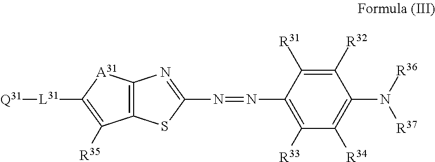
(in the formula, R³¹ to R³⁵ each independently represent a hydrogen atom or a substituent; R³⁶ and R³⁷ each independently represent a hydrogen atom or an optionally substituted alkyl group; Q³¹ represents an optionally substituted aromatic hydrocarbon, aromatic heterocyclic, or cyclohexane ring group; L³¹ represents a divalent linker; and A³¹ represents an oxygen atom or a sulfur atom); 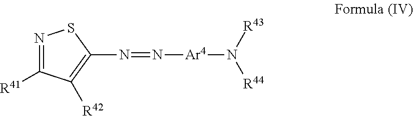
(in the formula, R⁴¹ and R⁴² each represent a hydrogen atom or a substituent or may be bonded to each other to form a ring; Ar⁴ represents an optionally substituted divalent aromatic hydrocarbon or aromatic heterocyclic group; and R⁴³ and R⁴⁴ each represent a hydrogen atom or an optionally substituted alkyl group or may be bonded to each other to form a heterocyclic ring); and 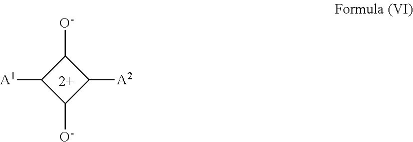
(in the formula, A¹ and A² each independently represent a substituted or unsubstituted hydrocarbon ring or heterocyclic group).

19. A method of producing a stereo image print according to claim 1, the method comprising;
applying a dichroic dye composition comprising an organic solvent and at least one kind of dichroic dye dissolved in the organic solvent, simultaneously or separately, onto the front surface and the back surface of a transparent support so as to form the respective images by arranging pixels for a left eye and pixels for a right eye in a predetermined array; and
horizontally aligning spontaneoulsy or passively the at least one kind of dichroic dye by evaporating the organic solvent in the composition.

20. The method according to claim 19, wherein the liquid crystalline dichroic dye composition is applied by ink jetting.
